(19) United States
(12) Patent Application Publication
(10) Pub. No.: US 2026/0352030 A1
(43) Pub. Date: Nov. 5, 2026

(54) AI-ORCHESTRATED DIRECTED ELECTROMAGNETIC WIRELESS POWER INFRASTRUCTURE WITH POST-QUANTUM BLOCKCHAIN-AUTHENTICATED DEVICE AUTHORIZATION

(71) Applicant: VOICE LIFE HOLDINGS Limited, Dubai (AE)

(72) Inventors: Robert Smith, Huntington Beach, CA (US); David Lark, Corcoran, CA (US); Mihael Radosolovic, Cavle (HR); Michael Smith, Corona, CA (US)

(21) Appl. No.: 19/741,315

(22) Filed: Jul. 14, 2026

Related U.S. Application Data
(63) Continuation-in-part of application No. 19/675,215, filed on May 12, 2026.
Application No. 19/675,215 is a continuation-in-part of application No. 19/227,267, filed on Jun. 3, 2025, now Pat. No. 12,627,355.
Application No. 19/227,267 is a continuation-in-part of application No. 18/977,497, filed on Dec. 11, 2024, now Pat. No. 12,348,048.
Application No. 18/977,497 is a continuation-in-part of application No. 18/343,308, filed on Jun. 28, 2023, now Pat. No. 12,199,445.
Application No. 18/343,308 is a continuation-in-part of application No. 18/059,874, filed on Nov. 29, 2022, now Pat. No. 11,735,960.
Application No. 18/059,874 is a continuation-in-part of application No. 17/499,335, filed on Oct. 12, 2021, now Pat. No. 11,545,855.
Application No. 17/499,335 is a continuation-in-part of application No. 17/137,830, filed on Dec. 30, 2020, now Pat. No. 11,171,521.
Application No. 17/137,830 is a continuation-in-part of application No. 16/853,170, filed on Apr. 20, 2020, now Pat. No. 10,910,882.
Application No. 16/853,170 is a continuation-in-part of application No. 16/597,776, filed on Oct. 9, 2019, now Pat. No. 10,944,296.
Application No. 16/597,776 is a continuation-in-part of application No. PCT/IB2019/052413, filed on Mar. 25, 2019.
Application No. 17/499,335 is a continuation-in-part of application No. 17/044,792, filed on Oct. 1, 2020, now Pat. No. 11,303,159.
Application No. 17/137,830 is a continuation-in-part of application No. 16/597,776, filed on Oct. 9, 2019, now Pat. No. 10,944,296.
Application No. 16/597,776 is a continuation-in-part of application No. 17/044,792, filed on Oct. 1, 2020, now Pat. No. 11,303,159.

(51) Int. Cl. H02J 50/20; H02J 50/40; H04B 10/90; H04W 12/06; H04W 84/06

(52) U.S. Cl. CPC H02J 50/20; H02J 50/40; H04B 10/90; H04W 12/06; H04W 84/06

(57) ABSTRACT

Disclosed are systems for dynamically coordinating wireless power delivery across terrestrial and orbital transmitter platforms. A system may include a terrestrial phased-array transmitter node configured to generate and selectively direct terahertz electromagnetic energy toward authenticated receiver devices within a ground-based coverage zone, and an orbital transmitter platform configured to selectively direct terahertz electromagnetic energy toward a ground-based rectenna array. A satellite communication interface may receive Positioning, Navigation, and Timing (PNT) data, and an artificial intelligence (AI) control system may dynamically arbitrate energy allocation between the terrestrial and orbital platforms based on atmospheric conditions, receiver device location, and device priority classification. The AI control system may perform beam alignment compensation based on PNT data to account for orbital motion and atmospheric propagation effects.

### TECHNICAL FIELD

The present disclosure relates to wireless power transmission systems and electro-magnetic radiation or fields for wireless power transfer and, more particularly, to AI-controlled directed electromagnetic energy delivery networks utilizing phased-array beam-forming across high-frequency electromagnetic spectra including millimeter wave, terahertz, and near-infrared bands, dynamic routing, and cryptographically secured, authenticated energy infrastructure for industrial, medical, and distributed device environments.

### BACKGROUND

Existing wireless power delivery systems fall into two fundamentally distinct architectural categories: (a) contact-dependent systems, including inductive and resonant coupling, which require near-field proximity and precise physical alignment; and (b) passive ambient harvesting systems, which collect incidental electromagnetic energy from existing environmental sources such as broadcast radio, cellular base stations, and Wi-Fi access points. Neither category constitutes a managed power delivery infrastructure. Contact-dependent systems cannot serve mobile or distributed devices. Passive ambient harvesting systems operate at power densities of microwatts to low milliwatts—orders of magnitude below the hundreds of milliwatts to multiple watts required to power active commercial devices such as autonomous mobile robots, electronic shelf labels, and medical patient monitoring equipment. Passive ambient harvesting systems contain no transmitter infrastructure dedicated to power delivery, no RF amplification stage gated by device authorization, no beamforming subsystem capable of directing energy to a specific device location, and no session management layer that measures and records delivered energy. These are not missing features that could be added to an ambient harvesting system—they are architectural absences that define the category.

Battery-dependent devices impose maintenance burdens, downtime risk, and environmental disposal costs. Existing wireless power systems lack device-level authorization, delivering energy without verifying receiver identity, which creates energy-exhaustion attack surfaces. In this regard, authentication protocols in the existing systems—including proximity-based identification protocols used in near-field charging systems (see, e.g., Energous Corporation, U.S. Pat. No. 10,103,552 B1, “Protocols for Authenticated Wireless Power Transmission”)—are directed to logical protocol-level authentication for localized “pockets of energy” and proximity-based delivery. They do not disclose managed infrastructure architectures for device-level wireless power authorization and delivery.

Terahertz electromagnetic wave technology, operating in the frequency range of 100 GHz to 10 THz, occupies what is referred to in the scientific literature as the “Terahertz Gap”—the spectral region between electronic microwave devices (which operate efficiently below approximately 100 GHz) and optical photonic devices (which operate efficiently above approximately 10 THz). The Terahertz Gap has historically been underutilized because reliable solid-state generation and detection in this band presented engineering challenges. There are two distinct technical challenges within the Terahertz Gap. First, the “THz gap” challenge: prior to approximately 2015, reliable solid-state sources and detectors for THz frequencies were primarily confined to laboratory instrumentation for spectroscopy and radio astronomy. By 2015, CMOS integration advances enabled phased-array transmitters at THz-adjacent frequencies—for example, academic research disclosed fully integrated phased-array radiators at 105.5 GHz for data communication applications. However, such communication-centric phased arrays were designed to minimize signal distortion and maximize signal-to-noise ratio, not to maximize energy flux density at a receiver location. The technical requirements for power delivery beamforming—including maximization of delivered power in watts, duty-cycle control for thermal management, and feedback regulation based on receiver charge state—are fundamentally different from those for communication beamforming, and existing communication arrays were not designed to address power delivery applications. Second, the “rectenna diode problem”: conventional Schottky diodes used in microwave rectennas suffer from excessive parasitic capacitance at THz frequencies above approximately 300 GHz, severely limiting rectification efficiency. Prior research into THz and infrared nanoantennas using metal-insulator-metal (MIM) tunnel diodes—including work at national laboratories and universities—demonstrated rectification of THz-frequency currents but in the context of ambient solar radiation harvesting, not directed managed power delivery with a dedicated transmitter.

### SUMMARY

The present disclosure relates to systems, methods, and non-transitory computer-readable media for managed directed wireless power delivery using phased-array transmitter infrastructure, cryptographic device authentication, AI-driven beam orchestration, and per-session energy metering. The system may include distributed phased-array terahertz transmitter nodes; a plurality of authenticated receiver devices; an AI-based control system (referred to herein as the ‘ATLAS engine’ or ‘AI control system’) for dynamic multi-endpoint routing; a cryptographic security layer (referred to herein as the ‘security module’ or ‘QuantumShield’) for device authentication and session management; and a satellite communication interface for global synchronization and space-to-Earth energy relay.

In one aspect, a wireless power delivery system includes a transmitter device configured to generate terahertz electromagnetic energy within a frequency range of 0.1 THz to 10 THz and to transmit the terahertz electromagnetic energy to a receiver device; the receiver device configured to receive the transmitted terahertz electromagnetic energy; and a control system communicatively coupled to the transmitter device and configured to adjust a transmission parameter based on feedback data received from the receiver device. In some embodiments, the control system calculates a Thermal Impact Vector for authenticated receiver devices and modulates a duty cycle parameter or power amplitude weight applied to the transmitter device to optimize battery State of Health over the device's operational lifecycle. In some embodiments, the control system predicts Energy Depletion Events for authenticated receiver devices and preemptively reroutes beam resources to prevent energy interruption before a depletion event occurs.

In another aspect, a wireless power delivery system includes a phased-array transmitter configured to generate directed electromagnetic energy and to selectively direct the electromagnetic energy via beam steering toward a receiver device, wherein the phased-array transmitter comprises a plurality of antenna elements configured to apply controlled phase differentials to steer the energy beam without mechanical movement; a receiver device comprising a terahertz rectenna configured to receive the directed electromagnetic energy and convert the received energy to direct current electrical power; and a controller configured to adjust a transmission parameter based on feedback data received from the receiver device. In some embodiments, the system further comprises a satellite communication interface configured to receive Positioning, Navigation, and Timing (PNT) data from a satellite, and the controller adjusts the transmission parameter based on the PNT data to compensate for motion of the receiver device. In some embodiments, the directed electromagnetic energy is generated within a terahertz frequence range of 100 GHz to 10 THz, a millimeter wave frequency range of 10 GHz to 100 GHz, or a near-infrared frequency range above 10 THz.

In another aspect, a cryptographic energy authorization system for a wireless power network includes a device identity module configured to store a cryptographically verifiable device identifier and to initiate a secure authentication handshake with a transmission control node; a transmission control node configured to verify the authentication handshake and to gate RF amplification of a phased-array transmitter based on verified authorized state; a transmitter resource allocation module configured to control allocation of transmitter resources based on the verified authorization state of an authenticated device; and a distributed or cryptographically secured logging system configured to record each energy session as an immutable audit record. In some embodiments, the system further comprises a security module configured to generate a dedicated cryptographic session key for each authenticated receiver device per energy delivery session and to isolate cryptographic session credentials on a per-device basis. In some embodiments, the system uses a hybrid cryptographic model comprising a classical cryptographic signature component and a post-quantum cryptographic signature component, wherein the RF amplification gating function is enabled upon verification of the components.

In another aspect, a method for authenticated wireless energy delivery includes receiving an authorization request from a receiver device; authenticating the receiver device by verifying a cryptographically verifiable device identifier; calculating, via a machine learning algorithm, an optimal spatial targeting vector and beam power allocation for the authenticated receiver device; directing on electromagnetic energy beam via a phased-array transmitter to the authenticated receiver device by applying a phase shift matrix to a plurality of antenna elements; and dynamically adjusting the phase shift matrix, beam direction vector, and power amplitude weight in real time based on updated physical input parameters received from the authenticator receiver device.

In another aspect, an AI-driven wireless energy routing system includes a telemetry ingestion module configured to receive physical input parameters from a plurality of authenticated receiver devices; a machine learning inference engine configured to process the physical input parameters and generate physical control outputs comprising of phase shift matrix, a beam direction vector, and power amplitude weights; a multi-device scheduling module configured to generate a beam allocation schedule based on predicted energy demand and a configurable device priority policy; and the control signal generator configured to transmit the physical control outputs to a plurality the phased-array transmitter nodes to directly cause modification of transmitter hardware state.

In another aspect, a system for dynamic coordination of wireless power delivery across terrestrial and orbital transmitter platforms includes a terrestrial phased-array transmitter node configured to generate and selectively direct terahertz electromagnetic energy toward authenticated receiver devices; an orbital transmitter platform configured to selectively direct terahertz electromagnetic energy toward the ground-based rectenna array; a satellite communication interface configured to receive PNT data; and an AI control system configured to dynamically arbitrate energy delivery allocation between the terrestrial an orbital transmitter platforms and to perform beam alignment compensation based on the PNT data.

In another aspect, a fleet-scale wireless power management infrastructure includes a plurality of phased-array transmitter nodes distributed across the plurality of coverage zones; a device registry storing authenticated device identifiers, device class designations, priority tier assignments, and zone assignments for each enrolled fleet device; a fleet management controller configured to generate fleet-wide beam allocation schedule; and a machine learning inference engine configured to continuously re-optimize the fleet-wide beam allocation schedule based on the current State of Charge telemetry, predicted energy demand, device cost priority constraints, and available beam capacity. In some environments, the fleet management controller simultaneously manages authenticated wireless power delivery to at least 100 enrolled fleet devices across the plurality of coverage zones.

In another aspect, a system for secure management of digital assets and system access includes a post-quantum cryptographic module; a key orchestration engine configured to pre-generate and dynamically allocate cryptographic keys from managed key pool; an identity integration module configured to associate cryptographic keys with authenticated user identities and enrolled devices; a transactional execution module configured to generate cryptographic signatures and process transactions across a distributed ledger or network system; and the compliance and audit module configured to record transaction data and cryptographic proofs as verifiable audit records.

In another aspect, a non-transitory computer-readable medium is provided storing instructions that, when executed by a processor, cause the processor to receive physical input parameters from authenticated wireless power receiver devices; process the physical input parameters using a machine learning algorithm to generate physical control output for a phase-array transmitter; control allocation of transmitter resources among authenticated devices based on a configurable device priority policy; transmit the physical control outputs to a plurality of phased-array transmitter nodes; and generate an immutable audit record of an energy delivery session.

Thus, various embodiments provide a system having dedicated transmitter infrastructure that actively generates directed electromagnetic energy; authorization-gated RF amplification that physically prevents energy delivery absent cryptographic device authentication; coherent directional beamforming that steers energy toward spatially targeted authenticated devices without mechanical movement; and per-session energy metering that records instantaneous power and cumulative watt-hours as immutable audit records.

Simplifications or omissions in this section as well as in the abstract or the title of this description may be made to avoid observing the purpose of this section, the abstract, and the title. Such simplifications or omissions are not intended to limit the scope of the various embodiments described herein.

### BRIEF DESCRIPTION OF THE DRAWINGS

The accompanying drawings, which are incorporated in and constitute a part of this specification, illustrate several embodiments directed to one of ordinary skill in the art and, together with the description, serve to explain the disclosed principles. It should be noted that, in accordance with standard practice in the industry, various features are not drawn to scale. In fact, the dimensions of the various features may be increased or reduced for clarity of discussion. In the drawings:

FIG. 1 is an illustration of an exemplary operating environment, according to some embodiments of the present disclosure.

FIG. 2 is a block diagram of a receiver device for facilitating wireless energy reception, in accordance with some embodiments.

FIG. 3 is a block diagram of the receiver device for facilitating wireless energy reception, in accordance with some embodiments.

FIG. 4 is a block diagram of a receiver device for facilitating wireless energy reception, in accordance with some embodiments.

FIG. 5 is a block diagram of the receiver device for facilitating wireless energy reception, in accordance with some embodiments.

FIG. 6 is a block diagram illustrating a blockchain/distributed logging framework coupled to a transmitter device and a receiver transceiver, in accordance with some embodiments.

FIG. 7 is a block diagram of the receiver device for facilitating wireless power reception, in accordance with further embodiments.

FIG. 8 is a schematic diagram illustrating a wireless power channel and pairing data handshakes between a transmitter device and receiver device, in accordance with some embodiments.

FIG. 9 illustrates a system for facilitating wireless transfer of power configured to adapt wireless transmission of power from a transmitter device to a plurality of receiver devices, in accordance with some embodiments.

FIG. 10 is a schematic diagram illustrating a control plane comprising a WPN server orchestrating power transfer between a transmitter device and receiver device, in accordance with some embodiments.

FIG. 11 illustrates wireless power transfer protocol stacks associated with the transmitter device and the receiver device, in accordance with some embodiments.

FIG. 12 illustrates a flowchart of a method of performing wireless power transfer using terahertz frequencies, in accordance with some embodiments.

FIG. 13 illustrates a flowchart of a method of performing wireless power transfer using terahertz frequencies, in accordance with some embodiments.

FIG. 14 illustrates a flowchart of a method of performing wireless power transfer using terahertz frequencies by transmitting an alert to a user device, in accordance with some embodiments.

FIG. 15 illustrates an environment in which the disclosed systems and methods may operate, in accordance with some embodiments.

FIG. 16 is a schematic diagram illustrating a terrestrial Wireless Power Mesh Network comprising Power Transmitter Routers, in accordance with some embodiments.

FIG. 17 is a schematic diagram illustrating a macro-architecture connecting Terahertz Router/Transmitter Devices and Smart Contracts and distributed logging servers, in accordance with an exemplary embodiment.

FIG. 18 illustrates blockchain receiver node registration with a wireless power mesh network, in accordance with the exemplary embodiment.

FIG. 19 illustrates blockchain receiver node registration with a wireless power mesh network, in accordance with the exemplary embodiment.

FIG. 20 illustrates power transmitter node validation using a blockchain, in accordance with an exemplary embodiment.

FIG. 21 illustrates power transmitter node validation using a blockchain, in accordance with the exemplary embodiment.

FIG. 22 illustrates power transmitter node validation using a blockchain, in accordance with the exemplary embodiment.

FIG. 23 illustrates power transmitter node validation using a blockchain, in accordance with the exemplary embodiment.

FIG. 24 illustrates power transmitter node validation using a blockchain, in accordance with the exemplary embodiment.

FIG. 25 illustrates power transmitter device node using blockchain to authenticate, identify, and verify a unique paring request, in accordance with an exemplary embodiment.

FIG. 26 illustrates power transmitter device node using blockchain to authenticate, identify, and verify a unique paring request, in accordance with the exemplary embodiment.

FIG. 27 illustrates power transmitter device node and receiver node using a bock chain to authenticate to detect a unique paring request for power transmission, in accordance with an exemplary embodiment.

FIG. 28 illustrates power transmitter device node and receiver node using a bock chain to authenticate to detect a unique paring request for power transmission, in accordance with the exemplary embodiment.

FIG. 29 illustrates power transmitter device node and receiver node using a bock chain to authenticate to detect a unique paring request for power transmission, in accordance with the exemplary embodiment.

FIG. 30 is a flowchart of a method of wireless charging using blockchain in a network, in accordance with some embodiments.

FIG. 31 is a schematic diagram illustrating a secure receiver Enclosure with AI Algorithm Network Discovery and Power Transmission Process, Authentication Verification Process, and MoS2-Enabled Flexible Rectenna, in accordance with some embodiments.

FIG. 32 is a block diagram of a computing device for implementing the methods disclosed herein, in accordance with some embodiments.

FIG. 33 is a schematic illustrating a system for facilitating wireless power transmission, in accordance with some embodiments.

FIG. 34 is a block diagram of a receiver device for facilitating wireless energy reception, in accordance with some embodiments.

FIG. 35 is a block diagram of the receiver device for facilitating wireless energy reception, in accordance with some embodiments.

FIG. 36 is a block diagram of the receiver device for facilitating wireless energy reception, in accordance with some embodiments.

FIG. 37 is a block diagram of the receiver device for facilitating wireless energy reception, in accordance with some embodiments.

FIG. 38 is a block diagram of the receiver device for facilitating wireless energy reception, in accordance with some embodiments.

FIG. 39 is a block diagram of the receiver device for facilitating wireless energy reception, in accordance with some embodiments.

FIG. 40 is a block diagram of a receiver device for facilitating wireless energy reception, in accordance with some embodiments.

FIG. 41 is a block diagram of a receiver device for facilitating transaction of energy wirelessly received by the receiver device, in accordance with some embodiments.

FIG. 42 is a block diagram of the receiver device for facilitating the transaction of the energy wirelessly received by the receiver device, in accordance with some embodiments.

FIG. 43 is a block diagram of the receiver device for facilitating the transaction of the energy wirelessly received by the receiver device, in accordance with some embodiments.

FIG. 44 is a block diagram of the receiver device for facilitating the transaction of the energy wirelessly received by the receiver device, in accordance with some embodiments.

FIG. 45 is a block diagram of the receiver device for facilitating the transaction of the energy wirelessly received by the receiver device, in accordance with some embodiments.

FIG. 46 is a block diagram of a receiver device for facilitating transaction of energy wirelessly received by the receiver device, in accordance with some embodiments.

FIG. 47 is a schematic of a system for facilitating wireless energy transmissions, in accordance with some embodiments.

FIG. 48 is a schematic of the system for facilitating wireless energy transmissions to the at least one secondary receiver device positioned below the ionosphere, in accordance with some embodiments.

FIG. 49 is a schematic of the system for facilitating wireless energy transmissions to the at least one secondary receiver device positioned above the ionosphere, in accordance with some embodiments.

FIG. 50 is a schematic of the system for facilitating wireless energy transmissions to the at least one secondary receiver device positioned in the ionosphere, in accordance with some embodiments.

FIG. 51 is a schematic of the system for facilitating wireless energy transmissions to the at least one secondary receiver device for powering the at least one electronic device, in accordance with some embodiments.

FIG. 52 is a block diagram of the primary receiver device of the at least one space station of the system, in accordance with some embodiments.

FIG. 53 is a block diagram of the at least one secondary receiver device of the system, in accordance with some embodiments.

FIG. 54 is a block diagram of the primary transmitter device of the at least one space station of the system, in accordance with some embodiments.

FIG. 55 is a block diagram of the at least one secondary receiver device of the system, in accordance with some embodiments.

FIG. 56 is a perspective view of the primary receiver device of the system, in accordance with some embodiments.

FIG. 57 is a bottom perspective view of the receiver enclosure of the receiver transceiver of the primary receiver device, in accordance with some embodiments.

FIG. 58 is a block diagram of the primary receiver device of the system, in accordance with some embodiments.

FIG. 59 is a block diagram of the at least one secondary receiver device of the system, in accordance with some embodiments.

FIG. 60 is a block diagram of the at least one transmitter device of the system, in accordance with some embodiments.

FIG. 61 is a block diagram of the primary receiver device of the system, in accordance with some embodiments.

FIG. 62 is a schematic of a system for facilitating wireless energy transmissions, in accordance with some embodiments.

FIG. 63 is a schematic of a system for facilitating wireless energy transmissions from at least one transmitter device to at least one receiver device via the ionosphere of the atmosphere of the earth, in accordance with some embodiments.

FIG. 64 is a schematic of a system for facilitating wireless energy transmissions from the at least one transmitter device to the at least one receiver device via the ionosphere of the atmosphere of the earth, in accordance with some embodiments.

FIG. 65 is a block diagram of a device 6500 for facilitating harnessing terahertz electromagnetic waves for energy generation, in accordance with some embodiments.

FIG. 66 is a block diagram of the device 6500 with the at least one first device 6602 and the at least one second device 6606, in accordance with some embodiments.

FIG. 67 is a block diagram of the device 6500 comprising the enclosure 6702, in accordance with some embodiments.

FIG. 68 is a block diagram of the device 6500 with the at least one first device 6602 comprising the first electromagnetic wave generator 6802 and the first transceiver 6804, in accordance with some embodiments.

FIG. 69 is a block diagram of the device 6500 with the at least one first device 6602 comprising the first electromagnetic wave generator 6802 and the first transceiver 6804 comprising the first antenna 6902, in accordance with some embodiments.

FIG. 70 is a block diagram of the device 6500 with the at least one first device 6602 comprising the first electromagnetic wave generator 6802, the first timing device 6604, and the first transceiver 6804 comprising the first antenna 6902, in accordance with some embodiments.

FIG. 71 is a block diagram of the device 6500 comprising the energy storage device 7102, in accordance with some embodiments.

FIG. 72 is a block diagram of the device 6500 with the at least one first device 6602 comprising the first electromagnetic wave generator 6802, the control device 7202, and the first transceiver 6804 comprising the first antenna 6902, in accordance with some embodiments.

FIG. 73 is a block diagram of a device 7300 for facilitating harnessing terahertz electromagnetic waves for energy generation, in accordance with some embodiments.

FIG. 74 is a perspective view of a device 7400 for facilitating harnessing terahertz electromagnetic waves for energy generation, in accordance with some embodiments.

FIG. 75 is a perspective view of the device 7400 with an electronic device 7502, in accordance with some embodiments.

FIG. 76 is a schematic diagram of a system 7600 for facilitating harnessing terahertz electromagnetic waves for energy generation, in accordance with some embodiments.

FIG. 77 is a schematic of a rectenna 7700 of the system 7600, in accordance with some embodiments.

FIG. 78 is a schematic of a stacked system 7800 for facilitating harnessing terahertz electromagnetic waves for energy generation, in accordance with some embodiments.

FIG. 79 is a schematic of the terahertz transmitter 7601 comprising the reflecting element 7607, in accordance with some embodiments.

FIG. 80 illustrates a quantum terahertz chip/antenna, which is specifically designed to capture and utilize terahertz electromagnetic waves, thereby facilitating the generation of energy, in accordance with some embodiments.

FIG. 81 is a block diagram of a system 8100 for facilitating harnessing terahertz electromagnetic waves for photovoltaically generating electrical energy, in accordance with some embodiments.

FIG. 82 is a block diagram of the system 8100 for facilitating harnessing terahertz electromagnetic waves for photovoltaically generating electrical energy, in accordance with some embodiments.

FIG. 83 is a block diagram of the system 8100 for facilitating harnessing terahertz electromagnetic waves for photovoltaically generating electrical energy, in accordance with some embodiments.

FIG. 84 is a block diagram of the system 8100 for facilitating harnessing terahertz electromagnetic waves for photovoltaically generating electrical energy, in accordance with some embodiments.

FIG. 85 is a block diagram of the system 8100 for facilitating harnessing terahertz electromagnetic waves for photovoltaically generating electrical energy, in accordance with some embodiments.

FIG. 86 illustrates the at least one electromagnetic generator 8102 comprised in the system 8100 for facilitating harnessing terahertz electromagnetic waves for photovoltaically generating electrical energy, in accordance with some embodiments.

FIG. 87 illustrates the at least one electromagnetic generator 8102 comprised in the system 8100 for facilitating harnessing terahertz electromagnetic waves for photovoltaically generating electrical energy, in accordance with some embodiments.

FIG. 88 illustrates the at least one photovoltaic device 8106 comprised in the system 8100 for facilitating harnessing terahertz electromagnetic waves for photovoltaically generating electrical energy, in accordance with some embodiments.

FIG. 89 illustrates the at least one photovoltaic device 8106 comprised in the system 8100 for facilitating harnessing terahertz electromagnetic waves for photovoltaically generating electrical energy, in accordance with some embodiments.

FIG. 90 illustrates the at least one energy storage device 8206 for facilitating harnessing terahertz electromagnetic waves for photovoltaically generating electrical energy, in accordance with some embodiments.

FIG. 91 is a schematic diagram illustrating an energy flow architecture, including an energy metering system/PowerCoin system, an AI Optimization System, and a Quantum Energy Vault, in accordance with some embodiments.

FIG. 92 is a schematic of a method 9200 for facilitating harnessing terahertz electromagnetic waves for photovoltaically generating electrical energy, in accordance with some embodiments.

FIG. 93 is a block diagram of a system 9300 for facilitating harnessing terahertz electromagnetic waves for photovoltaically generating electrical energy, in accordance with some embodiments.

FIG. 94 is a flow diagram of a method 9400 for facilitating harnessing terahertz electromagnetic waves for photovoltaically generating electrical energy, in accordance with some embodiments.

FIG. 95 is a block diagram of a system 9500 for facilitating managing of terahertz wave energy, in accordance with some embodiments.

FIG. 96 is a block diagram of the system 9500, in accordance with some embodiments.

FIG. 97 is a block diagram illustrating an example receiver unit having a Cryptographic Security System/Blockchain Security System managing a terahertz antenna, in accordance with some embodiments.

FIG. 98 is a block diagram of a system 9800 for facilitating managing of terahertz wave energy, in accordance with some embodiments.

FIG. 99 is a block diagram of a system 9900 for facilitating managing of terahertz wave energy, in accordance with some embodiments.

FIG. 100 is a block diagram illustrating an AI-Enhanced Adaptive Antenna System 10000 linking a Satellite to terrestrial THz Wave Generators and Cryptographic Security Systems/Blockchain Security System, in accordance with some embodiments.

FIG. 101 is a flowchart illustrating a Predictive Performance Orchestration subsystem data flow, according to some embodiments.

FIG. 101A is a front view of a phased array antenna 10102, in accordance with some embodiments.

FIG. 101B is a front view of a metamaterial antenna 10104, in accordance with some embodiments.

FIG. 101C is a front view of a reconfigurable intelligent antenna 10106, in accordance with some embodiments.

FIG. 102 is a flowchart illustrating a Fleet-Scale Multi-Zone Wireless Power Management Architecture, in accordance with some embodiments.

FIG. 103 is a flowchart illustrating a Digital Asset and Identity Management Layer Architecture and PA Enable-Pin Coupling, in accordance with some embodiments.

FIG. 104 is a flowchart illustrating a Hybrid Post-Quantum Session Token Generation and RF Amplification Gating Sequence, in accordance with some embodiments.

FIG. 105 illustrates an AI system input data and sensor architecture 10500, in accordance with some embodiments.

FIG. 106 illustrates satellite communication protocol and synchronization methods 10600, in accordance with some embodiments.

FIG. 107 illustrates quantum-resistant blockchain technology architecture 10700, in accordance with some embodiments.

FIG. 108 illustrates a system 10800 designed to work with any suitable THz source (100 GHz-10 THz), in accordance with some embodiments.

FIG. 109 is a flowchart of a method 10900 of facilitating managing of terahertz wave energy using a terahertz antenna, in accordance with some embodiments.

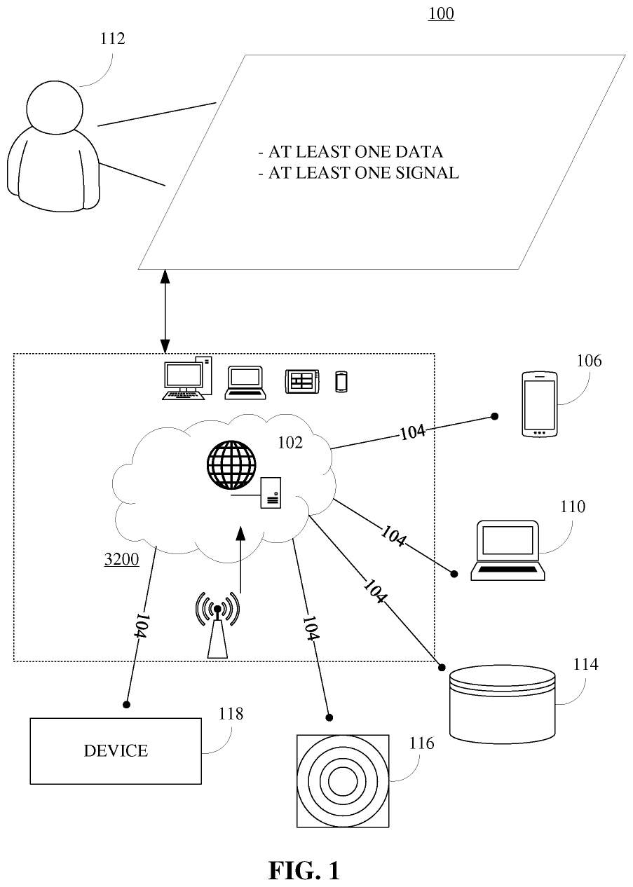

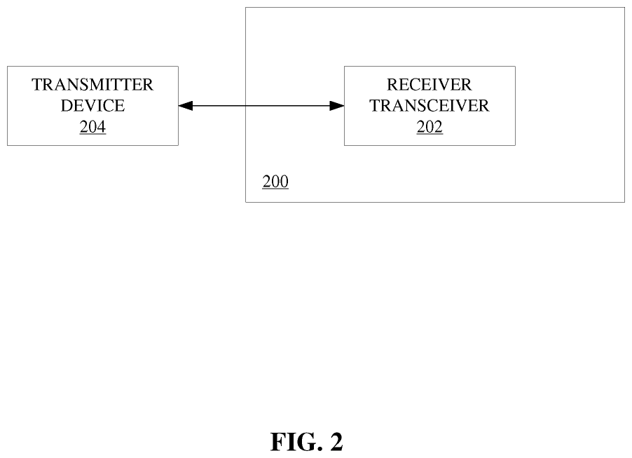

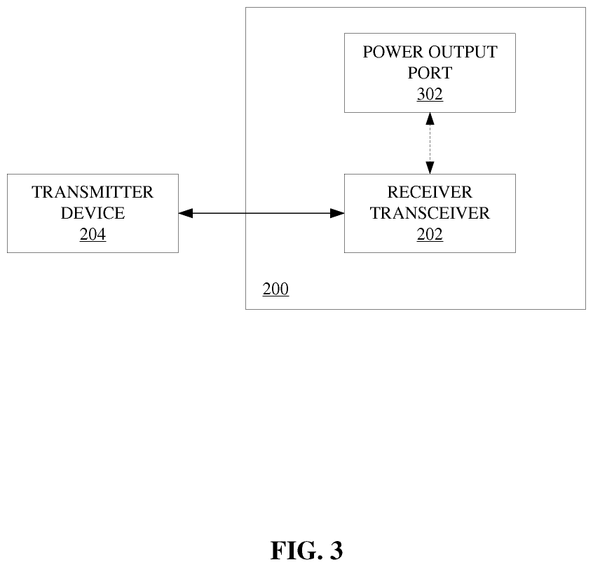

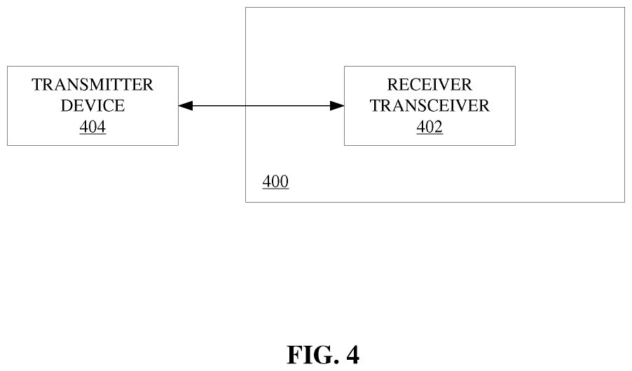

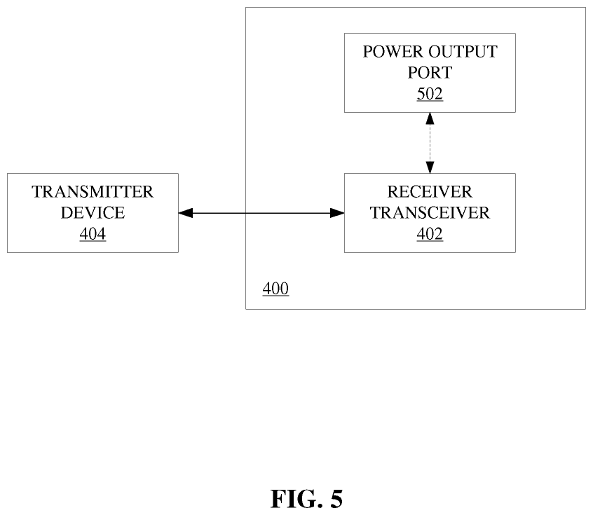

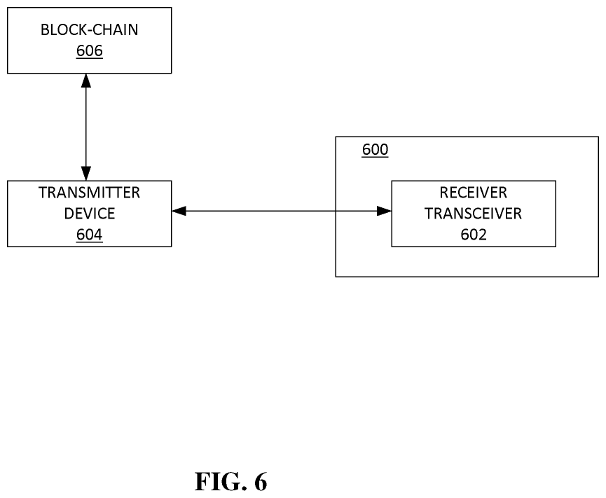

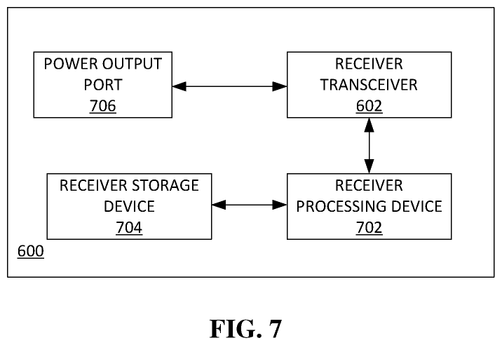

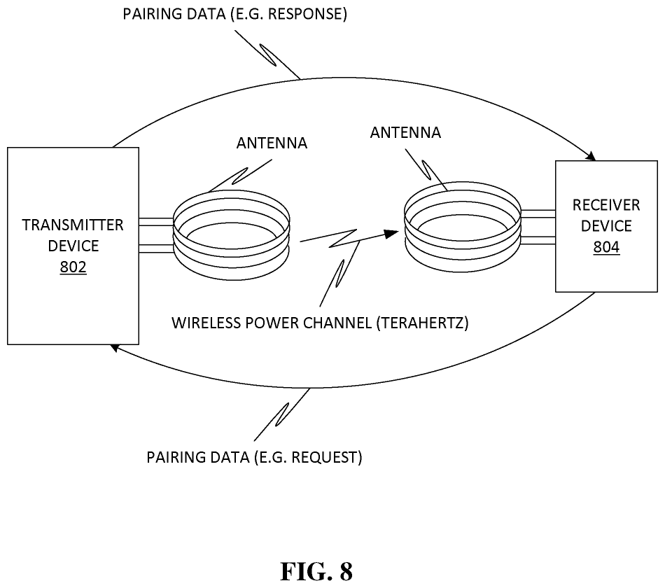

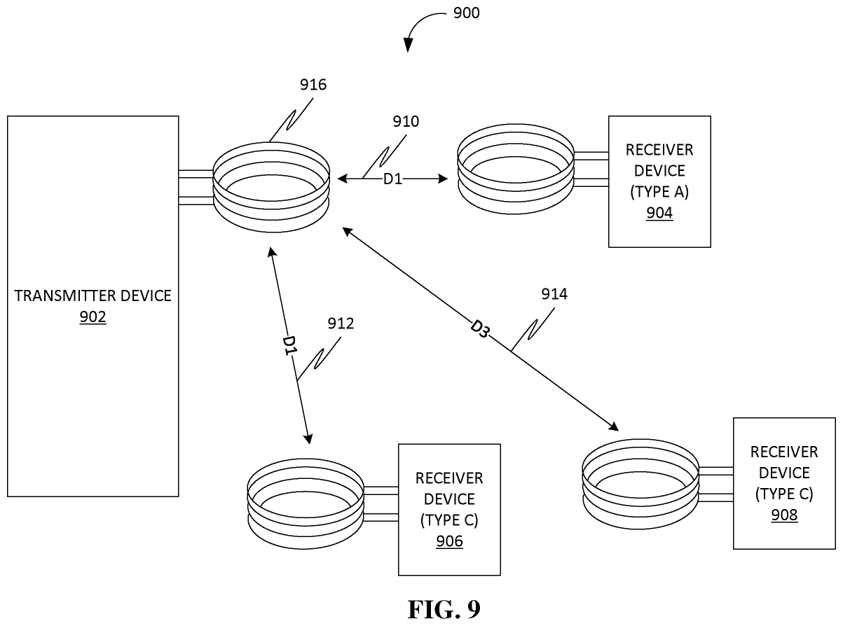

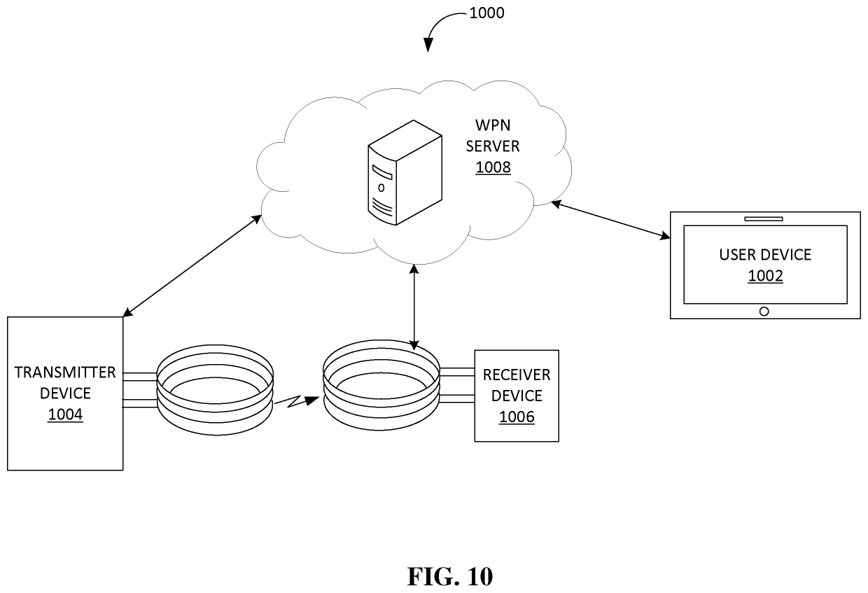

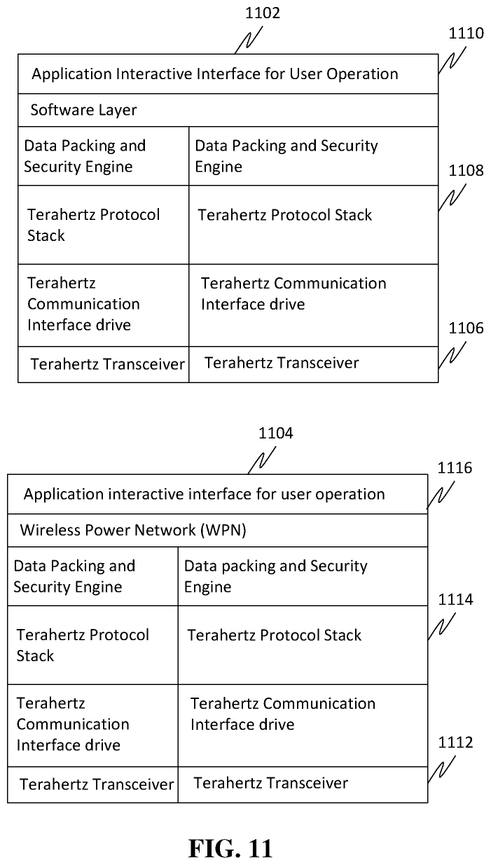

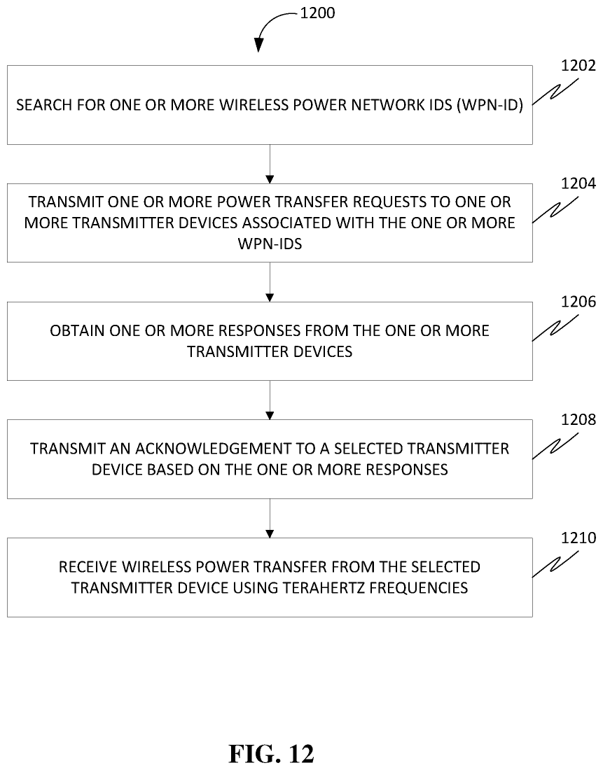

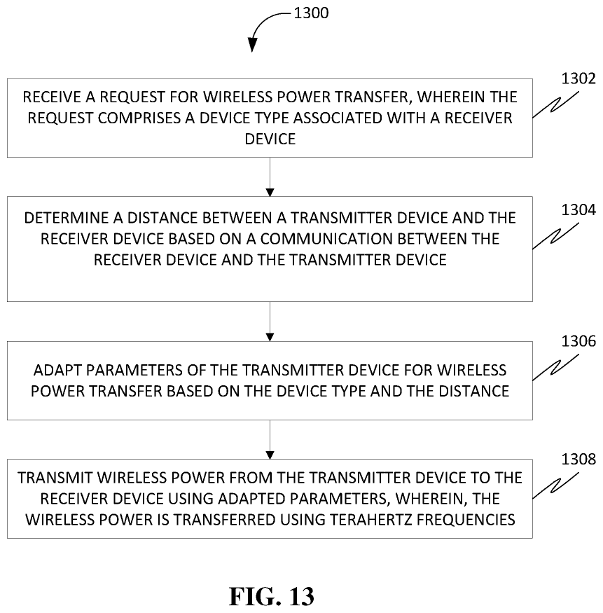

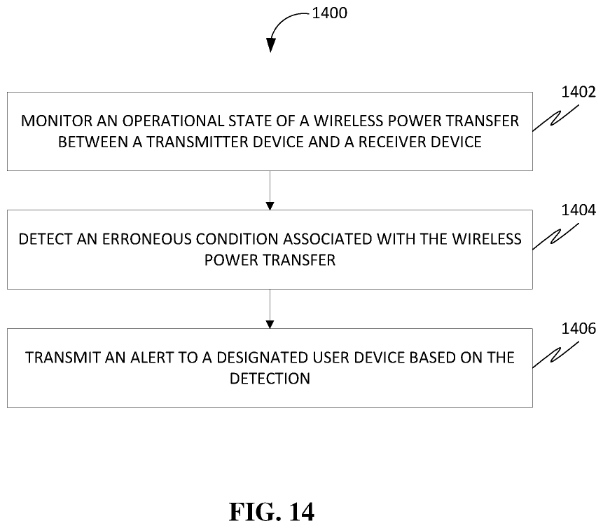

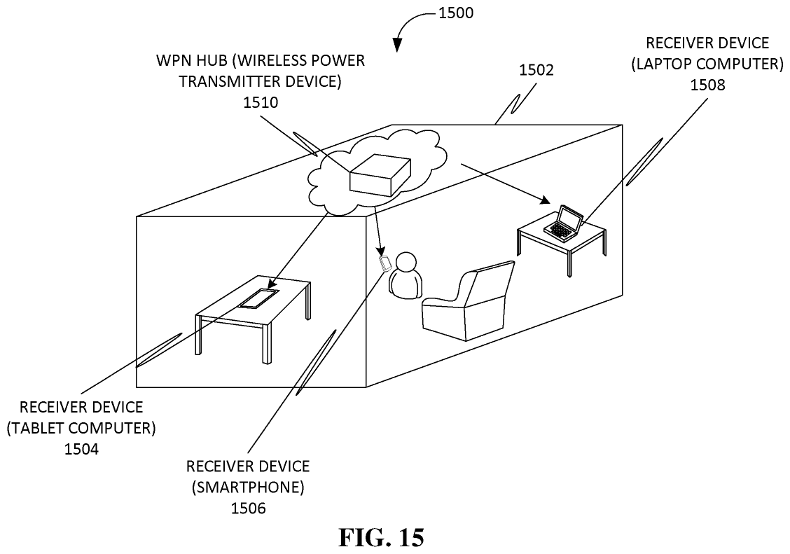

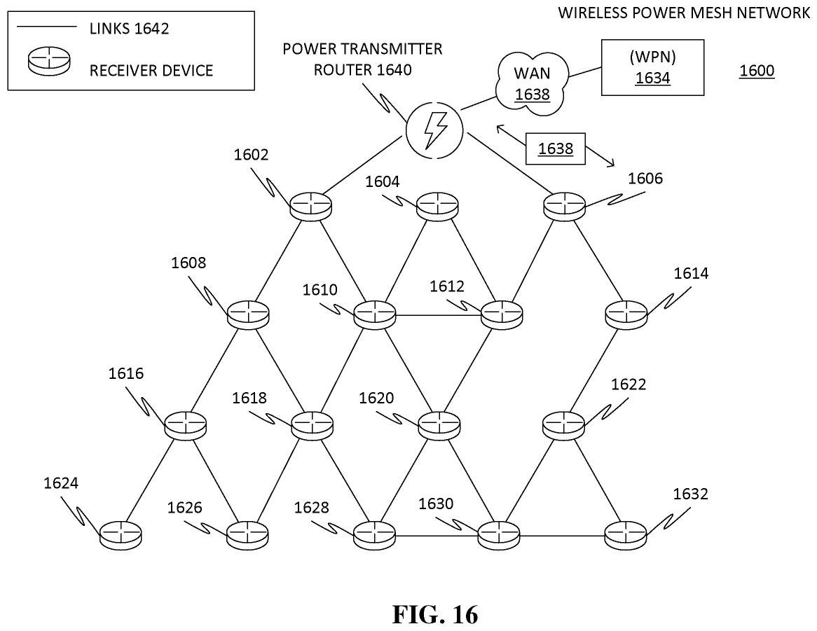

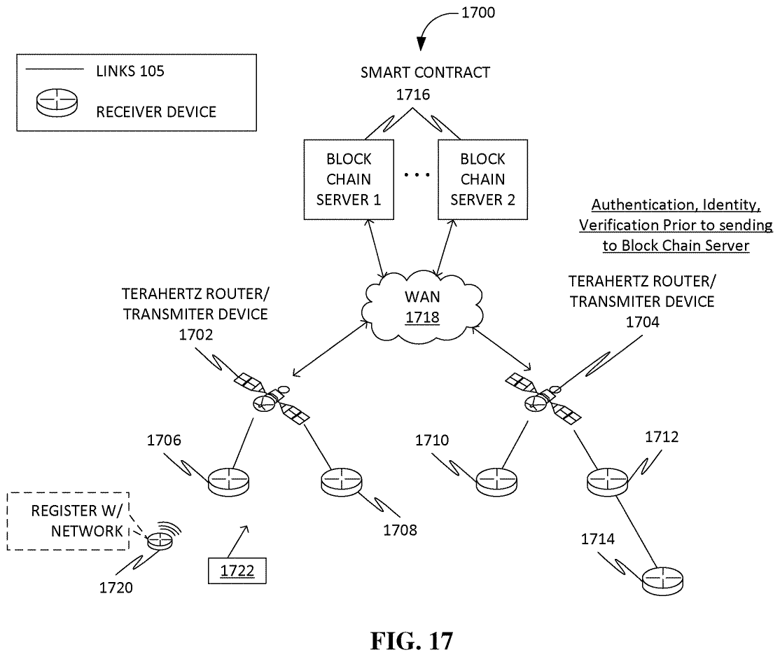

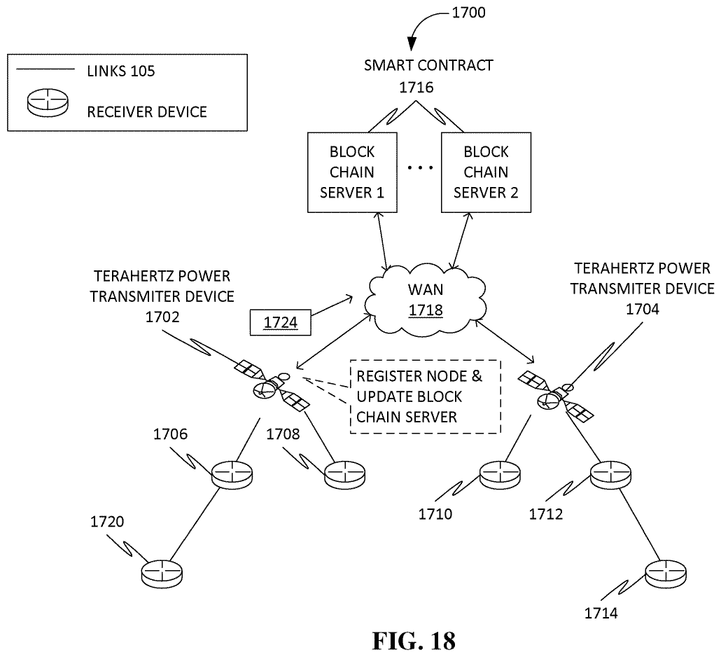

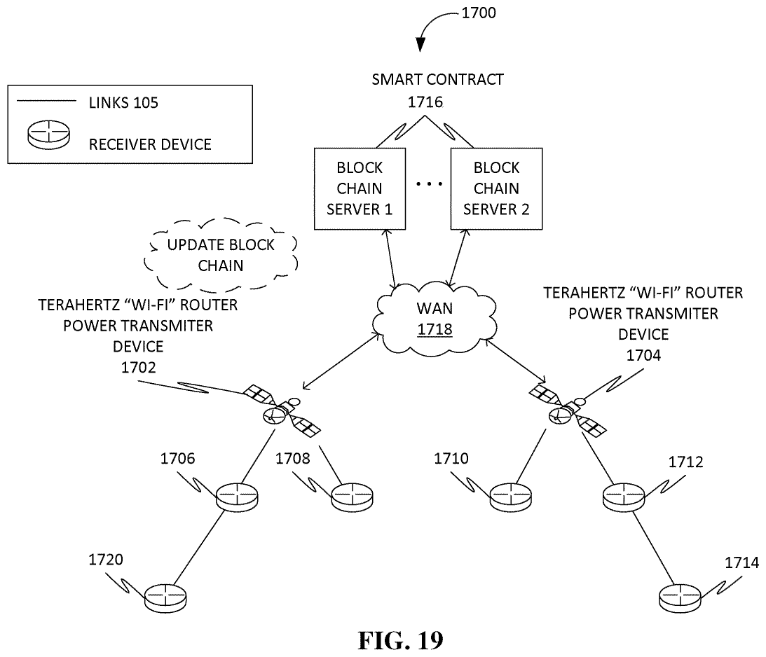

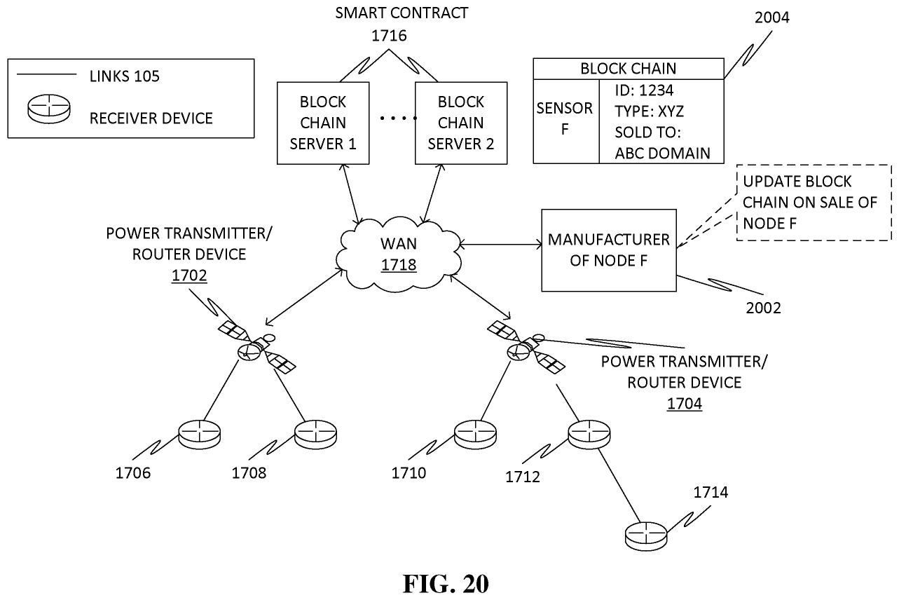

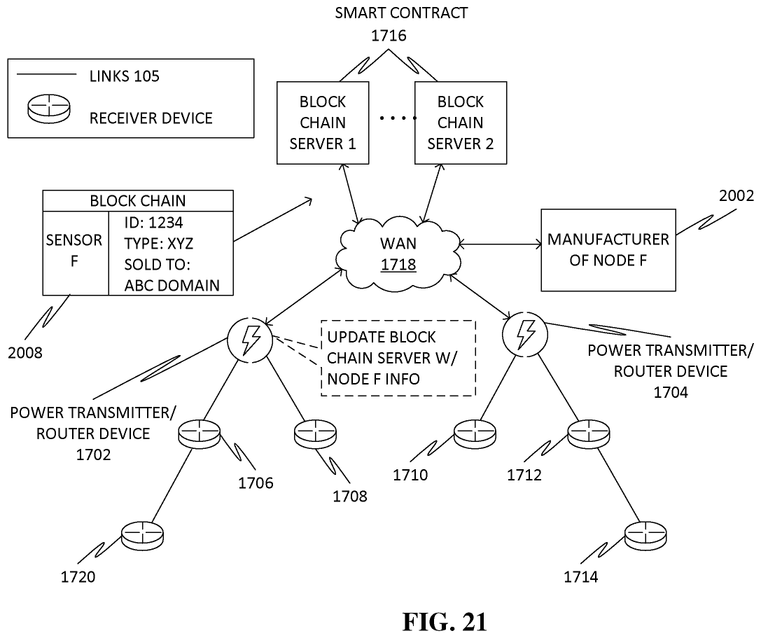

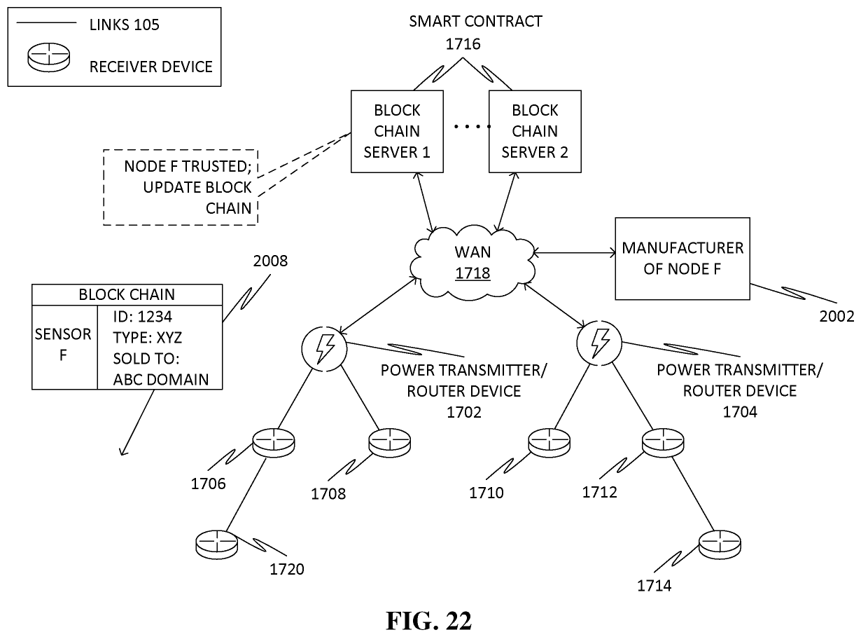

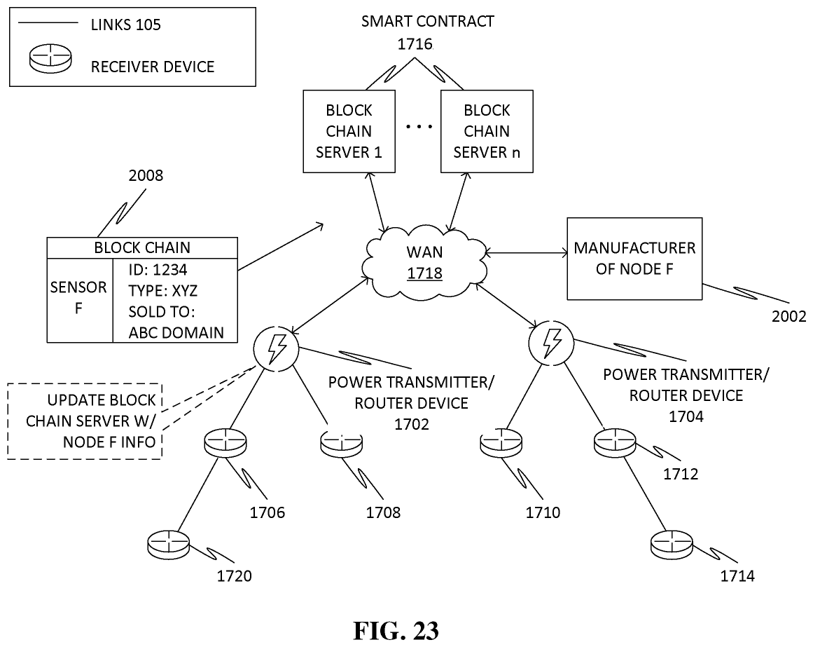

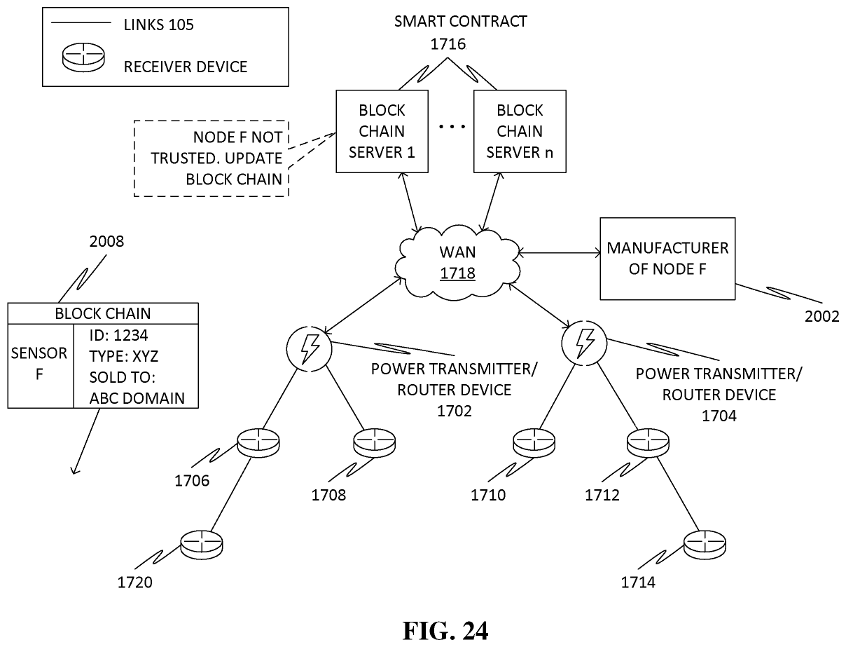

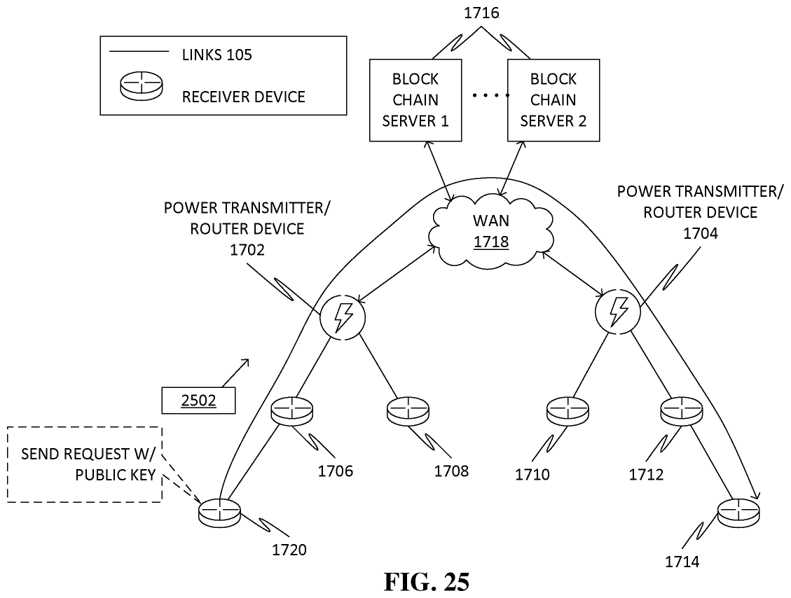

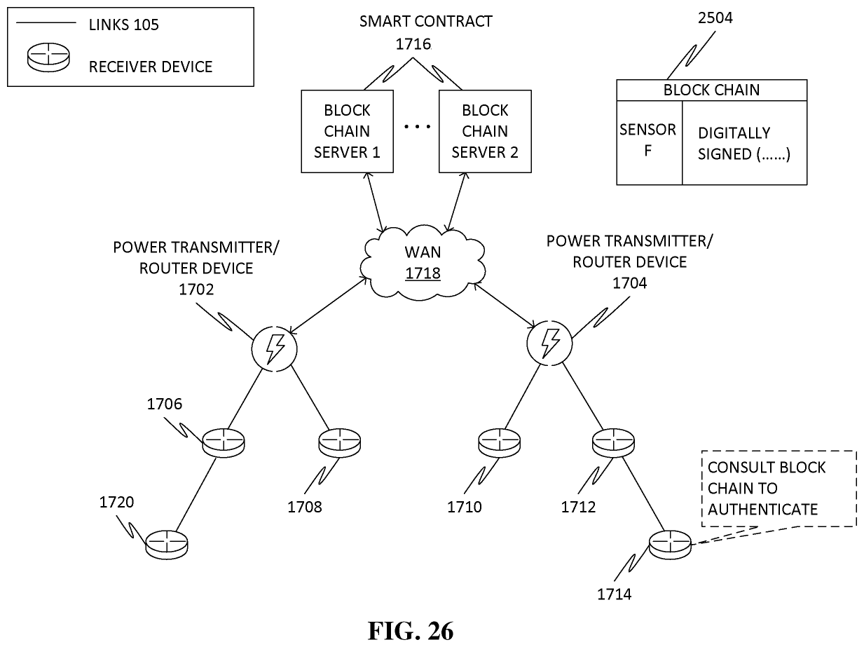

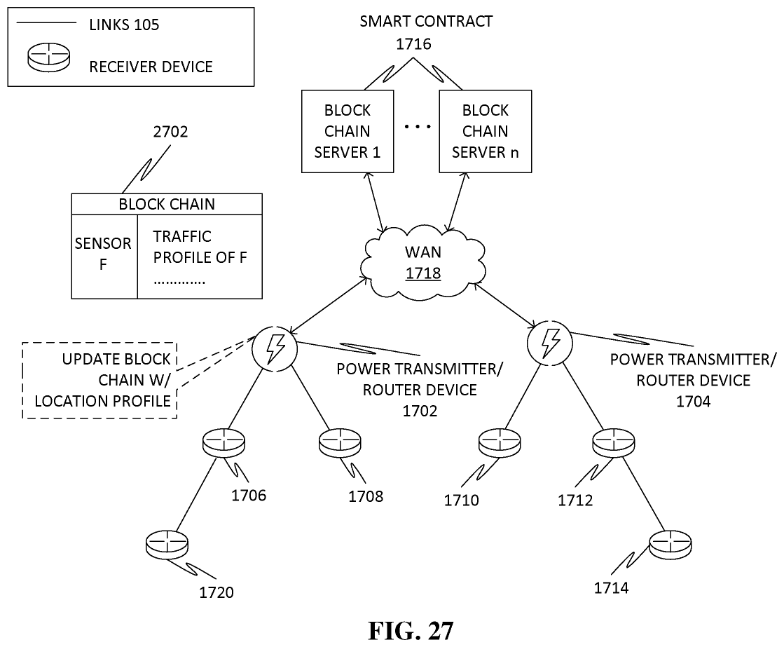

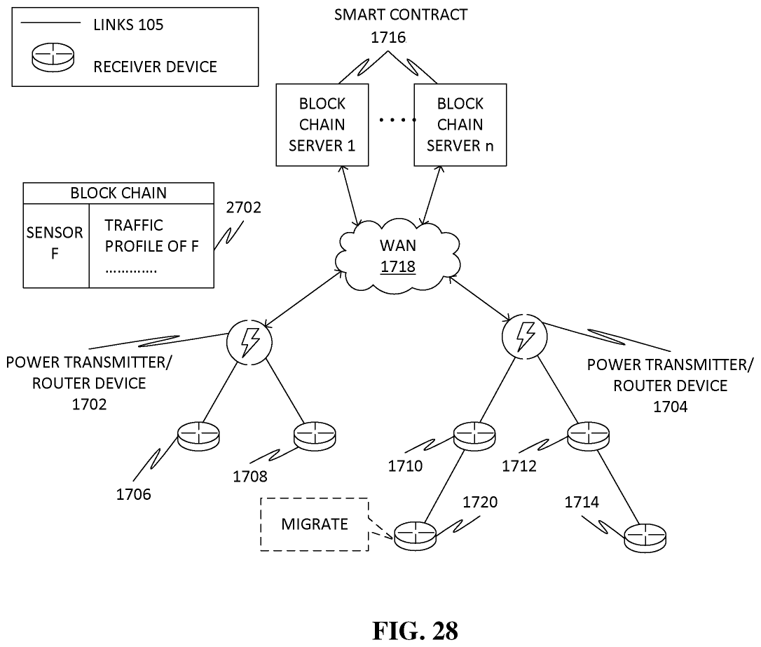

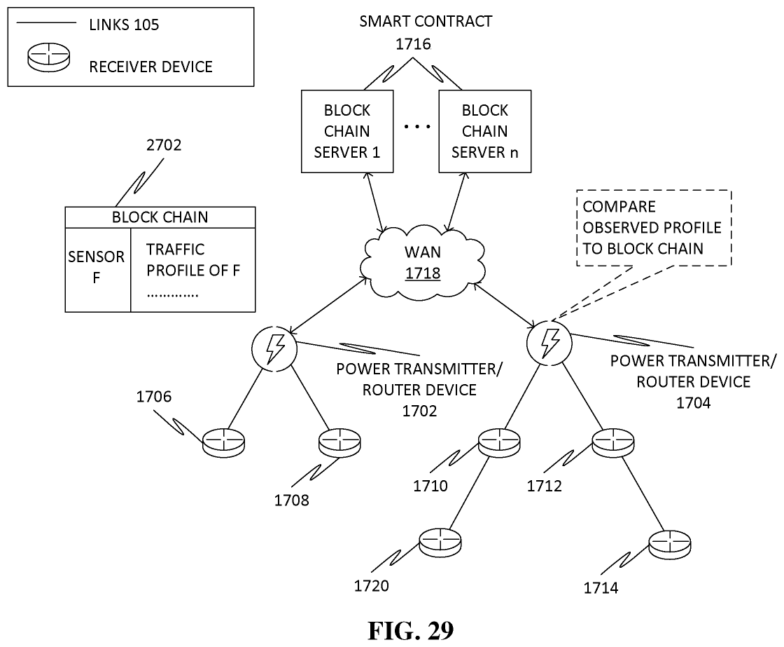

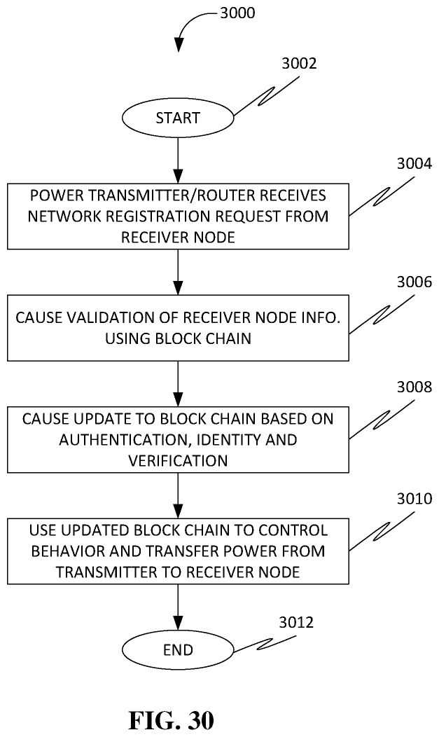

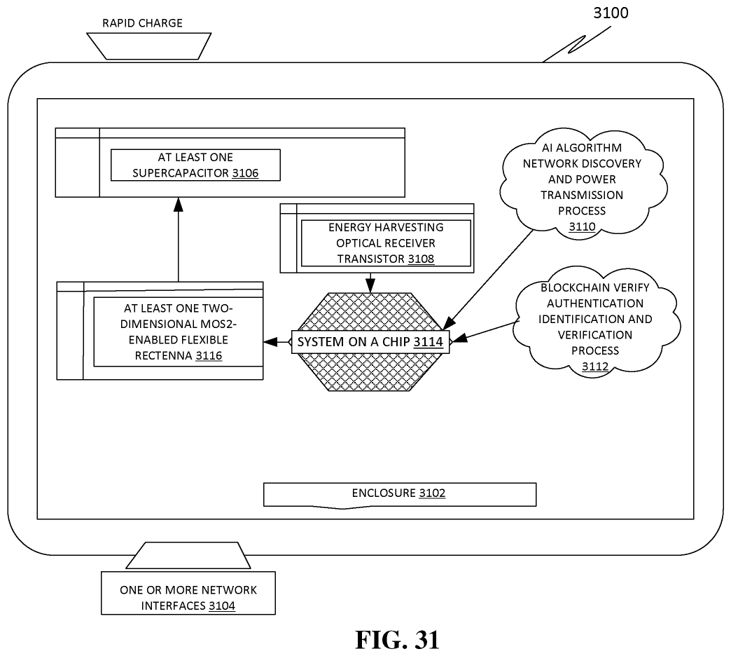

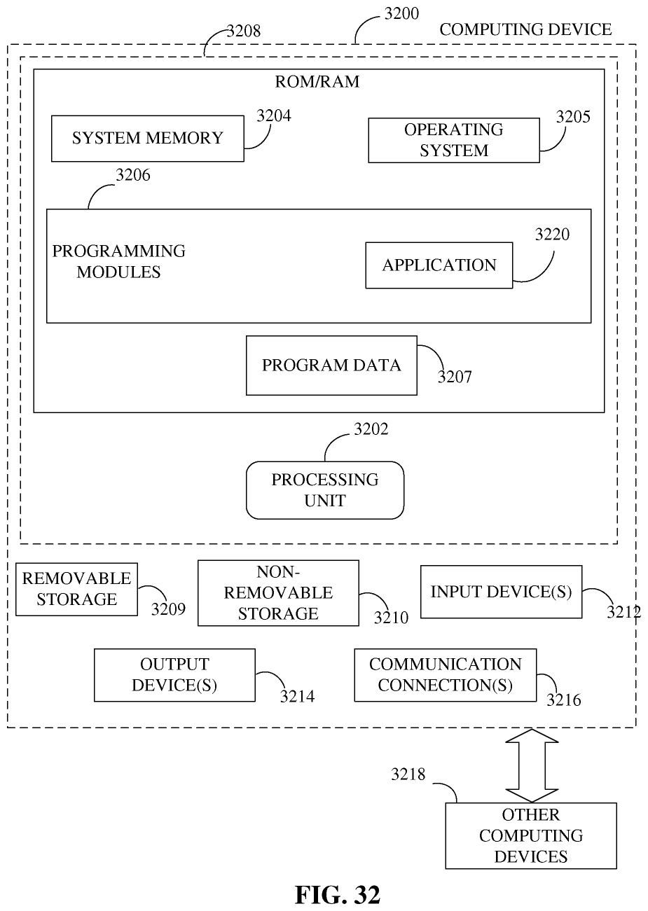

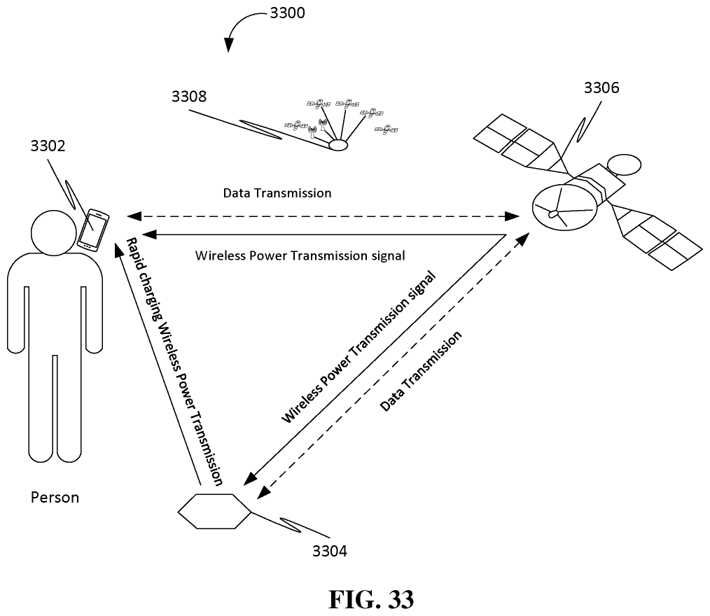

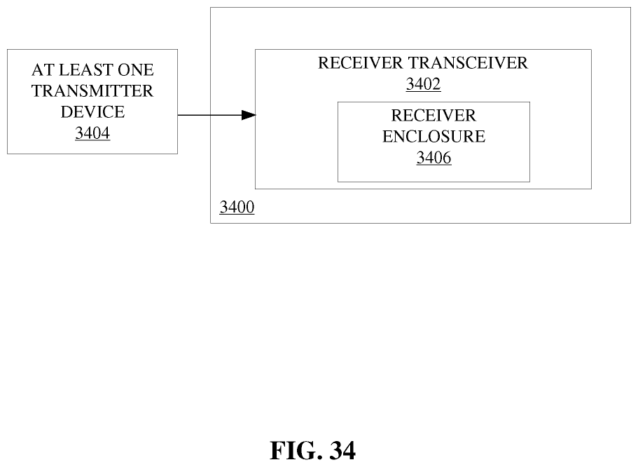

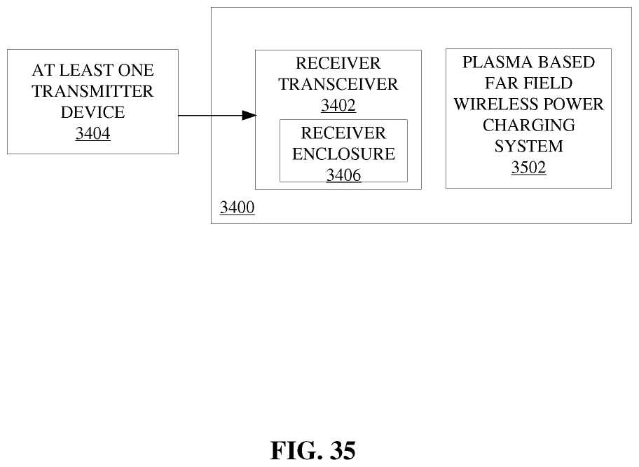

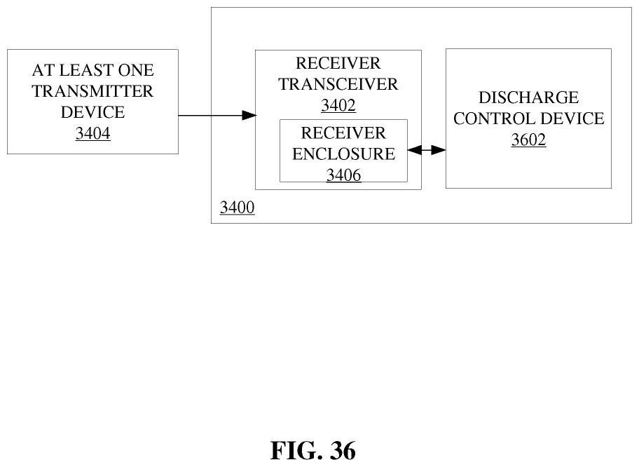

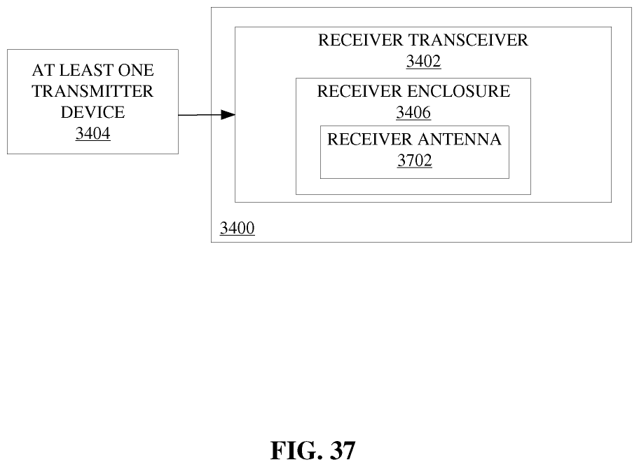

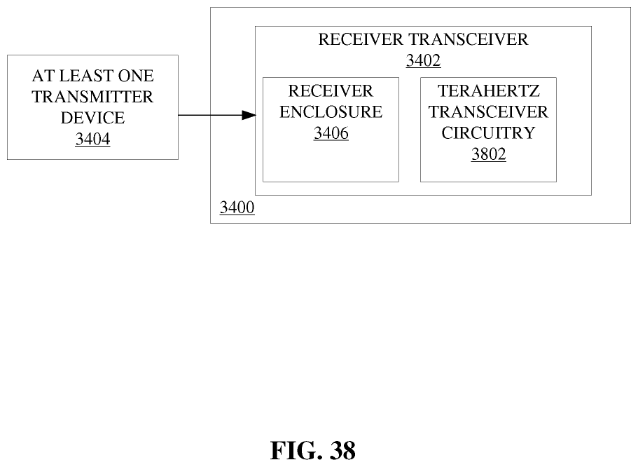

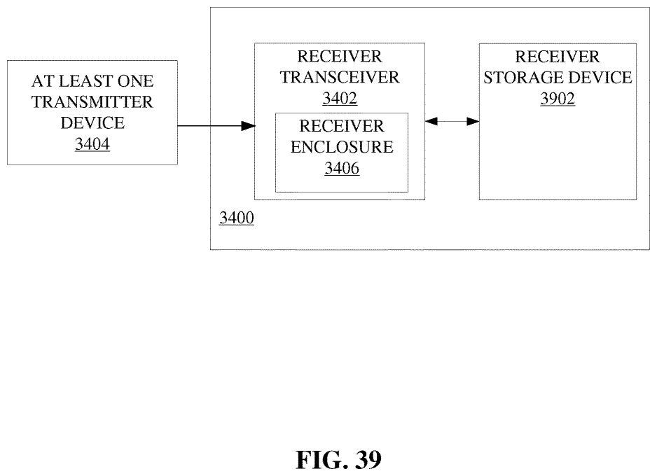

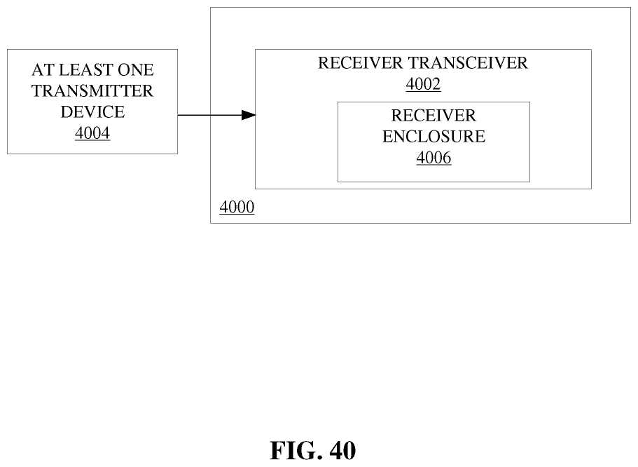

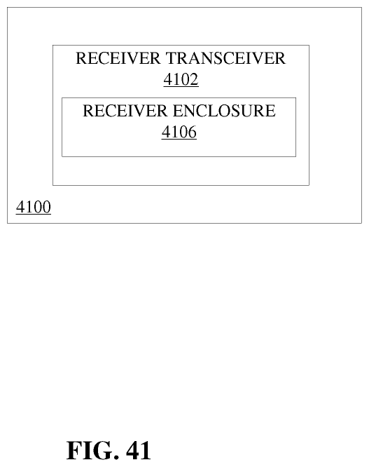

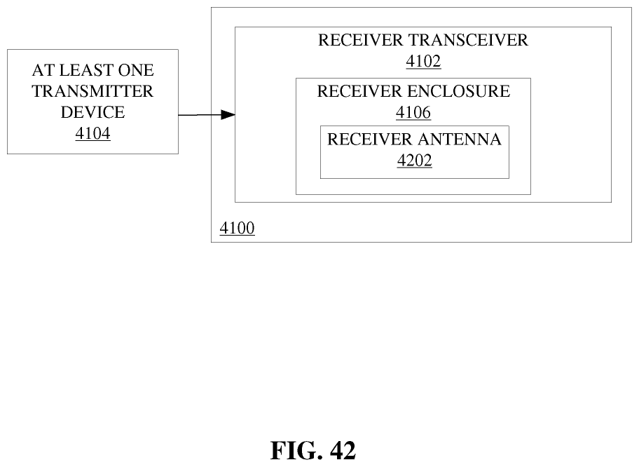

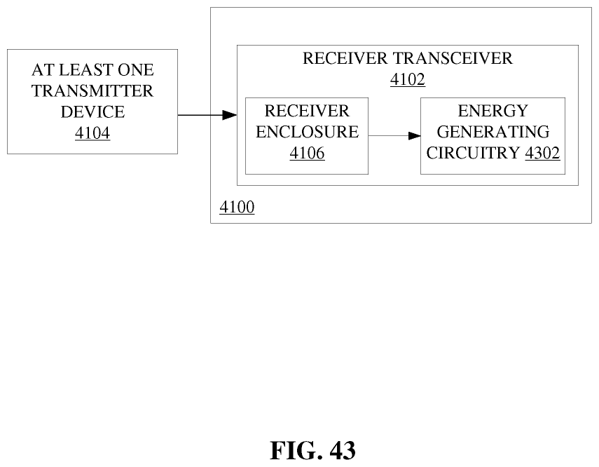

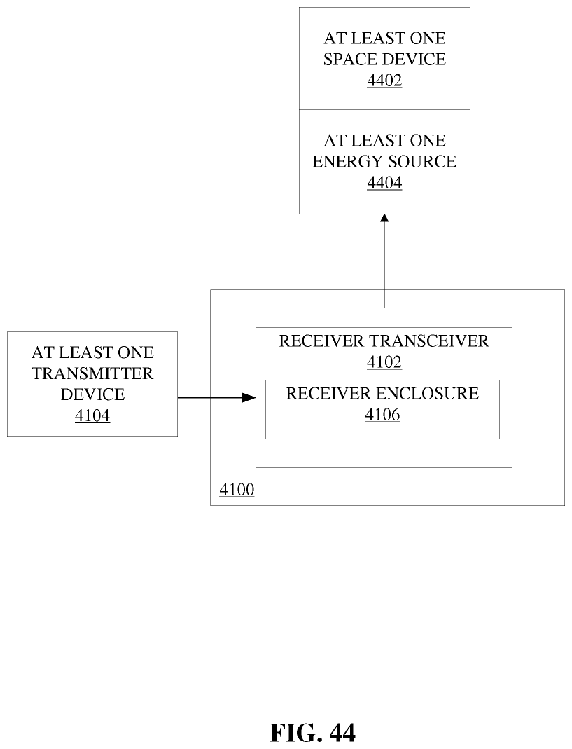

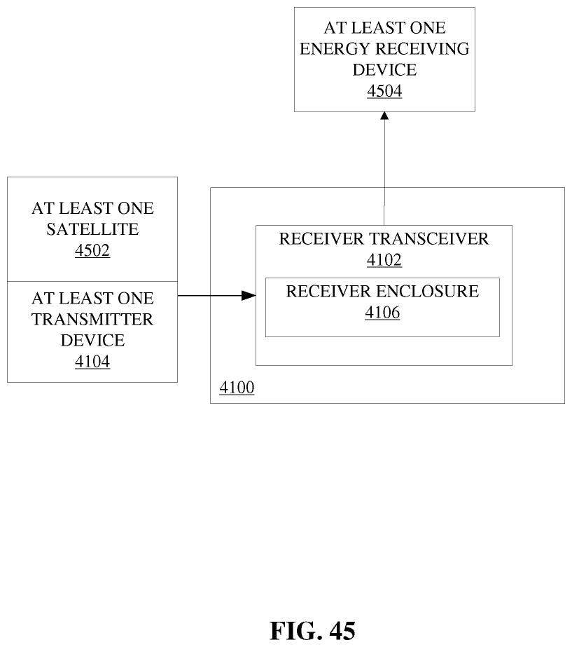

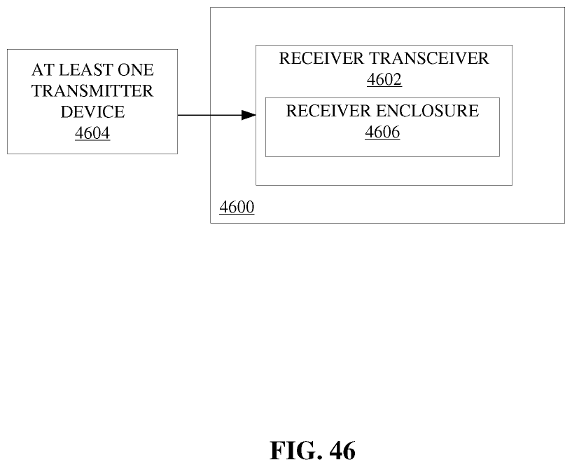

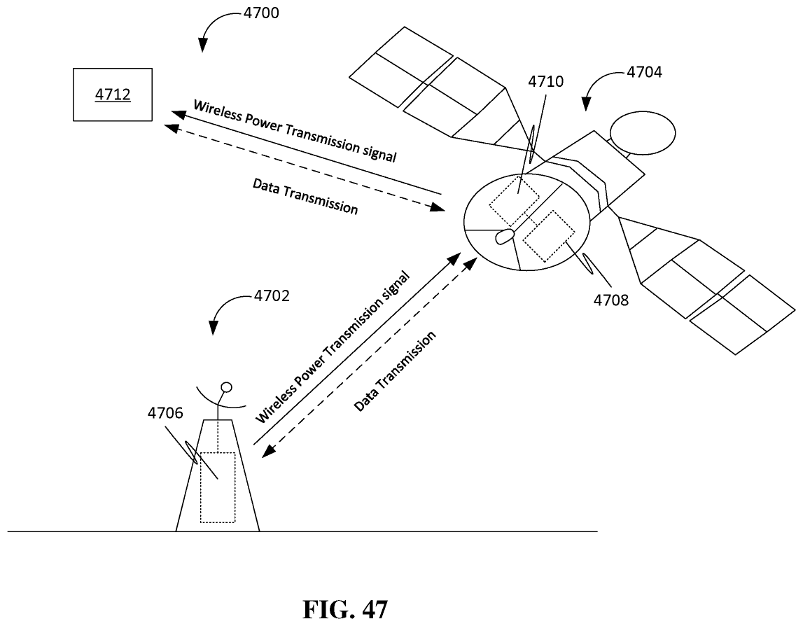

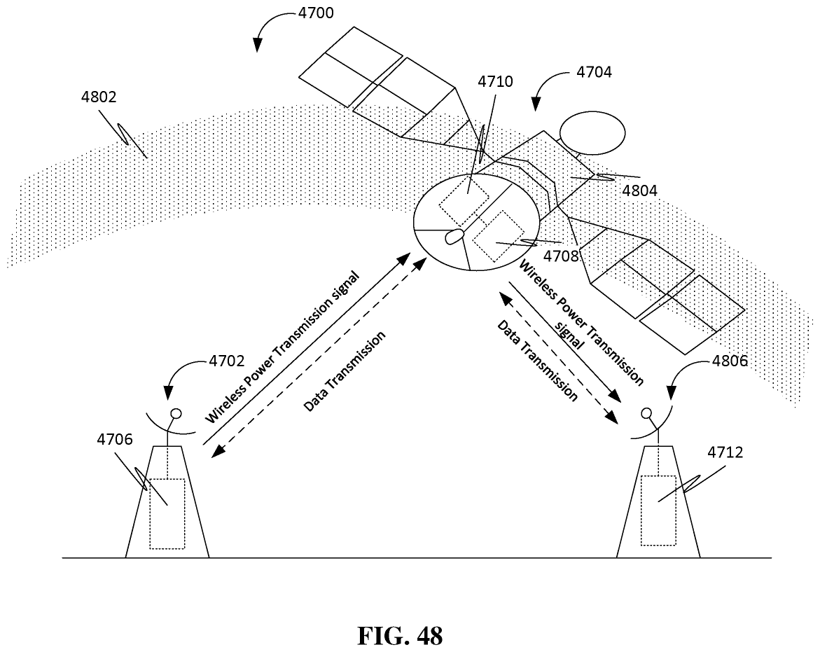

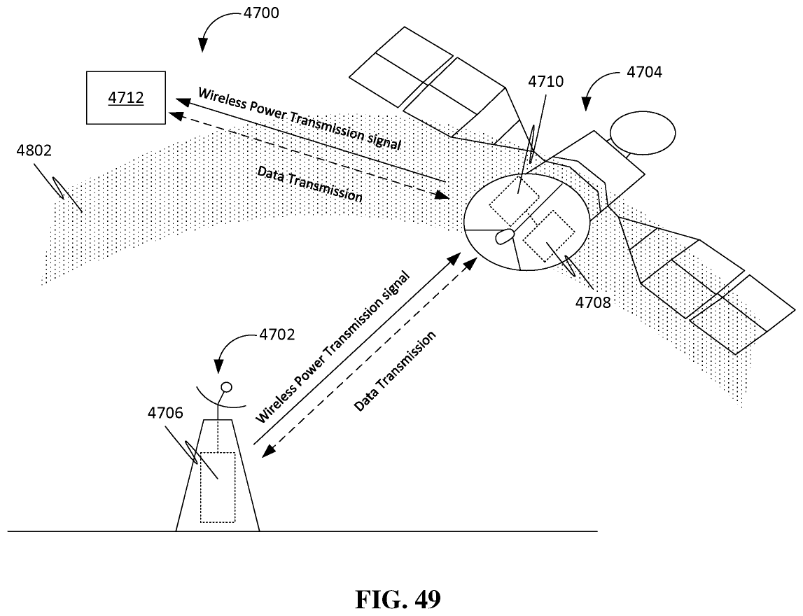

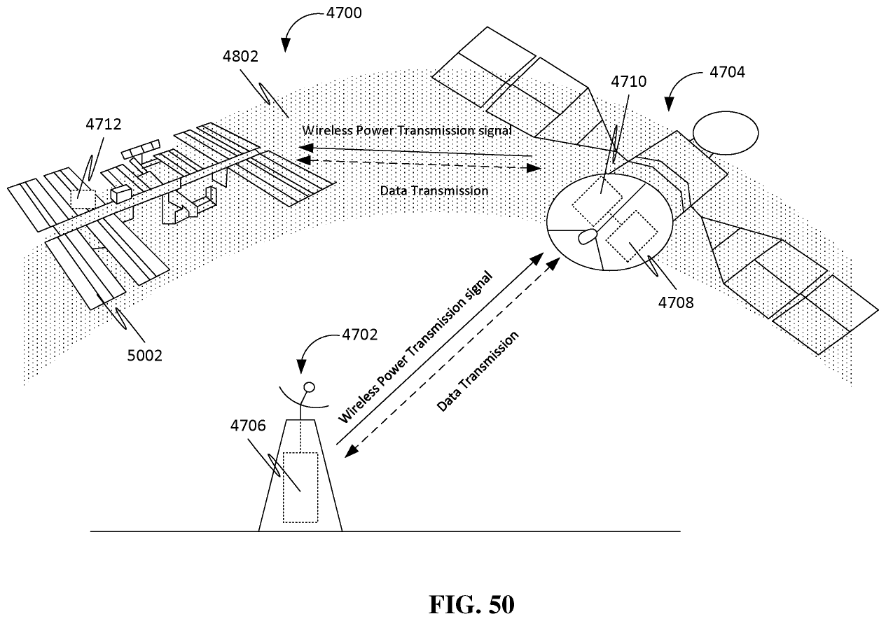

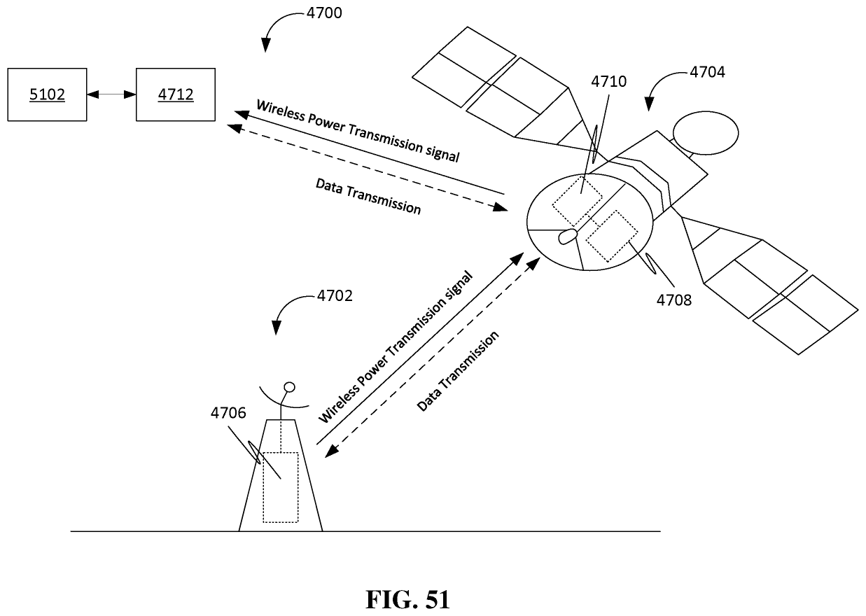

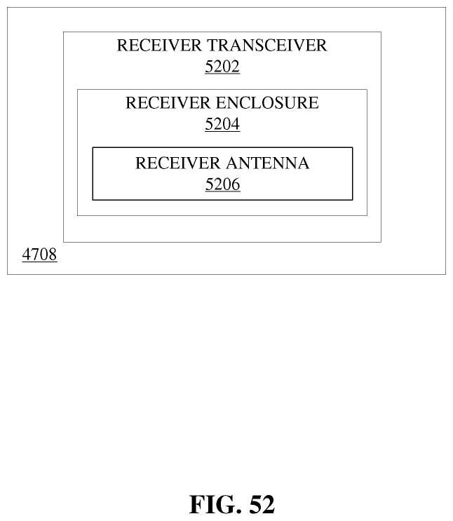

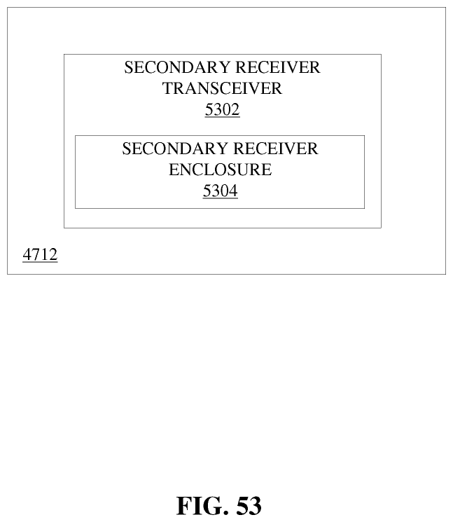

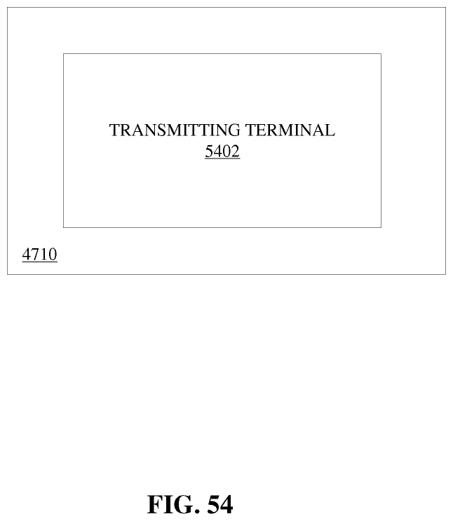

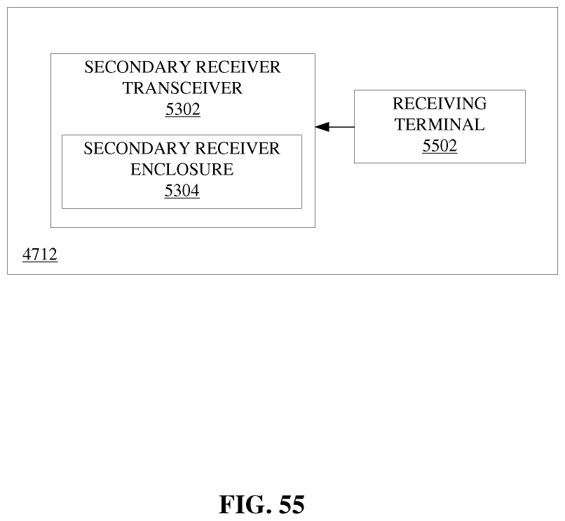

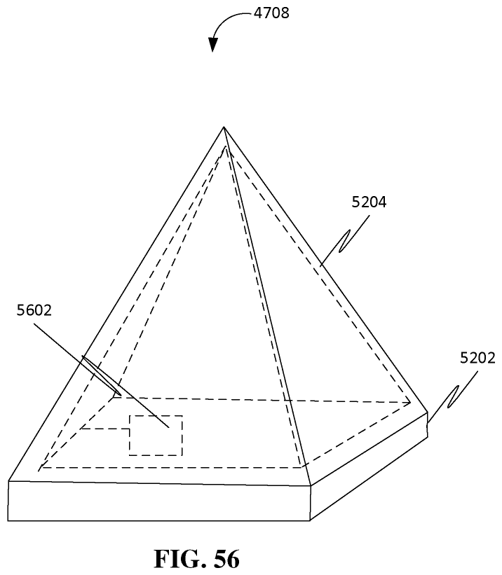

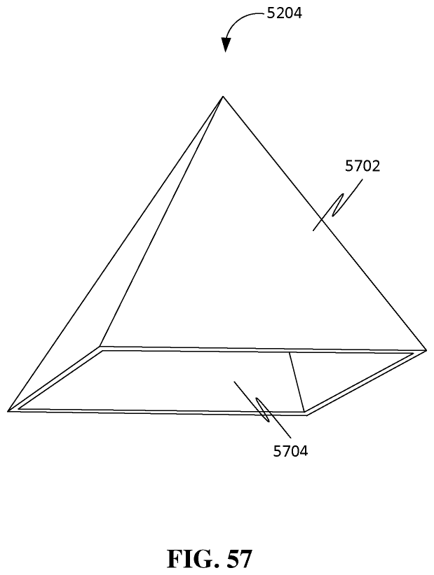

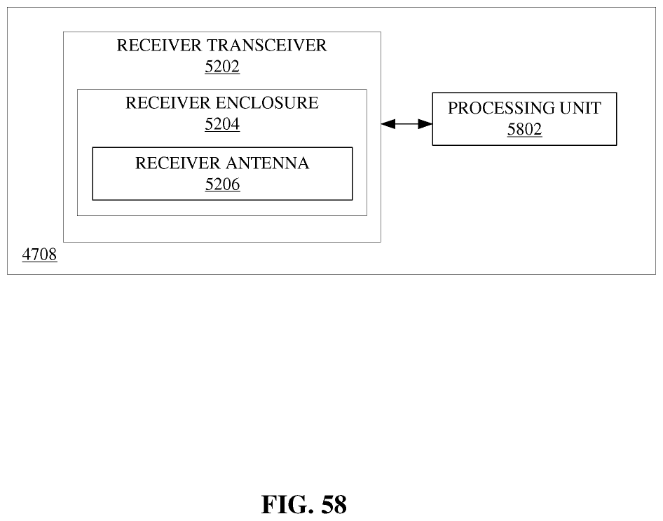

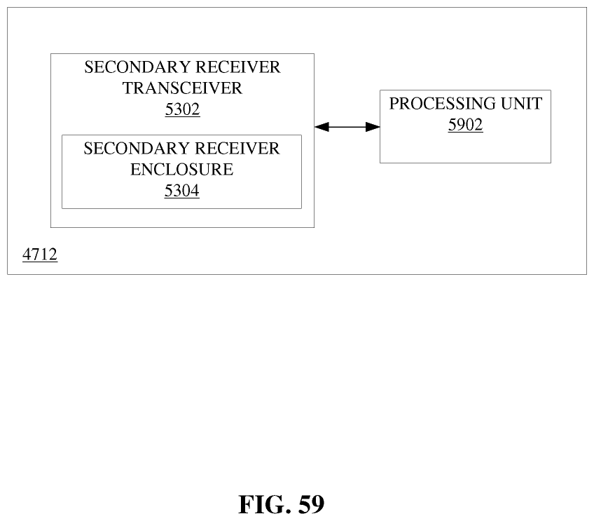

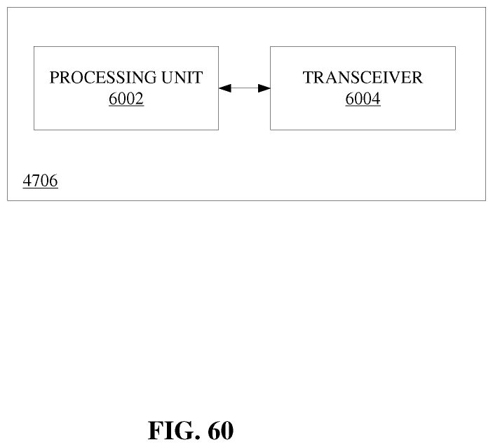

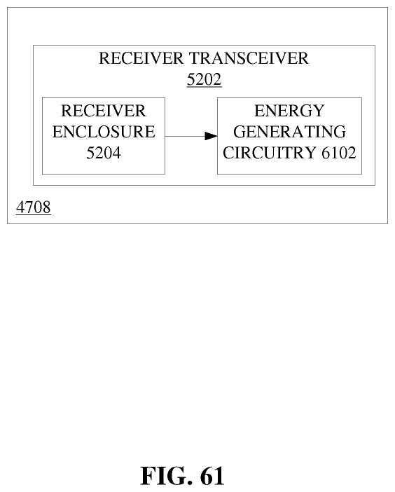

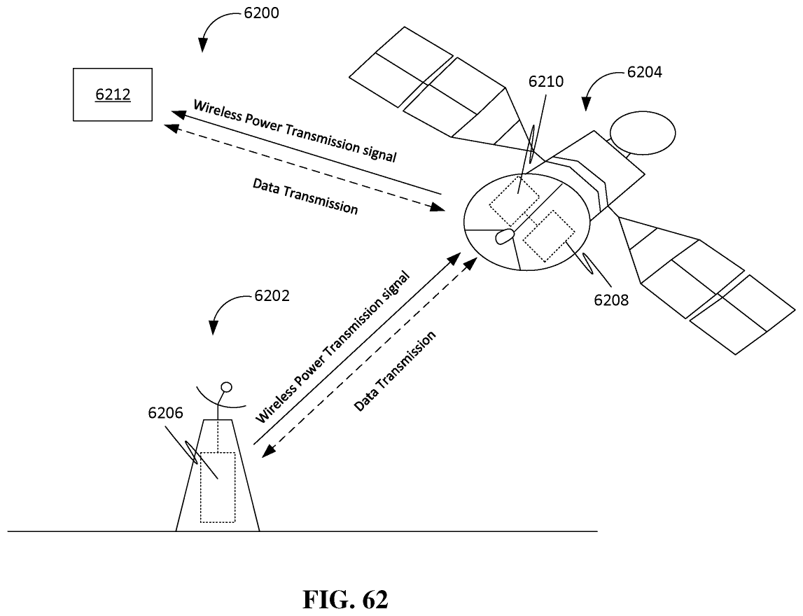

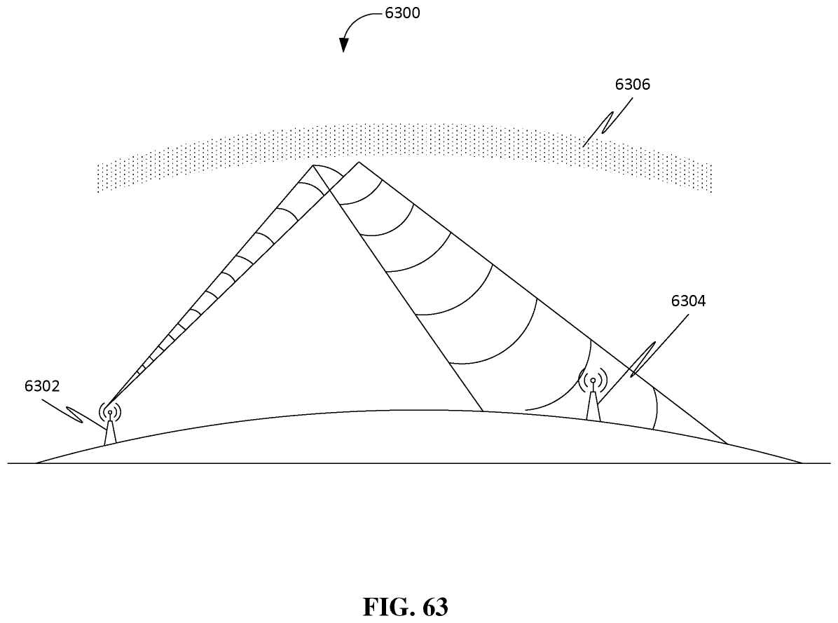

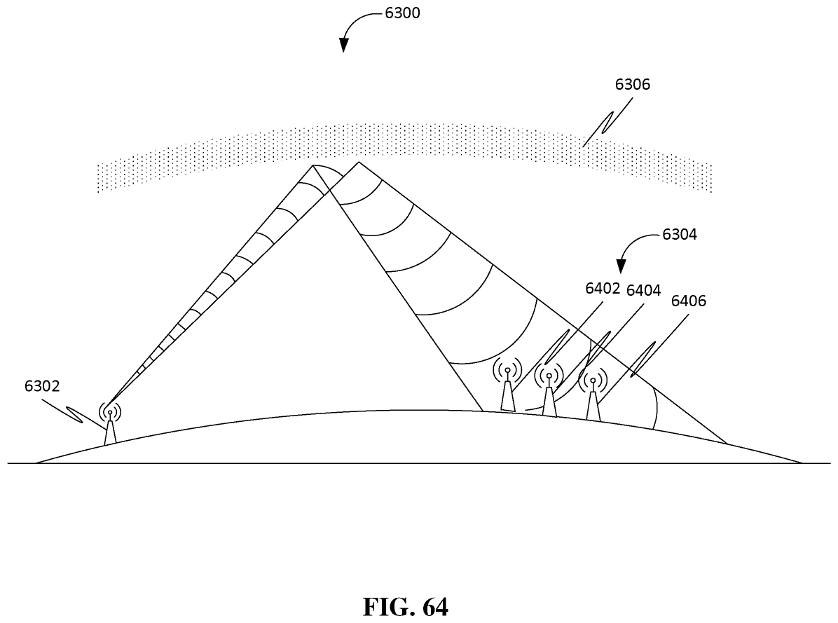

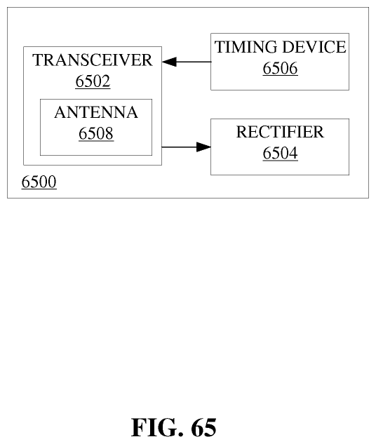

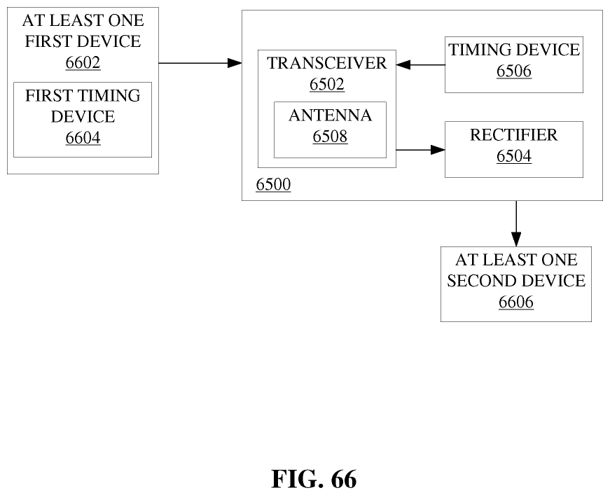

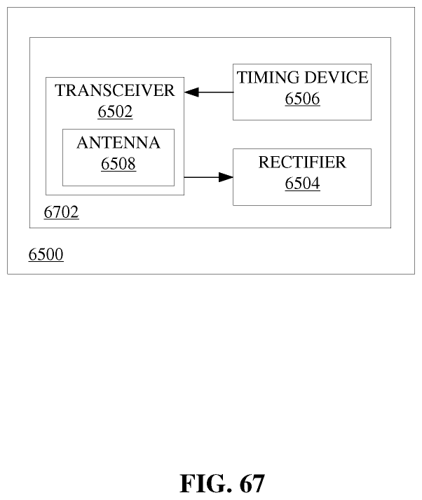

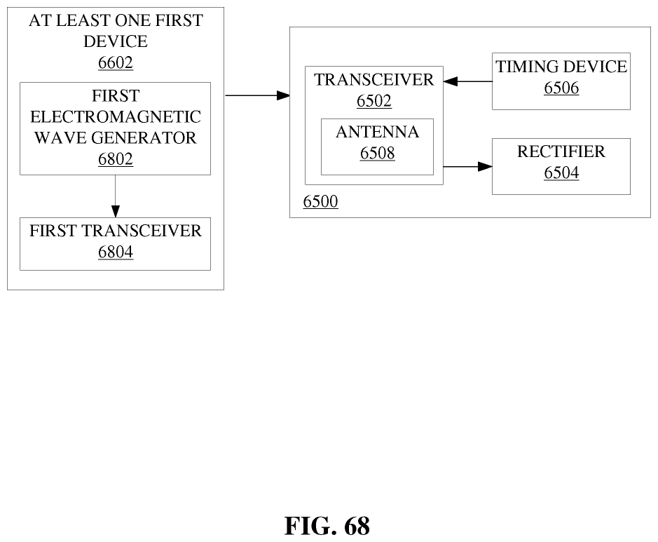

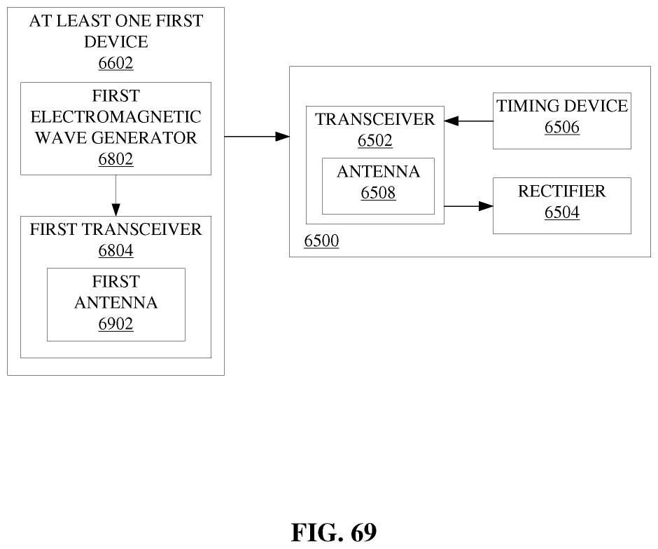

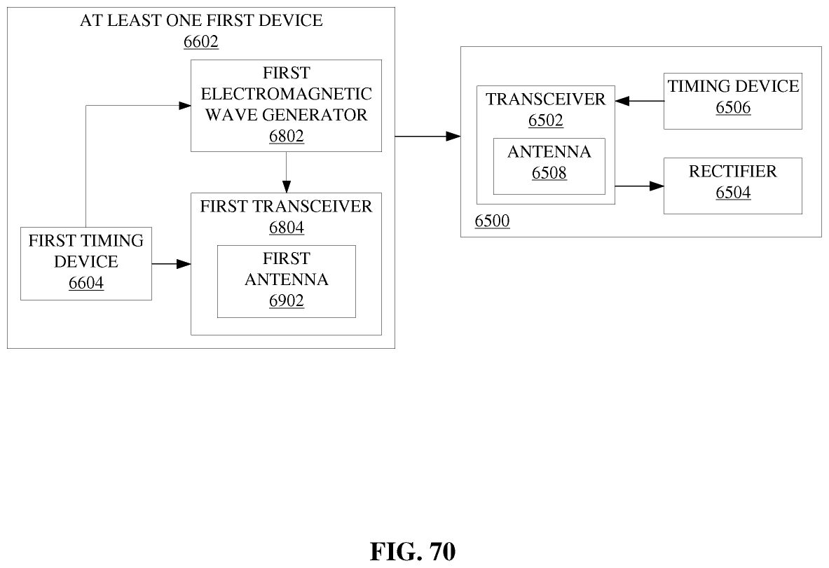

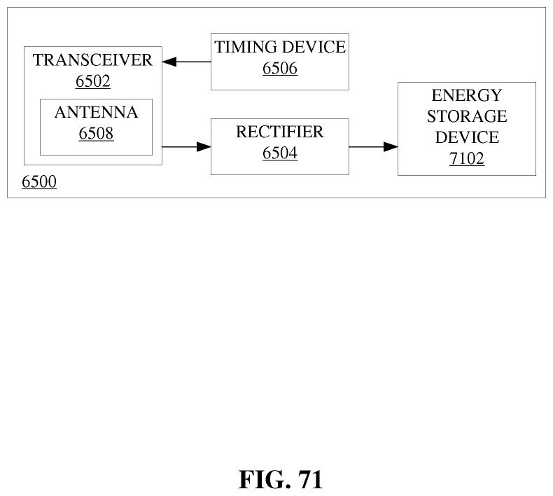

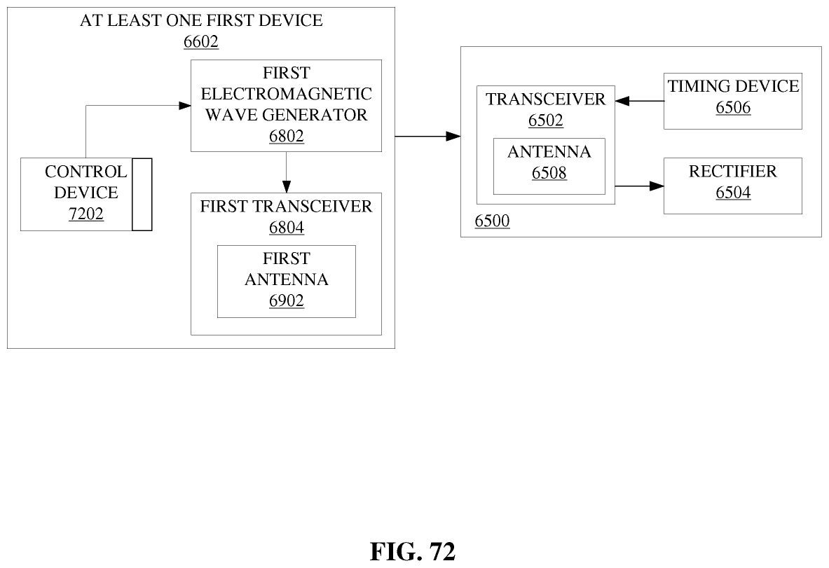

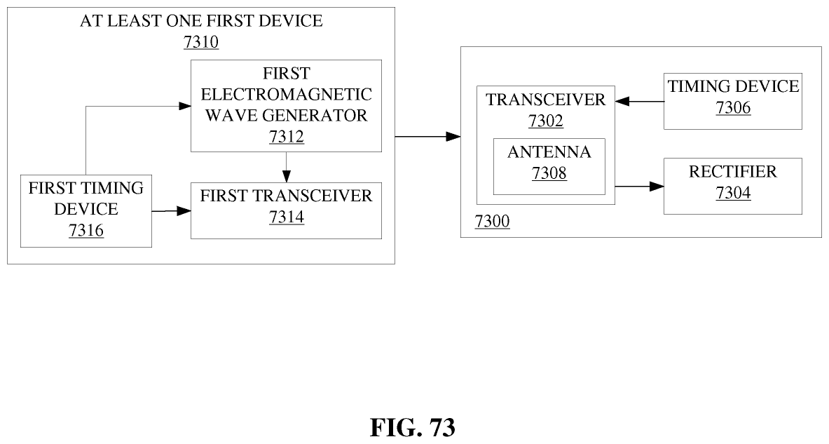

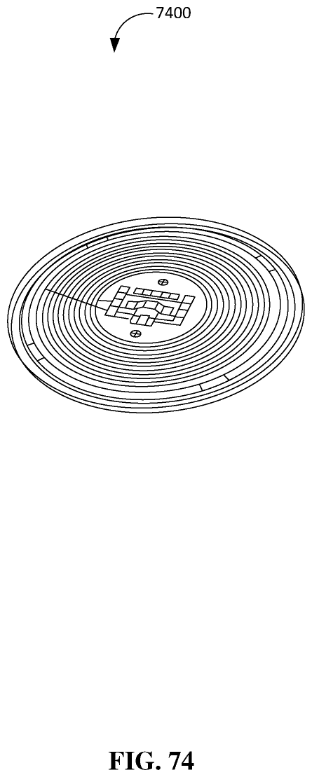

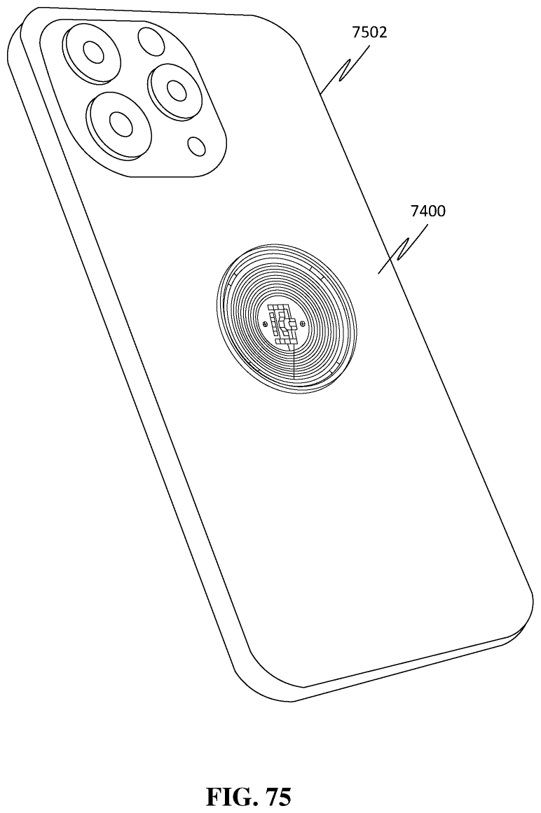

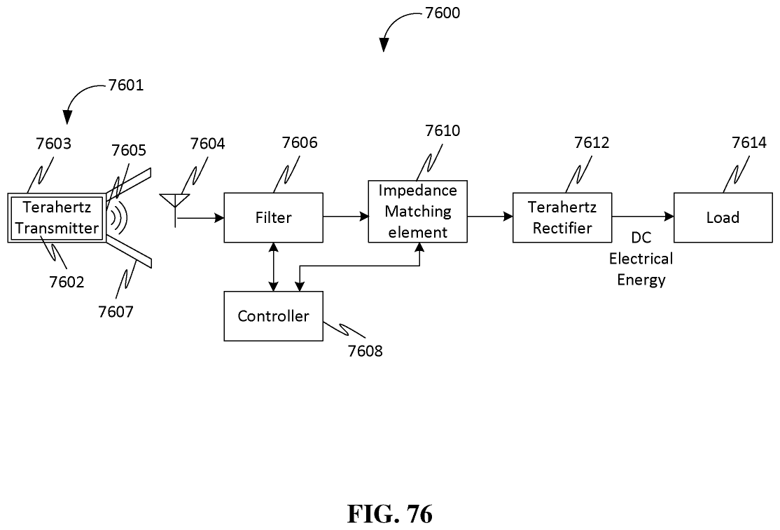

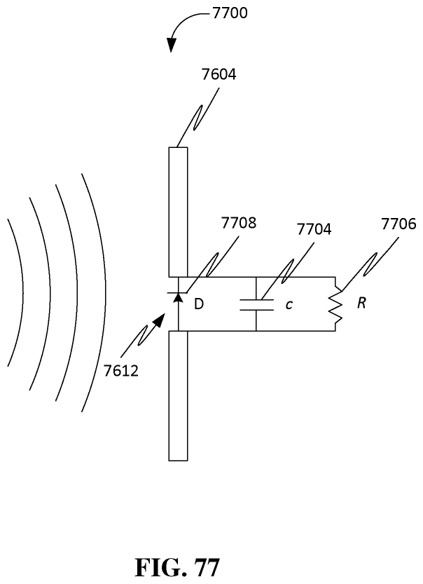

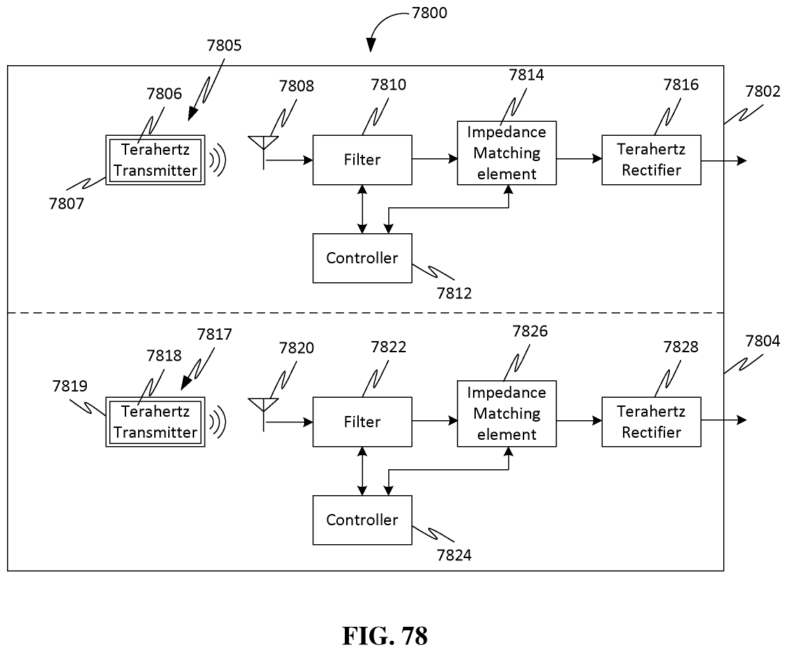

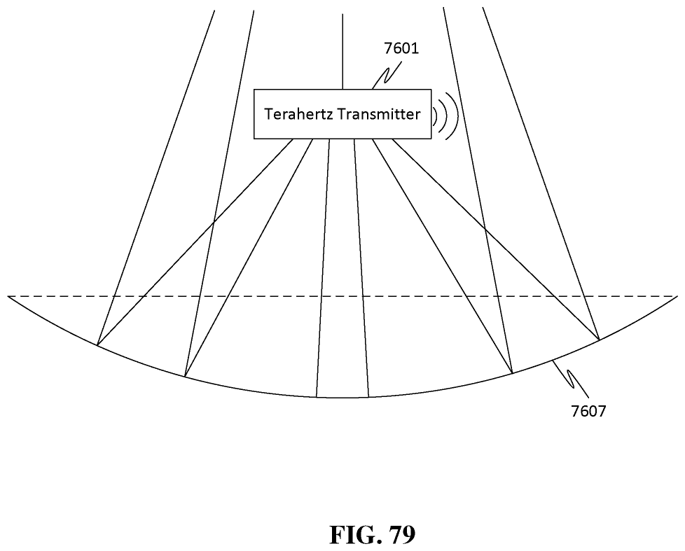

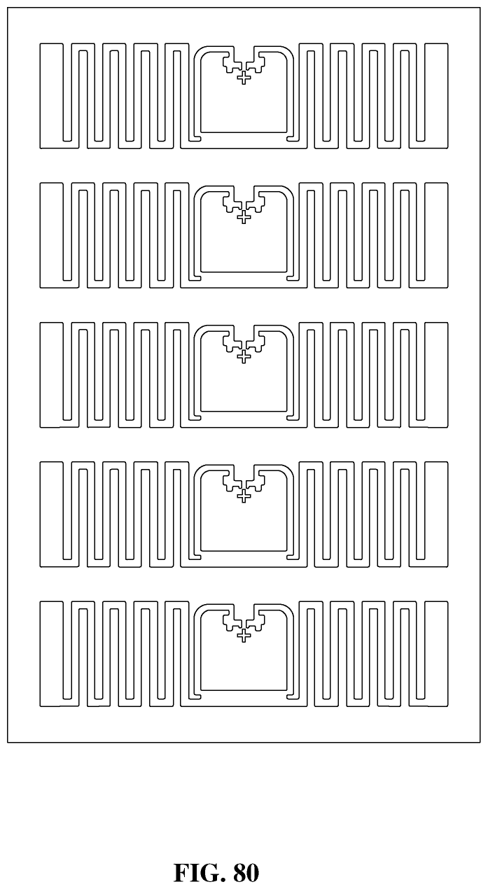

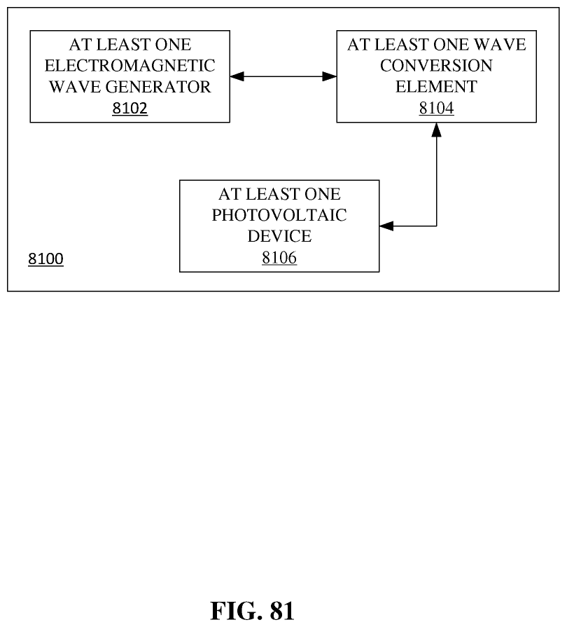

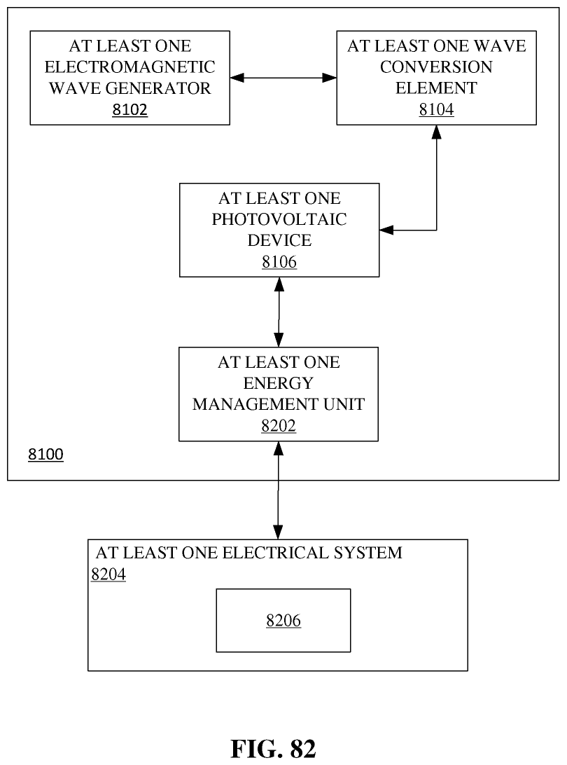

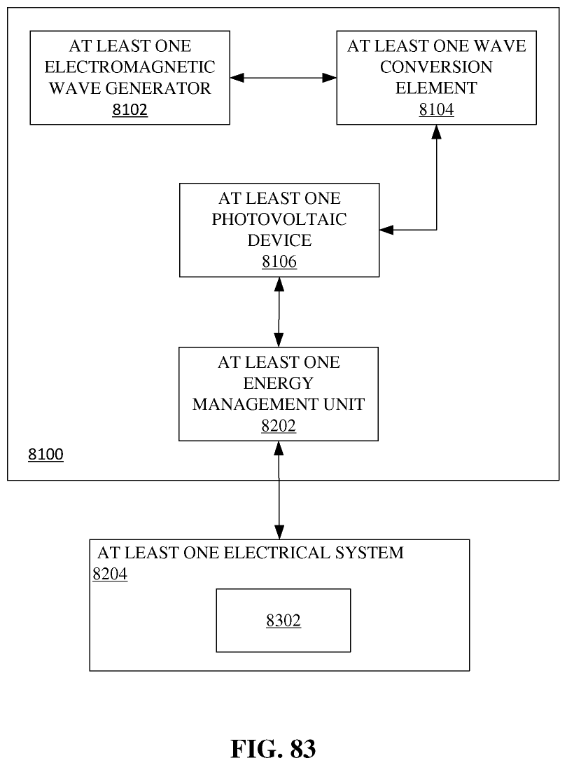

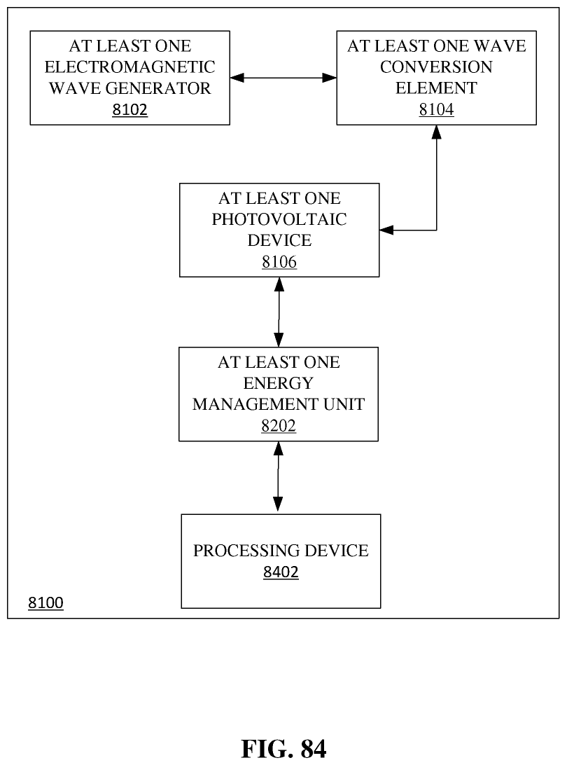

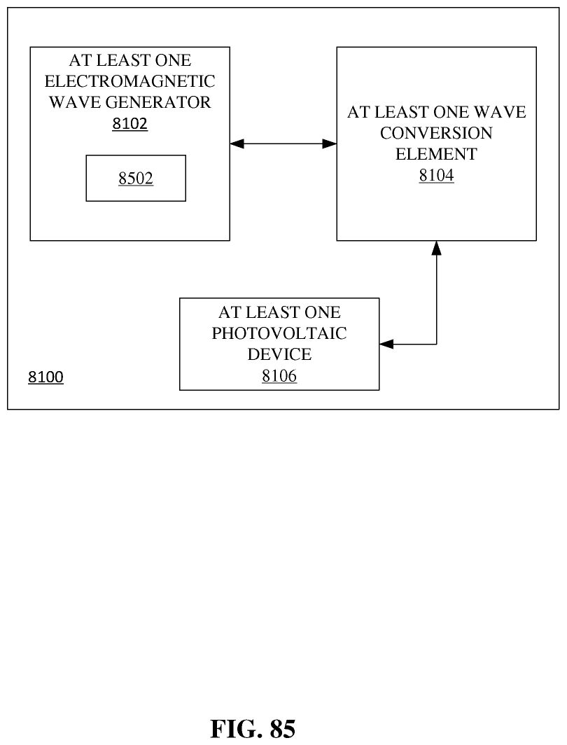

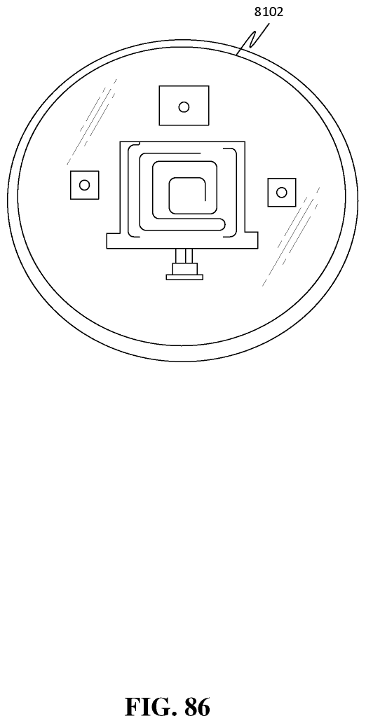

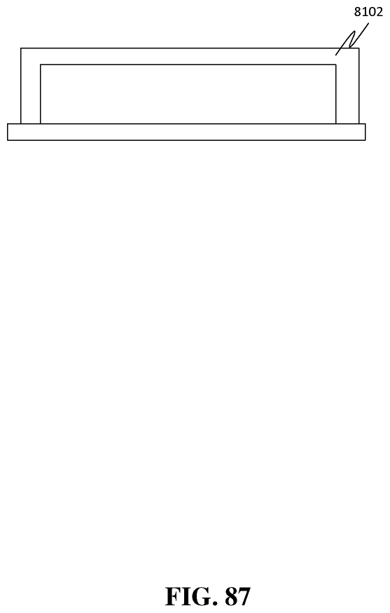

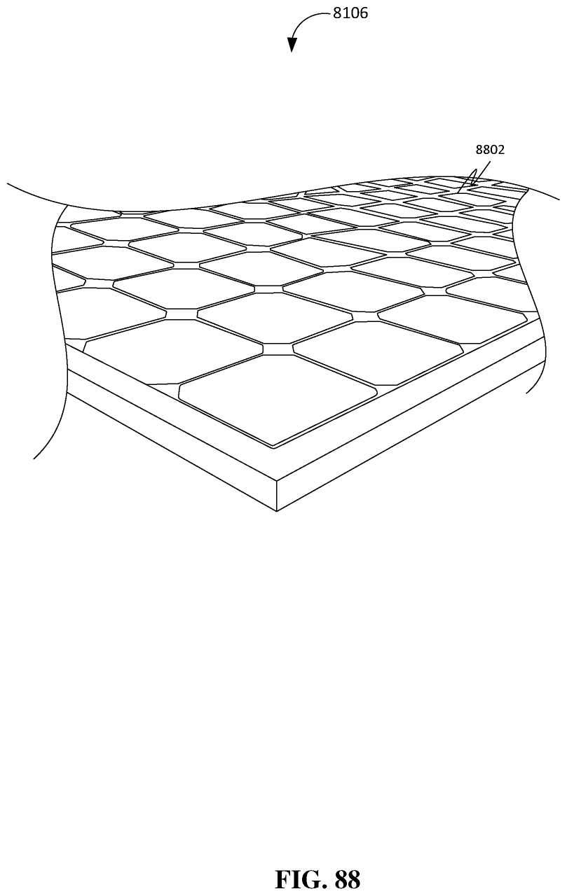

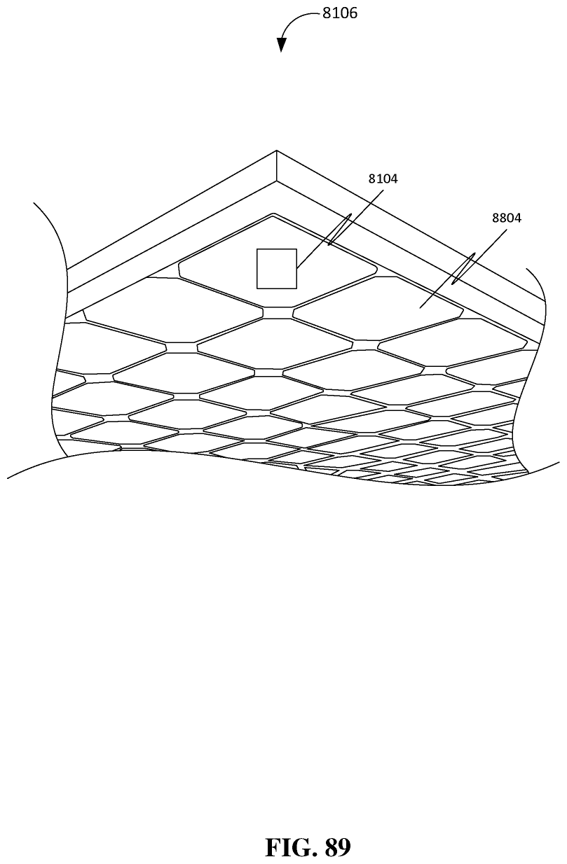

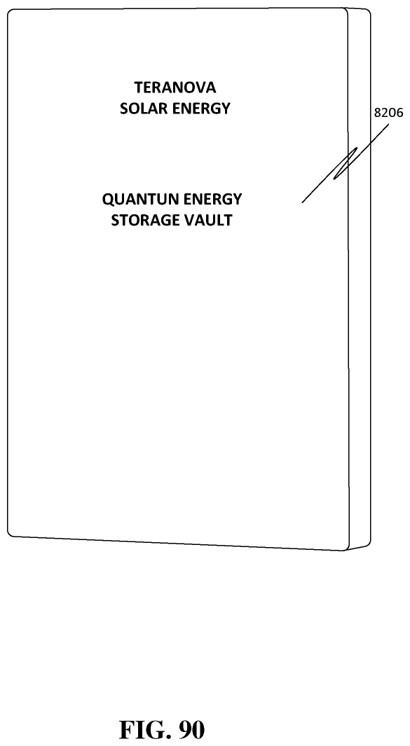

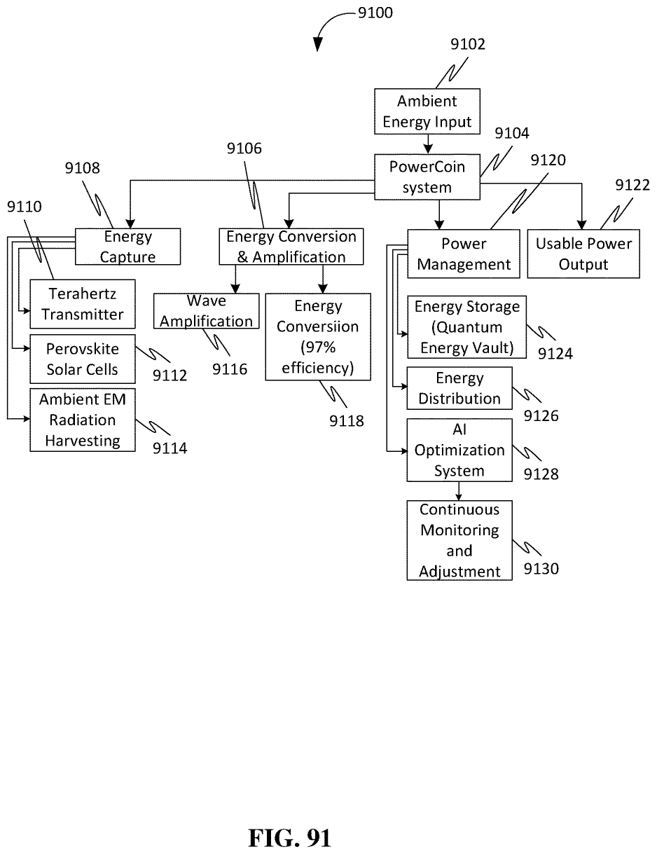

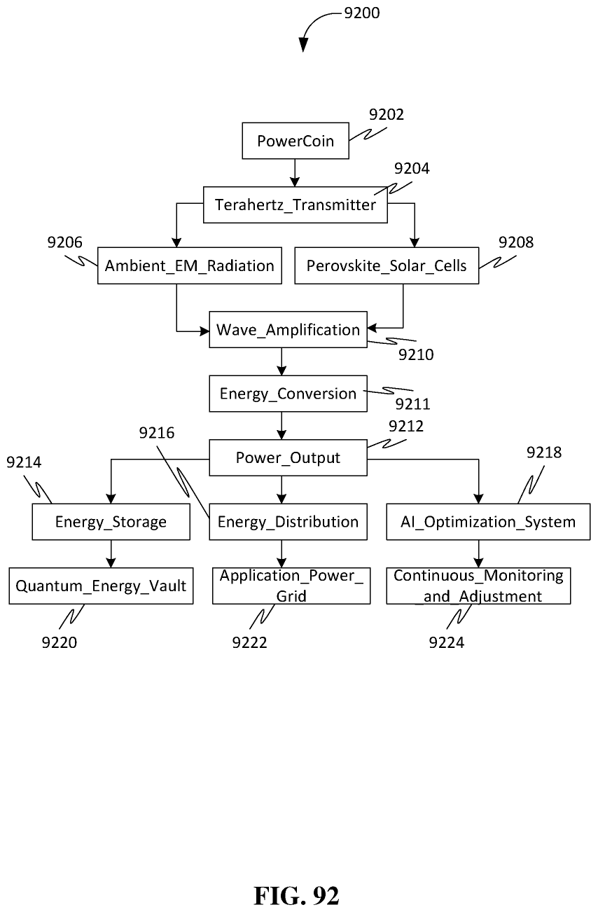

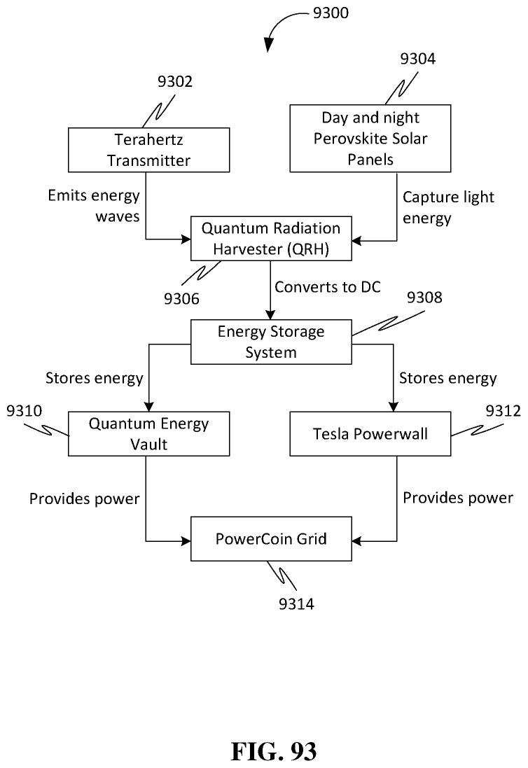

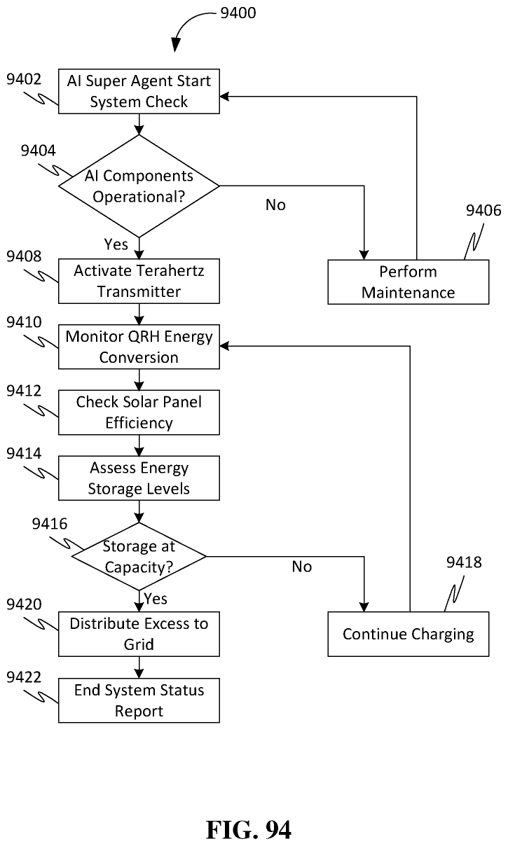

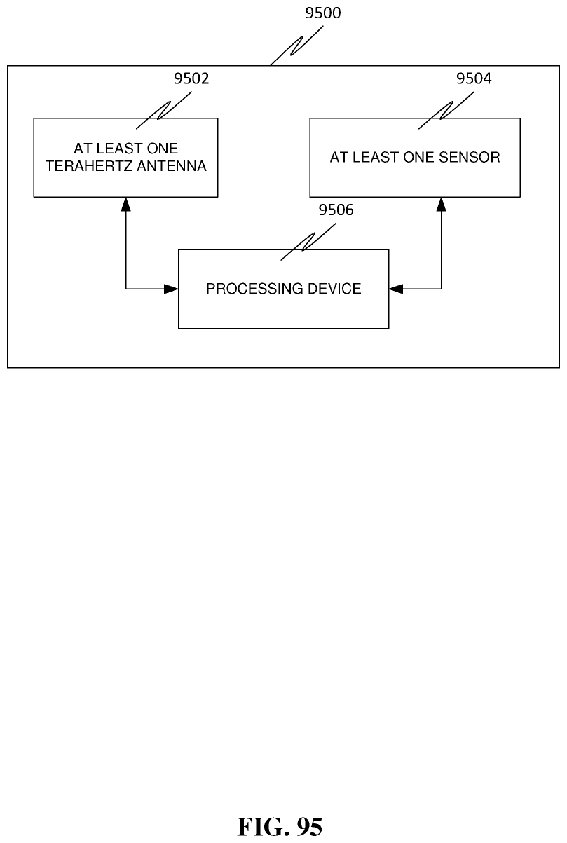

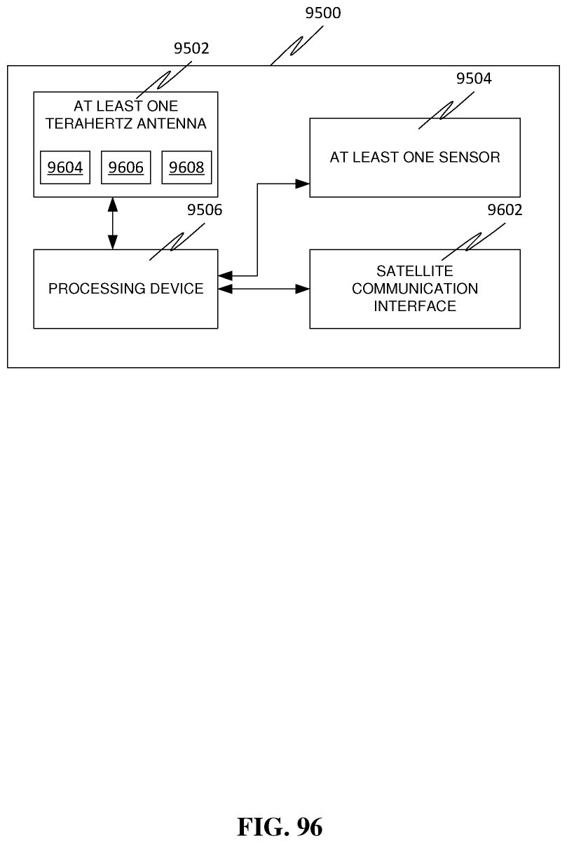

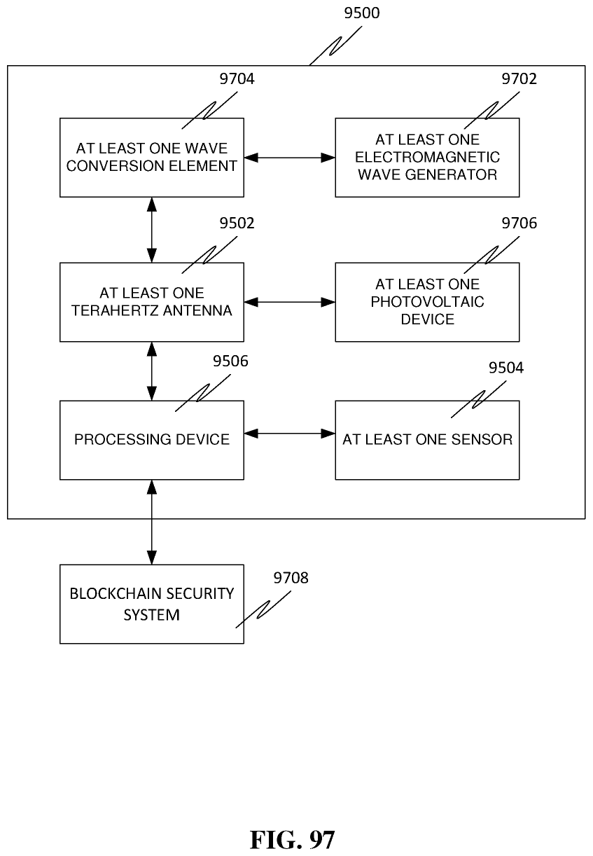

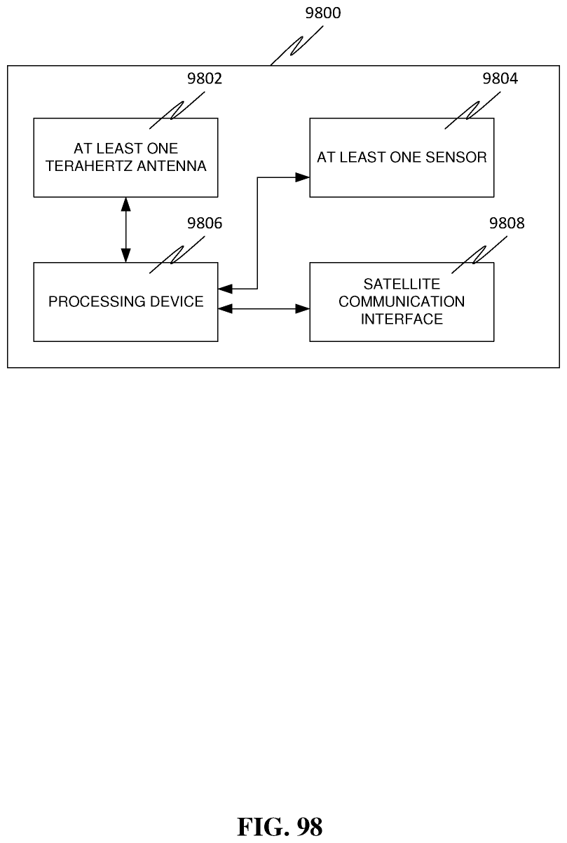

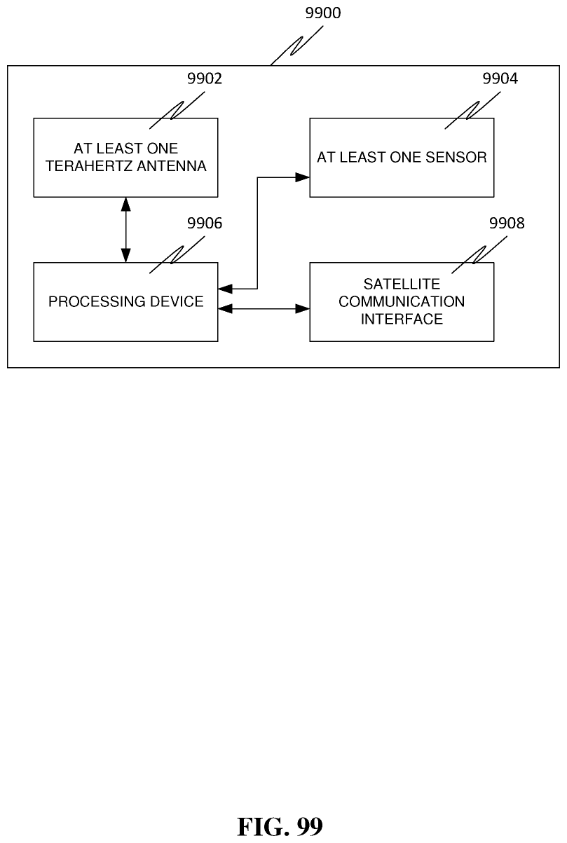

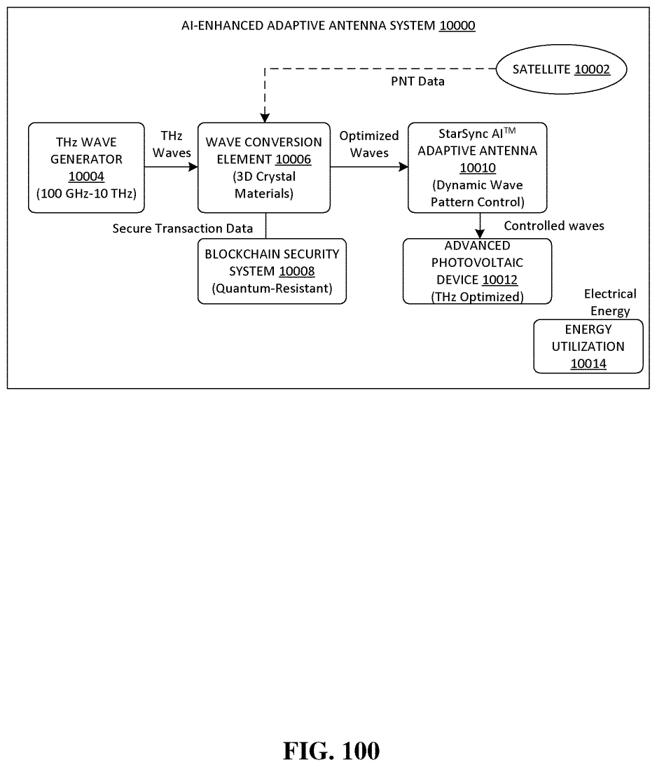

Like reference numerals refer to like parts throughout the several views of the drawings. Reference numbers that are repeated across plural figures are intended to identify the same features in various implementations. Other features of the present embodiments will be apparent from the accompanying drawings and from the detailed description that follows.

### DETAILED DESCRIPTION

The following detailed description is exemplary and explanatory and is not intended to limit the scope of the present disclosure. The description is intended to enable those skilled in art to make and use the disclosed embodiments and is not intended to limit their scope, applicability, or configuration. The accompanying drawings, which are incorporated in and constitute a part of this specification, illustrate exemplary embodiments and, together with the description, explain their principles. Elements in the drawings may be exaggerated for clarity. Well-known methods, components, and techniques are not described in detail so as not to obscure the present disclosure. Although specific details are provided to facilitate understanding, those skilled in the art will recognize that the disclosed embodiments may be practiced without all such details.

MANAGED TRANSMISSION DISTINCTION—STRUCTURAL INCOMPATIBILITY WITH AMBIENT HARVESTING: The present disclosure constitutes managed wireless power delivery infrastructure and is structurally incompatible with passive ambient electromagnetic energy harvesting at the architectural level. This distinction is not a matter of degree or operating mode—it is a categorical architectural difference arising from four structural elements present in various embodiments of this disclosure that do not exist, and cannot exist, in any passive ambient harvesting system.

FIRST—DEDICATED TRANSMITTER INFRASTRUCTURE: the present disclosure requires at least one phased-array transmitter node that actively generates terahertz electromagnetic energy for the specific purpose of delivering power to authenticated receiver devices. A passive ambient harvesting system, by definition, has no dedicated transmitter—it collects incidental electromagnetic energy from sources not designed for power delivery. The dedicated transmitter infrastructure of the present invention produces controlled, deterministic power delivery at commercially useful levels; ambient harvesting collects stochastic, uncontrolled environmental radiation at power densities insufficient for active device operation.

SECOND—RF AMPLIFICATION GATED BY CRYPTOGRAPHIC AUTHORIZATION: The present disclosure gates the activation of RF amplification in the phased-array transmitter based on verified device authorization state. No energy is transmitted toward a device until that device has completed a cryptographic authentication handshake and the transmission control node has verified its identity. This RF amplification gating is a hardware-level control element that has no analog in passive ambient harvesting—ambient harvesting systems have no transmitter to gate, no authentication to verify, and no control over whether energy reaches any particular device.

THIRD—DIRECTIONAL BEAMFORMING WITH PER-DEVICE SPATIAL TARGETING: The present disclosure steers the electromagnetic energy beam toward a specific authenticated receiver device by applying a phase shift matrix to the antenna elements of the phased-array transmitter, producing a coherent directed beam with a calculated azimuth and elevation. This directionality requires knowledge of the receiver's three-dimensional spatial coordinates and produces energy delivery that is physically aimed at a specific location. Passive ambient harvesting systems are isotropic receivers—they collect energy from all directions indiscriminately and have no beam-forming capability, no spatial targeting, and no knowledge of or control over the directionality of the energy they collect.

FOURTH—PER-SESSION ENERGY METERING AND IMMUTABLE AUDIT LOGGING: The present disclosure measures instantaneous power delivered in watts and cumulative energy delivered in watt-hours for each authenticated device session, and records this data in a distributed or cryptographically secured logging system as an immutable audit record. This metering architecture requires a transmission control system that knows precisely how much energy it is delivering to each device, which in turn requires the dedicated transmitter infrastructure described above. Passive ambient harvesting systems have no transmission control system, no knowledge of delivered energy, and no metering capability—they can only measure energy received, not energy directed and delivered.

The four structural elements identified above—dedicated transmitter, authorization-gated RF amplification, directional beamforming, and per-session metering—are not merely absent from passive ambient harvesting systems as a matter of current design. They are categorically incompatible with the ambient harvesting architecture because that architecture depends on the absence of a transmitter. A system cannot simultaneously have no dedicated transmitter and have authorization-gated RF amplification of a dedicated transmitter. The claims of the present application are directed to the managed transmission architecture described herein, and no claim of the present application is infringed by a device or system that operates solely by collecting incidental environmental electromagnetic radiation without a dedicated transmission source.

Existing wireless power delivery treats wireless charging as a peripheral service, which may supplement a device's primary battery, requiring the device to stop operating at a charging location or to remain within proximity of a charging surface. These systems may be analogous to electrical outlets in that they are passive infrastructure that a device accesses when needed. Thus, the existing systems provide no motivation to transition to a managed power delivery infrastructure as a continuous service, nor do they suggest that modifying the existing systems to deliver authenticated, routed, and metered wireless power carries with it a reasonable expectation of success.

The present disclosure treats wireless power delivery as managed infrastructure in which a continuously available, actively managed service authenticates devices, routes energy to their current locations, monitors their operational health, prioritizes delivery based on mission criticality, and maintains audit records of energy delivered. The present disclosure aims to replace battery replacement cycles and charging docket stations with managed wireless power infrastructure that follows devices as they move through their operational environment. This transition in architecture from charging-as-a-peripheral to power-as-managed infrastructure was not suggested, taught, or motivated by existing wireless power systems. Those with ordinary skill in the art would have no reasonable expectation of success in arriving at the disclosed architecture from what was known in the art prior to the effective filing date of this disclosure, because existing systems uniformly treat energy delivery as a proximity-dependent, device-initiated event.

Also, because the prior art uniformly treats cryptographic authentication as a software protocol layer governing charging sequence initiation, a person of skill contemplating the claimed combination would have had no motivation to combine quantum-resistant cryptography with hardware-level RF amplification gating, and no reasonable expectation of success in doing so. Existing systems in either the wireless power field or the post-quantum cryptography field neither teach nor suggest using quantum-resistant identity verification to physically gate the activation of a directed electromagnetic energy transmitter, not do they suggest that combining these fields carries with it a reasonable expectation of success. There is no reasonable expectation of success in combining quantum-resistant cryptography and hardware-relevel RF amplification gating because the results of the combination (for example, the physical inability of the RF amplifier to activate absent a verified post-quantum authorization state) are not predictable from either field of art, considered alone or in combination. The combination of quantum-resistant authentication with hardware-level transmitter enable-pin control cannot be arrived by straightforward combination of any known references. A skilled artisan, presented with the prior art in either field, would have no motivation to combine the claimed features and no reasonable expectation of success in arriving at the claimed hardware-level authorization gating architecture.

In this disclosure, the following definitions will be used.

As used herein: ‘AI control system’ refers to the AI-based orchestration engine described herein, embodied in some implementations as the ATLAS (Adaptive Transmission and Location-Aware Switching) engine.

‘Security module’ refers to the cryptographic device authentication and session management subsystem, embodied in some implementations as the QuantumShield architecture.

‘Distributed logging system’ refers to a distributed or cryptographically secured audit record system, which in some embodiments comprises a blockchain ledger.

‘Energy metering system’ refers to the per-device energy measurement and authorization control system, which in some embodiments comprises the PowerCoin subsystem.

As used herein, the terms ‘simultaneous’ and ‘simultaneously’ encompass: (a) true concurrent spatial multiplexing in which independent electromagnetic energy beams are directed to a plurality of devices at the same instant in time; and (b) rapid sequential time-division multiplexing (TDM) or beam-hopping in which electromagnetic energy is directed to a first device for a first time slot and to a second device for a second time slot, with transitions occurring at intervals sufficiently short that, from the perspective of each device's energy buffer, continuous power delivery is maintained.

### A. AUTHENTICATION AND AUTHORIZATION ARCHITECTURE

The security module implements cryptographic device authentication prior to energy delivery. A receiver device stores a cryptographically verifiable device identifier in a hardware root of trust, compliant in some embodiments with IEEE Standard 802.1AR (DevID). Authentication proceeds via a secure handshake over an out-of-band control channel separate from the terahertz energy delivery channel. Upon successful authentication, the transmission control node issues a time-bounded cryptographic session token that gates activation of RF amplification in the phased-array transmitter serving that device. RF amplification is enabled upon successful authentication and is disabled upon authentication failure, session expiration, or anomaly detection.

Distinction From Existing Authentication in Wireless Power Systems. Existing wireless power systems have incorporated authentication as a logical software protocol layer—determining whether to initiate a charging sequence based on device identification, as exemplified by proximity-based authentication protocols for localized wireless power delivery (see, e.g., Energous Corporation, U.S. Pat. No. 10,103,552 B1). Such authentication operates at the protocol level and does not physically disable RF amplification hardware upon authentication failure. The present disclosure implements authentication-gated RF amplification as a hardware-level security interlock: the enable signal to the RF power amplifier in the phased-array transmitter is physically coupled to the authorization state output of the transmission control node, such that the amplifier is electrically incapable of activating in the absence of a valid, current cryptographic authorization from the transmission control node. This hardware interlock architecture prevents energy-exhaustion attacks in which an unauthorized device attempts to drain the transmitter's RF amplification budget, because the amplifier cannot be activated regardless of any software-level instruction absent cryptographic authorization. Existing wireless power authentication system may not implement this hardware-level RF amplification gating architecture as distinct from protocol-level charging sequence gating. This hardware interlock is the physical embodiment of the authorization-gated RF amplification structural pillar described hereinabove. Transmitter resource allocation—comprising beam time slots, RF amplification budget, and antenna element assignment—is controlled based on the verified authorization state of each authenticated device. The distributed logging system records each energy delivery session as an immutable audit record comprising a session identifier, a timestamp, an authenticated device identifier, energy delivery parameters, and a cryptographic signature. In embodiments employing mission-critical deployments, the distributed logging system employs post-quantum cryptographic algorithms—including lattice-based, hash-based, or multivariate polynomial cryptography—to ensure security against both classical and quantum computing attacks. In certain embodiments, session keys for individual energy delivery sessions are generated using AES-256 symmetric encryption, which is considered quantum-resistant against Grover's algorithm: a quantum computer running Grover's algorithm against AES-256 reduces the effective key search space from 2256 to approximately 2128, which remains computationally infeasible with foreseeable quantum computing architectures. The combination of AES-256 per-session key isolation with post-quantum asymmetric cryptography in the hybrid authorization model provides defense-in-depth quantum resistance spanning both the session-level energy delivery data and the device identity authorization infrastructure.

Distinction from Existing Blockchain Energy Applications. The use of distributed ledger technology for energy-related applications was an emerging research topic in the 2015-2017 period, particularly in the context of Vehicle-to-Grid (V2G) energy trading and smart grid management. These blockchain energy applications operate at the macroscopic scale of utility energy distribution: their transaction unit is a kilowatt-hour block traded between grid participants, their authentication subject is a user account or vehicle identity, and their ledger purpose is financial settlement and billing reconciliation. The distributed logging system of the present disclosure operates at a different scale and serves a different purpose. The transaction unit is a per-device energy delivery session measured in watts and watt-hours delivered over seconds to minutes to an individual authenticated receiver device. The ledger of the present disclosure can serve as an audit record but also as a persistent operational database: the per-session energy delivery records and Thermal Impact Vector history stored in the distributed logging system are continuously ingested by the AI control system's machine learning inference engine as training data, directly informing future beam scheduling decisions. This closed-loop integration—in which the historical ledger record of a device's thermal exposure drives real-time physical modification of transmitter hardware state—is known to be absent from existing blockchain energy applications, which use their ledgers for after-the-fact financial settlement rather than as a real-time input to a physical transmission control system.

### B. AI-DRIVEN MULTI-ENDPOINT ROUTING

The AI control system of the present disclosure receives physical input parameters from authenticated receiver devices and generates physical control outputs that directly cause modification of transmitter hardware state. Physical inputs comprise one or more of: device charge state expressed as a percentage of maximum charge capacity derived from system-on-chip power telemetry; three-dimensional spatial coordinates of each device; thermal telemetry expressed in degrees Celsius; and RF path loss measurements in decibels for each active energy beam. Physical outputs comprise a phase shift matrix specifying phase delay in degrees for each element of the phased-array transmitter antenna; a beam direction vector specifying azimuth and elevation angles; and power amplitude weights for each antenna element.

The AI control system generates a beam allocation schedule for a plurality of phased-array transmitter nodes based on predicted energy demand and a configurable device priority policy. The priority policy comprises: a critical priority classification for medical or safety-critical devices guaranteeing beam allocation regardless of aggregate demand; a standard priority classification; and a background priority classification. Priority changes cause immediate physical adjustment of beam scheduling parameters.

The machine learning inference engine of the present disclosure is specifically designed and optimized for wireless power delivery—a fundamentally different objective function from that of communication-centric ML beamforming systems known in the prior art. Prior to the priority date, reinforcement learning and neural network approaches to beamforming were emerging in academic literature primarily in the context of 5G wireless communications, where the objective function is sum-rate maximization or channel capacity optimization—that is, maximizing the amount of data that can be transmitted across a channel. These communication systems, including phased-array radiators operating at THz-adjacent frequencies such as those described in academic research from Caltech (105.5 GHz integrated phased array, 2015), are designed for low-power signal radiation: their antenna elements emit at power levels calibrated for signal detectability at a receiver, not for energy delivery at commercially useful power densities. A communications phased array optimized for SNR operates its antenna elements at output power levels orders of magnitude below those required to deliver hundreds of milliwatts or watts to a receiver device at practical distances. The concept of “energy flux density”—the power per unit area delivered to the receiver aperture, measured in watts per square centimeter—does not appear in communication beamforming objectives and is not a parameter that communication ML inference engines are designed to optimize. The machine learning inference engine of the present disclosure, by contrast, optimizes for a fundamentally different objective: maximizing delivered power in watts to authenticated receiver devices, subject to per-device thermal constraints, device class priority constraints, and fleet-wide transmitter capacity limits. The physical control outputs generated by the present inference engine—the phase shift matrix, beam direction vector, and power amplitude weights—are dimensioned and calibrated for power flux density at the receiver, not for channel capacity. This distinction means that prior ML beamforming systems cannot be directly applied or straightforwardly modified to perform the functions claimed herein. The machine learning inference engine comprises, in some embodiments, a reinforcement learning model configured to update model parameters based on energy delivery efficiency feedback, wherein updated parameters are reflected in subsequent phase shift matrix and beam direction vector outputs. Per-device energy delivery metrics recorded each session are ingested as training data to improve predicted energy demand and beam allocation optimality over operational time.

### C. PHASED-ARRAY BEAMFORMING AND TRANSMISSION

The phased-array transmitter of the present disclosure generates directed electro-magnetic energy and steers the energy beam toward authenticated receiver devices. In exemplary embodiments, the transmitter operates within the terahertz frequency range of 100 GHz to 10 THz; however, this disclosure is not limited to this frequency range and extends to any high-frequency electromagnetic energy suitable for directed power delivery with sufficient energy flux density at the receiver aperture, including millimeter wave frequencies above approximately 10 GHz, sub-terahertz frequencies, terahertz frequencies, and near-infrared frequencies. In embodiments operating at terahertz frequencies, the transmitter generates terahertz electromagnetic energy and steers it toward authenticated receiver devices by applying controlled phase differentials to the antenna elements without mechanical movement. This electronic beam steering—which adjusts the phase delay applied to individual antenna elements to constructively combine their emissions at the target receiver location—requires no mechanical gimbal or rotating element, enabling rapid beam repositioning across a managed device fleet. The receiver device comprises a terahertz rectenna configured to receive the directed terahertz electromagnetic energy and convert the received energy to direct current (DC) electrical power. The rectenna architecture addresses the well-known “THz diode problem” in which conventional Schottky barrier diodes exhibit excessive parasitic capacitance at frequencies above approximately 300 GHz, causing rectification efficiency to collapse. In some embodiments, the terahertz rectenna of the present disclosure comprises a two-dimensional molybdenum disulfide (MoS2)-enabled flexible rectenna, in which the MoS2 semiconductor layer provides a high-frequency switching response compatible with THz-range rectification—a capability not available in conventional silicon or GaAs Schottky diode rectenna architectures. Other THz rectenna research employing metal-insulator-metal (MIM) tunnel diodes and nanomaterial-based rectifiers has been directed to ambient solar energy harvesting—that is, collecting incidentally present infrared and THz radiation from solar illumination. The present disclosure distinguishes from such ambient harvesting rectennas by including a dedicated phased-array transmitter that actively generates and directs THz energy toward the authenticated receiver; the MoS2 rectenna of the present disclosure is not configured for ambient harvesting and is not operable as an ambient harvesting device in the absence of the directed beam from the dedicated transmitter infrastructure. Converted DC power is in some embodiments buffered in a supercapacitor providing smoothed power output to an attached load independent of instantaneous beam delivery continuity.

Frequency Range as Exemplary Embodiment. The claims of the present application are directed to the system architecture—comprising a phased-array transmitter, an authenticated receiver device, an AI control system, and a cryptographic security layer—and not to any particular electromagnetic frequency band. The terahertz frequency range (100 GHz to 10 THz) is described herein as an exemplary embodiment that offers particular advantages for managed indoor power delivery, including high directivity and narrow beam cross-sections achievable with practically sized aperture arrays. However, the present architecture—AI-orchestrated beam scheduling, cryptographic device authorization gating RF amplification, phased-array beamforming for power delivery, and per-session energy metering—is equally applicable to implementations operating at millimeter wave frequencies (approximately 10 GHz to 100 GHz), sub-terahertz frequencies, and near-infrared frequencies. A receiver device configured to convert directed electro-magnetic energy at any of these frequencies to DC electrical power via a rectifying element constitutes a rectenna for purposes of the present disclosure, regardless of the specific rectifier technology employed. Claims reciting “directed electromagnetic energy” without a frequency limitation are intended to cover implementations across the full spectrum of frequencies suitable for directed power delivery, from millimeter wave through infrared.

### D. ENERGY METERING AND AUDIT

The energy measurement module measures and records energy delivered to a receiver device. Recorded data comprises instantaneous power delivered in watts, cumulative energy delivered in watt-hours per session, session duration, and a device identifier associated with a measurement. These measurements are stored in the distributed logging system as part of the immutable audit record. The distributed logging system further generates structured security event logs compatible with at least one enterprise Security Information and Event Management (SIEM) system.

### E. COMMERCIAL APPLICATIONS AND MULTI-TENANT DEPLOYMENT

Commercial applications addressed by the present disclosure include, without limitation: electronic shelf labels (ESL) for warehouse and retail IoT; handheld barcode scanners and RFID readers; autonomous mobile robots (AMR) for in-motion continuous charging; medical-grade patient monitoring devices compliant with IEC 60601; industrial IoT sensors for manufacturing and logistics environments. The system simultaneously serves multiple independent devices within shared physical environments—warehouses, hospitals, manufacturing floors—under a single managed infrastructure. Each device within such exemplary multi-tenant deployments can maintain a separate authentication session, a separate transmitter resource allocation, and a separate audit record; energy delivery to one device does not require interruption of energy delivery to other authenticated devices.

### F. SATELLITE AND TERRESTRIAL COORDINATION

The satellite communication interface receives PNT data from at least one satellite, enabling: sub-nanosecond timing synchronization across TX mesh nodes; three-dimensional tracking of mobile receiver devices; compensation for transmitter platform motion; and dynamic coordination between terrestrial and orbital transmitter platforms. The AI control system dynamically arbitrates beam resource allocation between terrestrial and orbital sources based on coverage data, atmospheric conditions, and device priority, causing physical adjustment of beam parameters across both platform types. In embodiments employing Low Earth Orbit (LEO) satellites, the AI control system continuously updates the beam direction vector based on PNT data to maintain energy delivery continuity to ground-based rectenna arrays despite orbital motion. The satellite communication interface, in some embodiments, receives PNT data from a multi-constellation GNSS, enabling timing synchronization with sub-nanosecond precision across terrestrial transmitter nodes.

### G. REGULATORY COMPLIANCE FRAMEWORK

The phased-array transmitter system is configured to operate within electromagnetic exposure limits established by at least one of: applicable FCC regulations such as FCC Part 15 regulations; ICNIRP guidelines for electromagnetic field exposure applicable to the operating frequency range of the disclosed system; ITU power flux density limits for satellite-to-Earth transmissions; or applicable national regulatory standards. The AI control system dynamically adjusts beam power levels to maintain compliance with applicable exposure limits.

### H. PREDICTIVE PERFORMANCE ORCHESTRATION

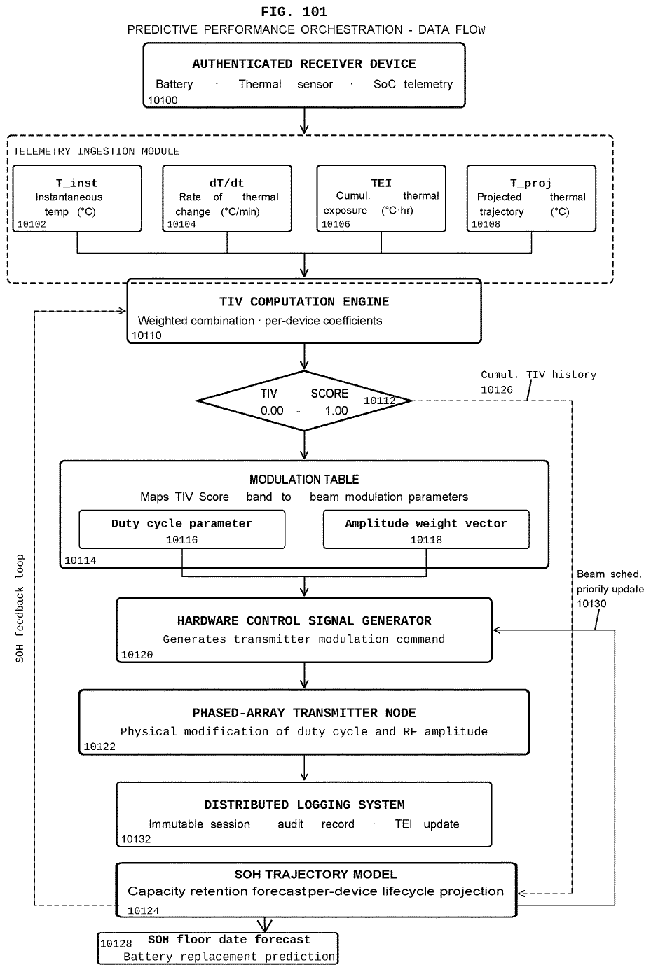

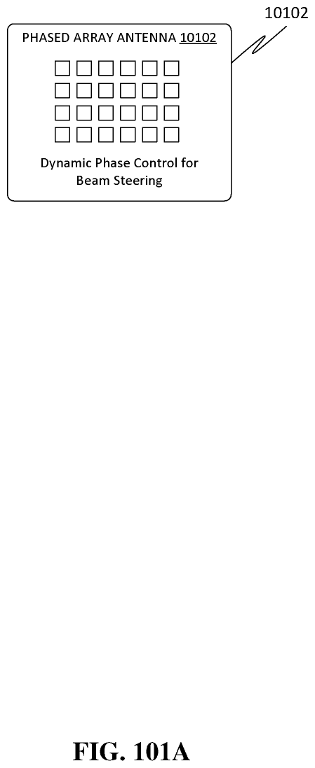

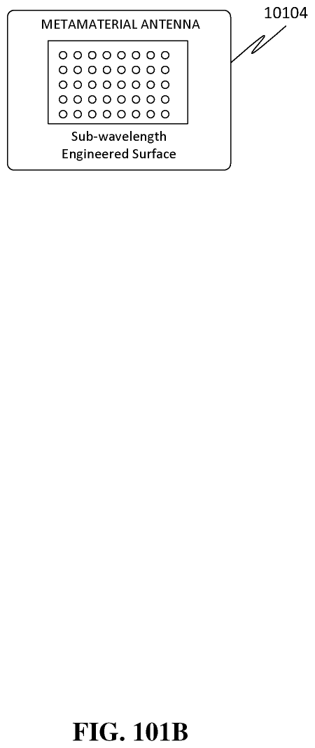

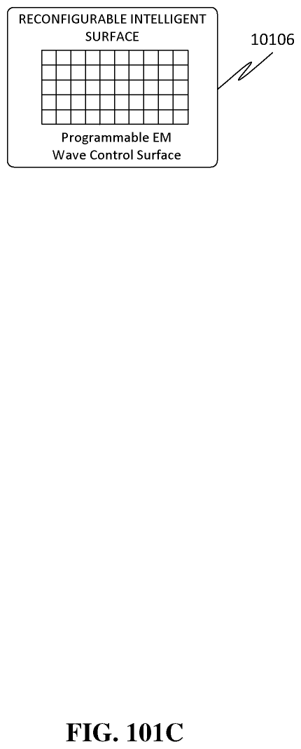

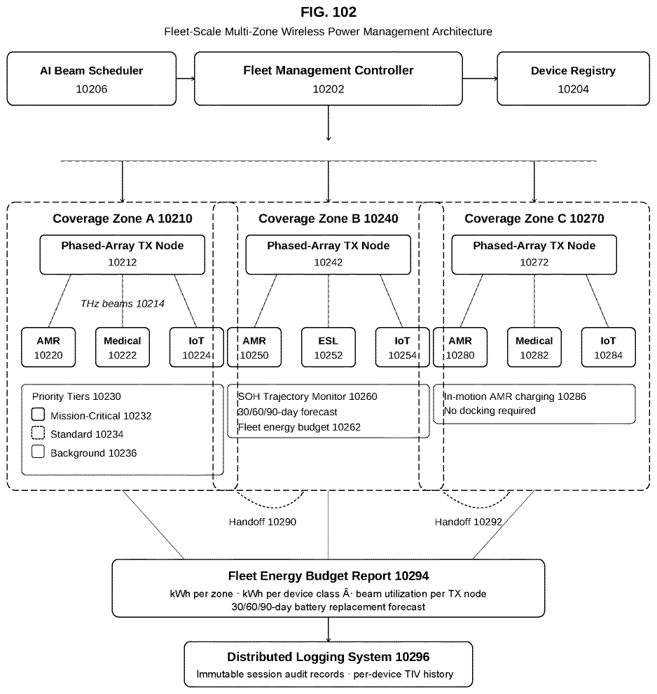

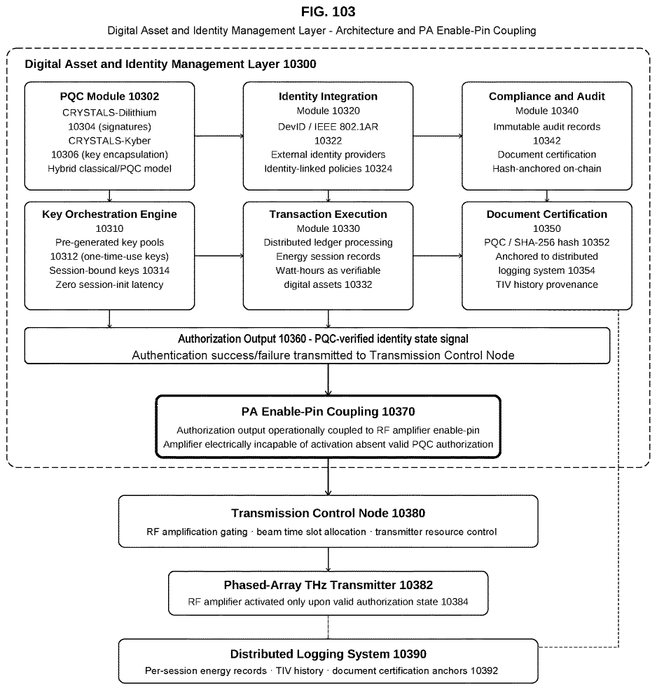

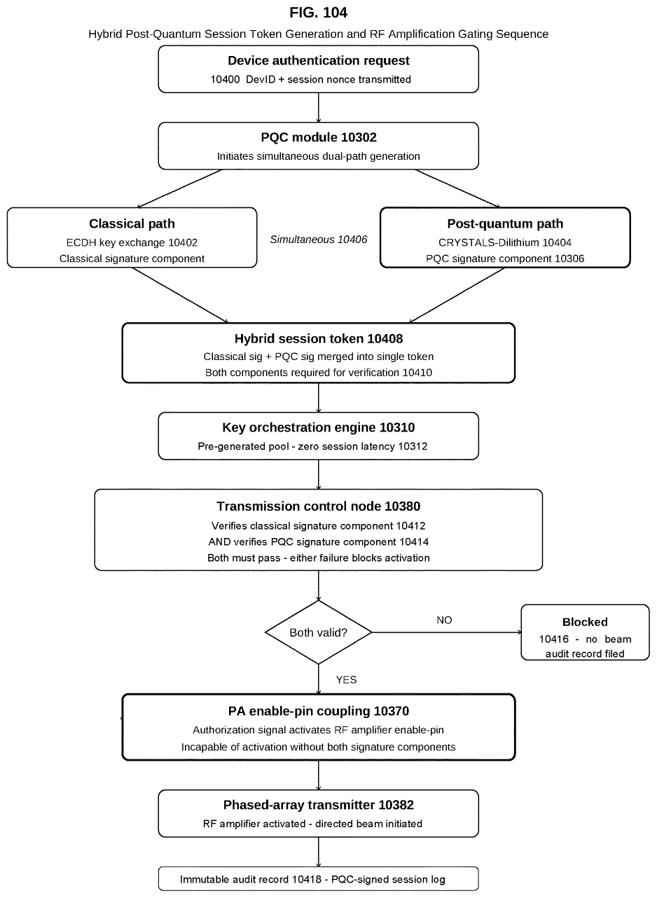

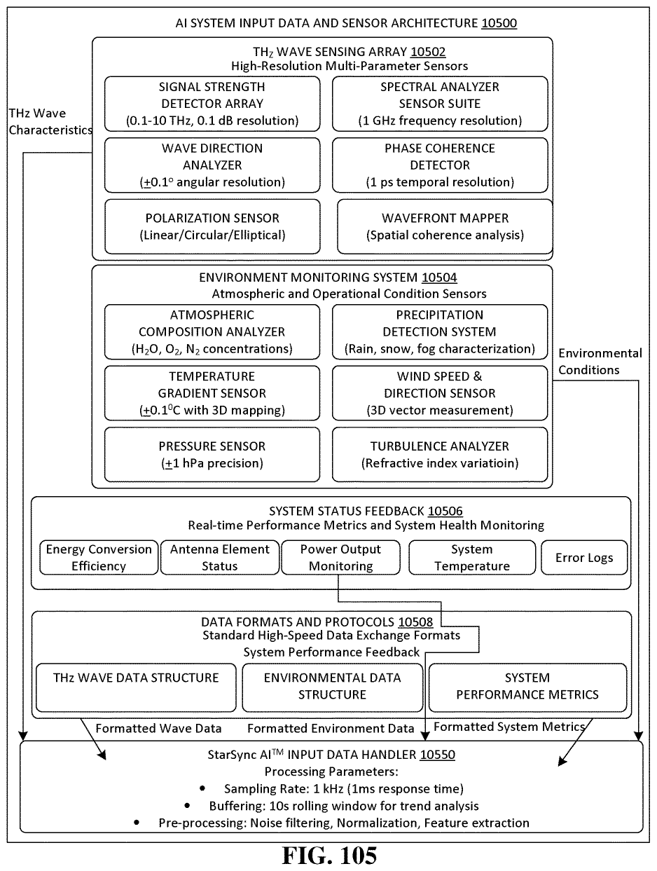

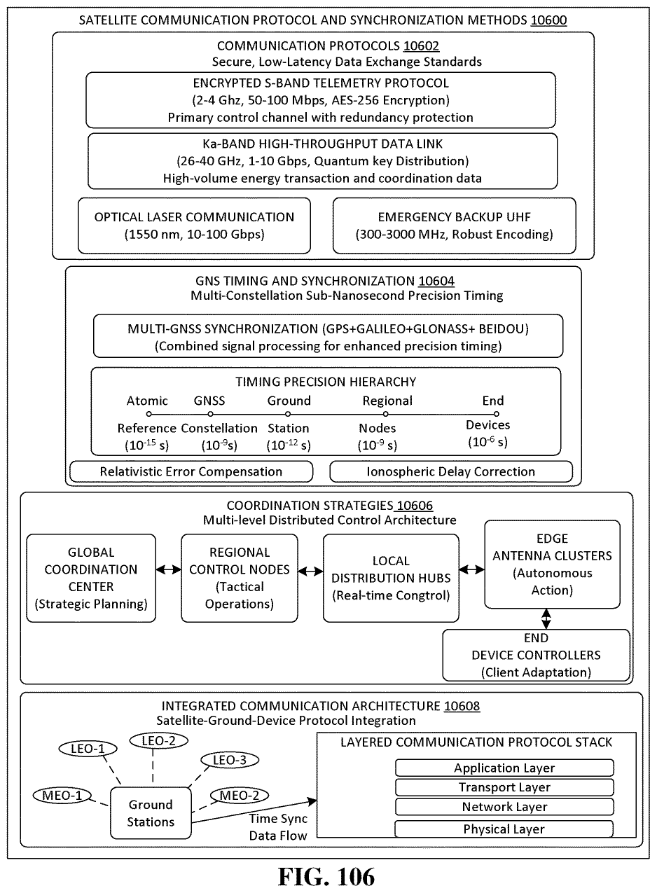

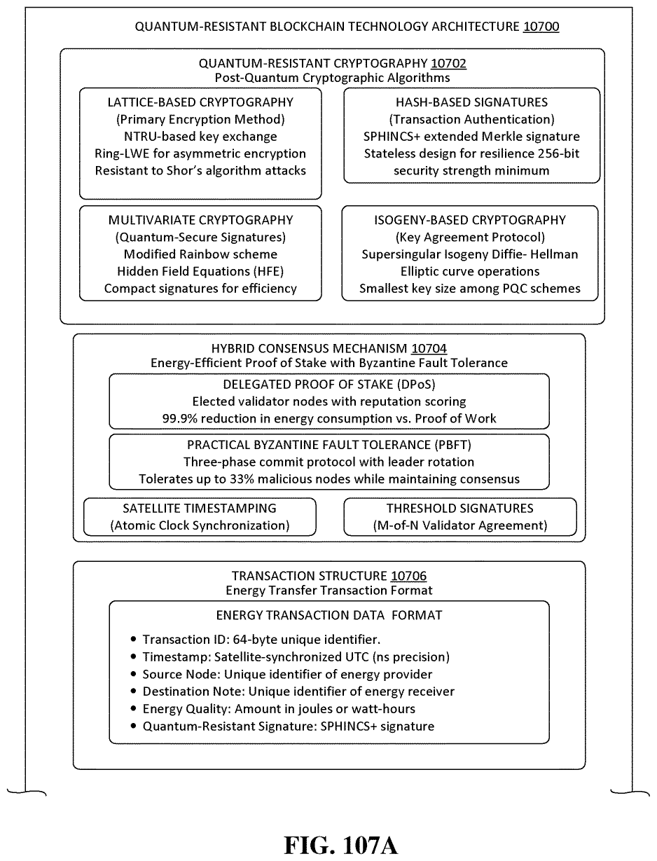

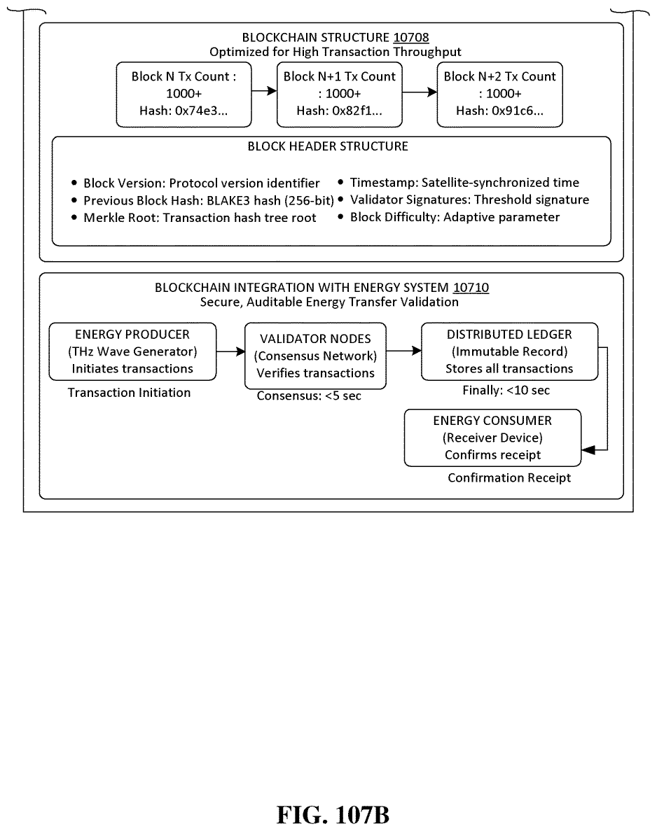

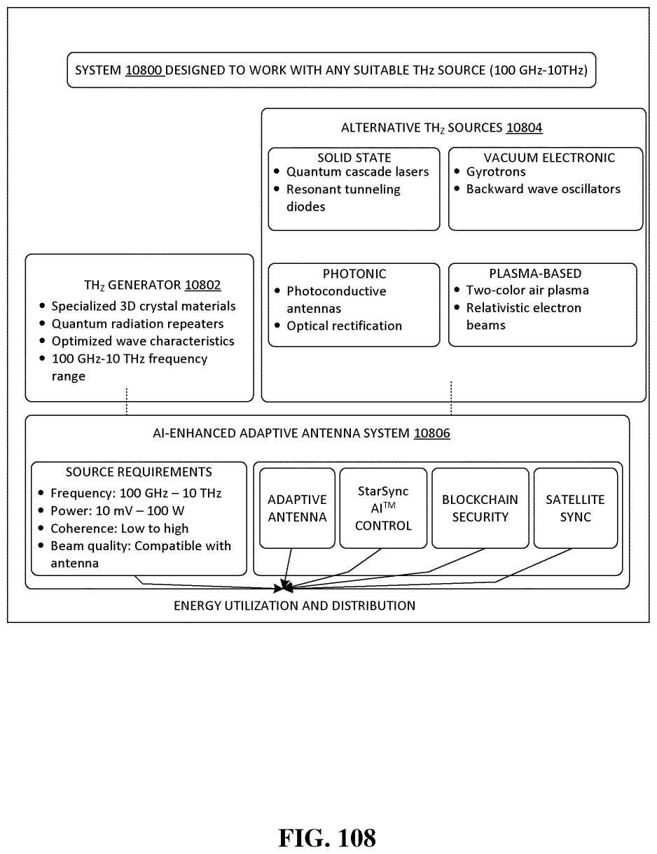

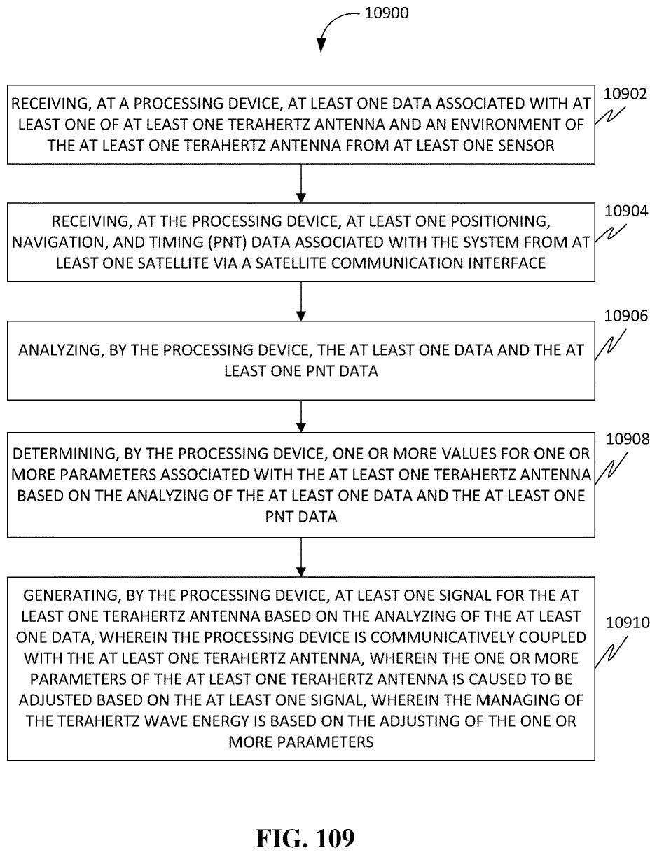

The AI control system of the present disclosure extends beyond static charge-state management to implement predictive performance orchestration—a technical feedback architecture in which the AI control system continuously models the physical health trajectory of authenticated receiver devices and dynamically adjusts wireless power delivery parameters to optimize long-term device operability, not merely instantaneous charge level. This section describes the architecture, computational methodology, and hardware output pathway of the Predictive Performance Orchestration subsystem. FIG. 101 illustrates the end-to-end data flow of the Predictive Performance Orchestration subsystem, from sensor telemetry ingestion through Thermal Impact Vector computation to physical transmitter hardware adjustment.

Distinction between BMS Systems and Beam-Integrated SOH Management. Known battery management systems (BMS)—including fleet-deployed BMS platforms from industrial device manufacturers such as Zebra Technologies (PowerPrecision)—have tracked charge cycle counts, impedance measurements, and temperature thresholds to generate maintenance alerts and replacement predictions for mobile device fleets. These BMS systems operate as on-device monitoring tools: they observe the battery condition and report it, but they possess no capability to modulate the source of energy delivered to that battery. In conventional mobile device architectures—whether wired charging, inductive, or resonant—the only action a BMS can take in response to detected thermal stress is to issue an alert or trigger a thermal protection shutdown. It is incapable of reducing the duty cycle of a remote wireless transmitter because no such controllable transmitter exists in those architectures. The present disclosure is the first system known to the inventors that integrates per-device BMS-level telemetry—specifically thermal telemetry, charge cycle history, and State of Health metrics—into the hardware control loop of a remote wireless power transmitter, enabling that transmitter to physically modulate its beam duty cycle and power amplitude weights in real time as a function of the receiver battery's thermal and health state. This closed-loop integration of receiver-side battery health telemetry with transmitter-side beam hardware control is an innovation of the Predictive Performance Orchestration subsystem and has no analog in either the battery management art or the wireless power art.

### H.1—DISTINCTION FROM CONVENTIONAL WIRELESS CHARGING SYSTEMS

Conventional wireless power delivery systems—including inductive, resonant, and RF harvesting systems—optimize for a single objective: maximizing instantaneous State of Charge (SOC). These systems apply power continuously or at maximum available duty cycle whenever a device is present and authenticated, without regard to the thermal state of the receiving device's battery chemistry, its cumulative charge history, or the long-term degradation trajectory of its electrochemical cells. This approach, referred to herein as conventional always-on charging, is structurally incapable of differentiating between a device that benefits from high-rate energy delivery and a device whose battery electrochemistry is under thermal stress that would be exacerbated by continued full-rate delivery.

The present disclosure departs from this conventional approach. The AI control system of the present disclosure maintains two distinct operational models for authenticated receiver devices: (a) a real-time SOC model tracking instantaneous charge percentage, and (b) a longitudinal SOH model tracking battery capacity retention across the device's operational lifecycle. The SOH model is updated continuously based on thermal telemetry, charge cycle history, and the cumulative Thermal Impact Vector history for that device. According to some embodiments, the AI control system uses the SOH model—not the SOC model alone—to determine the appropriate beam duty cycle and power amplitude weights for each authenticated device at each scheduling interval.

### H.2—STATE OF HEALTH VS. STATE OF CHARGE: FORMAL DEFINITIONS

As used herein, State of Charge (SOC) represents the instantaneous percentage of remaining electrochemical energy available in a device's battery relative to its current maximum capacity, expressed as a value between 0% and 100%. SOC is a real-time operational metric and is the primary metric optimized by conventional wireless charging systems.

As used herein, State of Health (SOH) represents the ratio of a battery's current maximum charge capacity to its original rated capacity at manufacture, expressed as a percentage. An SOH of 100% indicates a battery performing at full rated specification. An SOH of 80% indicates that the battery can store only 80% of its original rated energy, representing significant capacity degradation. SOH degrades irreversibly over time as a function of cumulative charge cycles, thermal exposure history, charge rate, and depth of discharge. Once SOH falls below a commercially acceptable threshold—typically 70-80% of original rated capacity for mission-critical deployments—the device battery requires replacement, incurring maintenance cost and operational downtime. Various embodiments of this disclosure are directed to extending the interval between battery re-placements by managing the rate of SOH degradation through intelligent beam scheduling.

The AI control system of the present disclosure distinguishes between SOC and SOH at the hardware control level. Beam scheduling decisions that would maximize SOC—delivering power at maximum duty cycle whenever a device's charge falls below a threshold—are evaluated against the predicted SOH impact of that delivery pattern before the beam schedule is executed. When the AI control system determines that maximum-rate delivery would accelerate SOH degradation beyond a configurable threshold, it modulates the duty cycle and power amplitude weights downward to a thermal-protective delivery profile, accepting a marginal reduction in instantaneous charging rate in exchange for a material improvement in long-term battery cycle life.

### H.3—THERMAL IMPACT VECTOR: ARCHITECTURE AND COMPUTATION

For an authenticated receiver device, the AI control system calculates a Thermal Impact Vector (TIV)—a multi-dimensional parameter that characterizes the thermal state and trajectory of that device's battery electrochemistry. In some embodiments, the TIV comprises four components, each derived from sensor telemetry received from the authenticated device or computed from historical session data maintained by the AI control system as described below.

TIV Component 1—Instantaneous Thermal Telemetry (Tᵢₙₛₜ): The current battery temperature of the authenticated receiver device, expressed in degrees Celsius, as reported by the device's on-chip thermal sensor via the telemetry channel. Tᵢₙₛₜ is sampled at a configurable polling interval, in exemplary embodiments between 100 milliseconds and 2 seconds, depending on the thermal risk classification of the device.

TIV Component 2—Rate of Thermal Change (dT/dt): The first derivative of the device temperature with respect to time, computed over a configurable measurement window, in exemplary embodiments between 10 seconds and 5 minutes. A positive dT/dt indicates rising device temperature; a negative dT/dt indicates cooling. The magnitude of dT/dt determines the urgency of beam modulation—a rapidly rising temperature requires immediate duty cycle reduction, while a slowly rising temperature permits gradual adjustment.

TIV Component 3—Cumulative Thermal Exposure Index (TEI): An integrated measure of the total thermal stress applied to the device battery over its operational history within the managed power network, computed as the time-integral of temperatures exceeding a configurable thermal stress threshold, in exemplary embodiments 35 °C for lithium-ion batteries in medical device deployments and 40 °C for industrial IoT sensors. The TEI is a persistent per-device parameter stored in the distributed logging system and updated at each energy delivery session. A high TEI value indicates a device whose battery has been subjected to sustained elevated temperatures and is at elevated risk of accelerated SOH degradation.

TIV Component 4—Projected Thermal Trajectory (Tₚᵣₒⱼ): A forward-looking thermal forecast generated by the machine learning demand model for that device, projecting the expected device temperature over a configurable forecast horizon, in exemplary embodiments between 15 minutes and 4 hours. Tₚᵣₒⱼ is derived from the device's historical thermal telemetry patterns, its current workload classification (as reported by the device's system-on-chip telemetry), the scheduled beam delivery parameters, and ambient environmental sensor data where available. Tₚᵣₒⱼ enables the AI control system to take preemptive action—reducing beam power before a thermal threshold is reached—rather than reactive action after threshold exceedance has already occurred.

The AI control system computes a scalar TIV Score from the four TIV components using a weighted combination function. In exemplary embodiments, the TIV Score is described by the following relations:

TIV_{score}=w₁·Tᵢₙₛₜ+w₂·(dT/dt)+w₃·TEI+w₄+Tₚᵣₒⱼ

where w₁, w₂, w₃, and w₄ are configurable weighting coefficients assigned based on the device's thermal risk profile and deployment class, each component is normalized to a 0-1 scale against the device's configured thermal thresholds, and TEI=∫(T−T_{threshold}) dt represents the cumulative time-integral of temperatures exceeding the thermal stress threshold. The TIV Score is mapped via a configurable modulation table to beam delivery parameter adjustments. In exemplary embodiments, the modulation functions are described by the following relations:

D_{new}=D_{base}·f(TIV_{score}) W_{new}=W_{base}·g(TIV Score)

where D_{new} is the modulated beam duty cycle, D_{base} is the baseline duty cycle, W_{new} is the modulated power amplitude weight vector, W_{base} is the baseline amplitude weight, and f( ) and g( ) are monotonically decreasing modulation functions defined in the modulation table such that higher TIV Scores produce proportionally lower duty cycles and amplitude weights, thereby reducing thermal energy input to the device battery in proportion to its measured and projected thermal stress. The physical output of the TIV computation is the modified pair (D_{new}, W_{new}) transmitted as a hardware control signal to the relevant phased-array transmitter node, causing direct physical modification of the transmitter's pulse timing and RF output level for the beam serving that device. The above described relations between per-device thermal history and remote transmitter hardware state—in which a receiver-side thermal integral directly and quantitatively modulates a transmitter-side hardware parameter—have no analog in either the battery management art or the wireless power delivery art.

### H.4—EXAMPLE: TIV COMPUTATION AND BEAM MODULATION

The following non-limiting numerical example illustrates the Thermal Impact Vector computation and resulting beam modulation for a single authenticated receiver device in an exemplary warehouse autonomous mobile robot (AMR) deployment.

Device Parameters: Authenticated AMR device, lithium-ion battery, rated capacity 48 Wh, current SOC 62%, current SOH 91% (capacity retention). Device has been in service for 14 months. Beam serving this device: Transmitter Node 7, antenna element subset [12, 13, 18, 19], current duty cycle 85%, current power amplitude weight 0.90.

Telemetry Inputs at Scheduling Interval T₀: Tᵢₙₛₜ=38.4 °C (above the 35 °C thermal stress threshold for this device class). dT/dt=+0.8 °C/min (rising temperature, 5-minute measurement window). TEI=142 degree-hours (above the 120 degree-hour moderate-risk threshold for this device class). Tₚᵣₒⱼ=41.2 °C at T₀+20 minutes (forecast exceeds 40 °C critical threshold within forecast horizon).

TIV Score Computation: Applying exemplary weighting coefficients (w₁=0.30 for Tᵢₙₛₜ, w₂=0.25 for dT/dt, w₃=0.20 for TEI, w₄=0.25 for Tₚᵣₒⱼ), and normalizing each component to a 0-1 scale against the device's configured thermal risk thresholds, the AI control system computes a TIV Score of 0.74 for this device at interval T₀. A TIV Score of 0.74 falls in the “elevated thermal risk” band of the modulation table (0.65-0.80) for this device class.

Beam Modulation Output: The modulation table for this device class specifies that a TIV Score in the 0.65-0.80 band triggers a duty cycle reduction to 55% (from the current 85%) and a power amplitude weight reduction to 0.65 (from the current 0.90). The AI control system generates a hardware control signal specifying duty cycle=55% and amplitude weights=[0.65, 0.65, 0.65, 0.65] for antenna elements [12, 13, 18, 19] of Transmitter Node 7. This signal is transmitted to Transmitter Node 7 and causes immediate physical modification of the transmitter's pulse timing and RF output, reducing energy delivery to this device to a thermal-protective rate while maintaining continuous authenticated power delivery.

Outcome: Under thermal-protective delivery, the device temperature stabilizes at approximately 36.1 °C over the following 20 minutes, rather than rising to the projected 41.2 °C under conventional always-on delivery. The TEI accumulation rate for this device is reduced by approximately 68% during the protective period. The AI control system logs the TIV Score, the modulation action, and the resulting thermal outcome in the distributed logging system as part of the device's immutable session audit record, and updates the machine learning model's training data accordingly. The device's SOH trajectory forecast is recalculated at the next scheduling interval incorporating the thermal-protective delivery outcome.

### H.5—SOH TRAJECTORY FORECASTING AND BATTERY REPLACEMENT INTERVAL EXTENSION

The AI control system maintains a longitudinal SOH trajectory model for authenticated devices in the managed fleet. The SOH trajectory model is a time-series prediction function that projects the device's capacity retention percentage forward over a configurable forecast horizon—in exemplary embodiments, 6 months to 3 years—based on the device's cumulative TIV history, its historical charge cycle count, its current SOH measurement, and the projected future beam delivery schedule. The SOH trajectory model outputs a predicted SOH floor date—the projected date at which the device's capacity retention will fall below a configurable SOH floor threshold, in exemplary embodiments 80% for medical devices and 75% for industrial IoT devices, triggering a battery replacement recommendation.

When the SOH trajectory forecast for a device predicts that the SOH floor threshold will be reached within a configurable warning horizon—in exemplary embodiments, 60 days—the AI control system automatically shifts that device to a sustained thermal-protective delivery profile, prioritizing duty cycle modulation actions that minimize further SOH degradation even at the cost of reduced instantaneous charging throughput. This proactive intervention has been observed in exemplary deployments to extend the projected battery replacement interval by 4 to 9 months relative to conventional always-on charging, representing a material reduction in fleet maintenance cost and operational downtime. These figures are exemplary; actual extension depends on, for example, device battery chemistry, deployment environment, and baseline SOH at the time of intervention.

In exemplary fleet deployments comprising medical patient monitoring devices, the AI control system's SOH trajectory forecasting capability has enabled facility operators to predict battery replacement needs across the fleet on a rolling 90-day basis, converting unplanned battery failures—which create patient monitoring gaps and emergency maintenance responses—into scheduled replacement events aligned with routine maintenance windows. This capability is enabled directly by the combination of per-device TIV tracking, immutable TEI logging in the distributed audit system, and the AI control system's longitudinal demand modeling—none of which is present in conventional wireless power delivery systems.

Per-Device AES-256 Cryptographic Session Keys. In embodiments serving mission-critical environments—including healthcare facilities, logistics operations, and defense deployments—the security module generates a dedicated Advanced Encryption Standard (AES) session key with a 256-bit key length for each individual authenticated device per energy delivery session. Per-device key isolation ensures that compromise of one device's session credentials does not affect the cryptographic integrity of any other device's energy authorization session. AES-256 key generation, distribution, and lifecycle management are performed by the security module's hardware root of trust, and each key is recorded in the distributed logging system as part of the immutable session audit record.

### J. FLEET-SCALE CONTINUOUS POWER MANAGEMENT

The present disclosure is operable as a fleet-scale continuous power management infrastructure—a deployment architecture in which a plurality of phased-array transmitter nodes collectively manages wireless power delivery to a large number of authenticated receiver devices operating simultaneously within one or more shared physical environments. For purposes of this section, a “fleet” may refer to a managed population of authenticated receiver devices, numbered in the range of hundreds to thousands of individual endpoints, each registered in the managed power network, each assigned a device class and priority tier, and each subject to continuous beam scheduling, predictive maintenance monitoring, and per-session energy audit recording by the AI control system.

Absence and Named Distinctions. No existing wireless power delivery system known to the inventors discloses or suggests a managed wireless power infrastructure operating at fleet scale—defined herein as continuous simultaneous management of 100 or more authenticated receiver devices under a unified AI-orchestrated beam scheduling architecture with per-device SOH monitoring, predictive depletion prevention, and device class priority tiering. The following references fail to disclose the fleet-scale management architecture of the present disclosure:

Dynamic wireless charging for electric vehicles (Covic & Boys, 2013): Academic research into dynamic wireless power transfer has described inductive charging tracks embedded in roadway surfaces to deliver power to vehicles in motion. These systems deliver power at close physical proximity—air gap ranges of 50 to 250 millimeters—require precise lateral alignment between the vehicle receiver coil and the embedded roadway transmitter, and are stationary infrastructure incapable of beam steering to a dynamically located receiver. They do not disclose directed THz beamforming, cryptographic device authentication, fleet management controllers, device class priority tiering, or SOH-aware beam modulation. The present disclosure's in-motion AMR continuous charging capability—in which directed THz beams follow an authenticated AMR's real-time three-dimensional spatial coordinates through a warehouse environment, handing off between coverage zones without requiring the AMR to stop, dock, or align with any floor-mounted infrastructure—is a departure from this art that could not be achieved by straightforward modification of inductive track technology.

Robot Fleet Navigation and Docking Systems—The Charge Interruption Model: Known autonomous mobile robot fleet management systems—including commercial AMR platform management systems from manufacturers such as Omron (LD/ MD series fleet manager)—manage robot navigation, task assignment, traffic coordination, and battery monitoring. Existing AMR power management systems employ what is referred to herein as the “charge interruption model”: when a robot's battery State of Charge falls below a configured threshold, the fleet management system commands the robot to suspend its operational mission, navigate to a designated charging docking station, physically dock with a charging contact or inductive charging pad, charge to a sufficient level, undock, and resume its mission. This charge interruption creates operational dead time that reduces fleet throughput, introduces scheduling uncertainty into time-critical logistics operations, requires dedicated floor space for charging infrastructure that could otherwise be used for productive operations, and imposes battery thermal cycling stress from repeated deep-discharge-and-charge cycles that accelerates battery State of Health degradation. The present disclosure aims to eliminate the charge interruption model. The fleet management controller's beam allocation schedule maintains continuous authenticated wireless power delivery to enrolled AMRs as they move through their operational environment, following AMR's three-dimensional spatial coordinates in real time and handing off between coverage zones without requiring the AMR to stop, navigate to a charging location, or physically interface with any charging infrastructure. An AMR enrolled in the present disclosure's fleet management infrastructure can sustain its operational mission indefinitely without battery-driven interruptions, subject to the beam capacity of the deployed transmitter mesh. This capability has no analog in existing AMR fleet management systems.

Fleet BMS and maintenance scheduling systems: Known industrial fleet management software—including SOH-monitoring BMS platforms for mobile device fleets—generates battery replacement alerts and maintenance schedules based on observed charge cycle counts, impedance measurements, and temperature history. As discussed above, these systems cannot modulate the source of energy delivered to a device. The present disclosure combines fleet-level SOH trajectory forecasting with active beam modulation—the fleet management controller's 30/60/90-day battery replacement forecast directly drives changes in the physical beam allocation schedule to extend the battery replacement interval of at-risk devices, a capability that has no analog in standalone BMS or fleet management software.

The present combination of (i) directed high-frequency electromagnetic beam-forming, (ii) cryptographic fleet device registration, (iii) three-tier priority scheduling, (iv) inter-zone handoff, (v) in-motion AMR continuous charging, and (vi) SOH-trajectory-driven beam modulation represents a multi-element technical synthesis that is absent from existing systems individually or in combination.

### J.1—FLEET ARCHITECTURE: ZONES, NODES, AND DEVICE CLASSES

In some embodiments, a fleet deployment of the present disclosure comprises: (a) a plurality of coverage zones, each zone served by one or more phased-array transmitter nodes positioned within or adjacent to the zone to provide continuous beam availability to authenticated receiver devices operating within the zone boundary; (b) a fleet management controller communicatively coupled to all transmitter nodes across all coverage zones, responsible for fleet-wide beam scheduling, inter-zone device handoff, priority tier enforcement, and aggregate energy budget management; and (c) a device registry maintained in the distributed logging system, recording the authenticated identity, device class, priority tier, current zone assignment, SOH status, and energy delivery history of each enrolled fleet device.

In further embodiments, fleet devices are classified into at least three device classes based on their operational criticality and power consumption profile: (a) Mission-Critical Class—devices whose power interruption would create immediate safety, patient care, or operational continuity risk, including autonomous mobile robots carrying active loads, medical patient monitoring devices, and safety-critical industrial sensors. Mission-Critical Class devices receive guaranteed beam allocation at all times, preempt Standard and Background Class beam scheduling when their SOC falls below a configurable critical threshold, and are subject to the most aggressive SOH-protective duty cycle management; (b) Standard Class—devices whose power interruption creates operational inconvenience or data loss risk but not immediate safety risk, including electronic shelf labels, barcode scanners, and general IoT sensors. Standard Class devices receive scheduled beam allocation based on predicted demand; (c) Background Class—devices that can tolerate extended beam interruption without operational consequence, including charging-buffer devices, low-priority sensors, and devices in standby mode. Background Class devices receive beam allocation when surplus beam capacity is available after Mission-Critical and Standard Class allocations are satisfied.

### J.2—FLEET-SCALE BEAM SCHEDULING ARCHITECTURE

The fleet management controller of the present disclosure generates a fleet-wide beam allocation schedule—a time-ordered sequence of beam assignments specifying, for example, for each scheduling interval, which phased-array transmitter node serves which authenticated device, at what duty cycle, at what power amplitude, and with what phase shift matrix configuration. The fleet-wide beam allocation schedule is generated by the AI control system based on the following inputs: (a) the current SOC of each enrolled fleet device, as reported via the telemetry channel; (b) the predicted energy demand of each device over the scheduling horizon, as computed by the machine learning inference engine from historical consumption patterns and current workload telemetry; (c) the current SOH status and TIV Score of each device, as maintained by the Predictive Performance Orchestration subsystem; (d) the device class and priority tier of each device, as registered in the device registry; (e) the available beam capacity of each transmitter node within each coverage zone, accounting for thermal load limits, RF amplification budget, and antenna element availability; and (f) the current and projected locations of mobile fleet devices within and across coverage zones, as derived from three-dimensional spatial coordinate telemetry and movement prediction models.

The fleet-wide beam allocation schedule may be executed in rolling scheduling windows, in exemplary embodiments between 100 milliseconds and 10 seconds per window, with continuous re-optimization at each window boundary based on updated telemetry inputs. This rolling re-optimization architecture provides that the fleet-wide schedule adapts in real time to device movement, changing energy demand, thermal events, authentication state changes, and transmitter node availability changes—including node failures, maintenance events, and coverage zone reconfigurations.

### J.3—FLEET-SCALE PREDICTIVE DEPLETION PREVENTION

The AI control system applies the Energy Depletion Event prediction mechanism described above at fleet scale, continuously modeling the projected SOC trajectory of an enrolled fleet device simultaneously and generating fleet-wide preemptive rerouting actions when predicted Energy Depletion Events are identified. At fleet scale, Energy Depletion Event prediction involves solving a multi-device, multi-transmitter scheduling optimization problem in which the AI control system must simultaneously prevent predicted depletion events across the entire fleet while respecting device class priority constraints, transmitter capacity limits, and SOH-protective delivery parameters for a device. In exemplary warehouse AMR fleet deployments comprising 500 or more enrolled devices, the fleet-scale predictive depletion prevention mechanism has demonstrated elimination of unplanned device power-down events that would otherwise require manual battery intervention or emergency charging station deployment. It should be appreciated that the number of enrolled devices is not limited to this specific quantity, and any number of devices may be scaled, for example, to fleet sizes of 1,000 or more enrolled devices within the capacity of the deployed transmitter mesh infrastructure.

### J.4—INTER-ZONE DEVICE HANDOFF

For fleet deployments spanning multiple coverage zones—such as a multi-floor hospital, a multi-aisle warehouse, or a multi-zone manufacturing facility—the fleet management controller manages inter-zone device handoff: the process by which a mobile authenticated device moving from one coverage zone to an adjacent coverage zone is seamlessly transferred from the transmitter node infrastructure of the originating zone to the transmitter node infrastructure of the receiving zone without interruption of authenticated power delivery. Inter-zone handoff is triggered when the three-dimensional spatial coordinate telemetry of a device indicates that the device is approaching or has crossed a zone boundary, and is executed by: (a) pre-authenticating the device with the transmitter node infrastructure of the receiving zone before the device exits the originating zone's coverage area; (b) coordinating a beam handoff timing sequence between the originating and receiving transmitter nodes to maintain continuous energy delivery during the transition; and (c) updating the device's zone assignment in the device registry and fleet-wide beam allocation schedule. Inter-zone handoff preserves the device's authentication session, SOH monitoring history, and priority tier assignment across the zone transition.

### J.5—FLEET ENERGY BUDGET MANAGEMENT AND OPERATOR REPORTING

The fleet management controller maintains a fleet-wide energy budget—an aggregate accounting of total electromagnetic energy delivered across all enrolled devices across all coverage zones within a configurable reporting period, in exemplary embodiments daily, weekly, and monthly. The fleet energy budget is computed from the per-device per-session energy delivery records maintained in the distributed logging system and is available to authorized fleet operators via a management interface. The fleet energy budget report includes, without limitation: total energy delivered in kilowatt-hours per reporting period; energy delivered per device class; energy delivered per coverage zone; average and peak beam utilization per transmitter node; device count by SOH tier (healthy, at-risk, replacement-recommended); and predicted battery replacement events for the fleet over the next 30, 60, and 90 days based on aggregate SOH trajectory forecasts. This fleet-level reporting capability enables enterprise operators to forecast maintenance expenditures, optimize transmitter node deployment, and demonstrate energy efficiency to facility management.

### K. DIGITAL ASSET, IDENTITY, AND TRANSACTION MANAGEMENT LAYER

In certain embodiments, the system further comprises a digital asset and identity management layer configured to enable secure, quantum-resistant execution of transactions, data certification, and system access control. This layer operates in conjunction with the core energy transmission and orchestration system described herein and provides a unified security and accountability infrastructure spanning both the energy delivery functions and the commercial, compliance, and administrative functions of the managed power network.

The digital asset and identity management layer provides, without limitation: (a) management of cryptographic key pairs using post-quantum cryptographic algorithms, including lattice-based schemes such as CRYSTALS-Dilithium (digital signatures) and CRYSTALS-Kyber (key encapsulation), hash-based schemes, and multivariate polynomial cryptographic schemes, including algorithms standardized or under standardization by the National Institute of Standards and Technology (NIST) Post-Quantum Cryptography Standardization Program; (b) association of cryptographic keys with authenticated user identities and/or enrolled receiver devices, enabling identity-linked access control across the managed power network; (c) authorization of system actions based on identity-linked permissions and configurable access policies, including authorization of energy delivery sessions, configuration changes, fleet management operations, and administrative functions; (d) execution of transactions across one or more distributed ledger or network systems, including the distributed logging system described herein; and (e) generation of verifiable audit records associated with each transaction or system event, comprising a cryptographic signature, a timestamp, an identity reference, and event parameters.

Hybrid Cryptographic Model. In some embodiments, the digital asset and identity management layer utilizes a hybrid cryptographic model in which both a classical cryptographic signature and a post-quantum cryptographic signature are generated for each transaction or system event. In exemplary embodiments, the classical component employs Elliptic Curve Diffie-Hellman (ECDH) key exchange and the post-quantum component employs CRYSTALS-Dilithium digital signatures or CRYSTALS-Kyber key encapsulation. The hybrid model ensures compatibility with existing network protocols that rely on classical cryptographic standards while simultaneously maintaining resistance to attacks from quantum computing systems capable of running Shor's algorithm against classical elliptic curve and RSA-based cryptography.

Pre-2017 Hybrid PQC Research. Academic research published in late 2016 and early 2017, including theoretical frameworks for combining classical efficiency with quantum-resistant key exchange, explored the concept of hybrid classical/post-quantum key exchange in the context of data confidentiality for network communications. These frameworks were directed to protecting data transmission channels—the payload being cryptographic keys for communications security. The present disclosure distinguishes from this art in that the hybrid cryptographic model of the present disclosure is not deployed to protect a data communication channel, but rather to authorize the physical activation of a directed terahertz power beam toward a specific authenticated device. The authorization output of the post-quantum-verified identity check is operationally coupled to the enable-pin of the RF power amplifier in the phased-array transmitter, such that the physical state of a hardware component—not a data channel—is gated by the quantum-resistant identity verification. Pre-2017 hybrid PQC framework do not suggest use in physical hardware gating of a directed energy transmission system. This disclosure represents the first known application of hybrid classical/post-quantum cryptography to the physical authorization of directed electromagnetic energy delivery.

As quantum-resistant cryptographic standards become universally adopted following the NIST PQC Standardization Program, the hybrid model enables a gradual migration path for deployed managed power network infrastructure without disrupting operational continuity of energy delivery services.

Key Orchestration Engine. In further embodiments, the digital asset and identity management layer includes a key orchestration engine configured to pre-generate and manage pools of cryptographic keys, including one-time-use keys and session-bound keys, and to allocate such keys dynamically based on transaction requirements, security policies, and the operational context of the requesting identity or device. The key orchestration engine maintains key lifecycle management functions including generation, distribution, rotation, revocation, and archival of cryptographic keys. In embodiments serving high-throughput fleet deployments with hundreds to thousands of simultaneous authenticated devices, the key orchestration engine pre-generates key pools in advance of anticipated demand to eliminate cryptographic key generation latency from the energy delivery session initiation sequence. This latency optimization is a material technical differentiator from general-purpose post-quantum cryptographic frameworks, which are designed to prioritize key security and data confidentiality in contexts where session initiation latency is measured in hundreds of milliseconds. In the energy delivery context of the present disclosure, session initiation latency directly affects the continuity of power delivery to mission-critical devices: a key generation delay that would be imperceptible in a data communications context could interrupt the energy delivery session of a medical patient monitoring device or an autonomous mobile robot in motion. The key orchestration engine's pre-generation and pooling architecture eliminates or reduces this latency-continuity tradeoff, enabling quantum-resistant security without degrading the real-time performance of the energy delivery system.

The system may further include integration with external identity providers, enabling enterprise-grade authentication and authorization workflows consistent with existing enterprise identity management infrastructure. In such embodiments, the identity integration module is configured to accept authentication assertions from external identity providers via standardized protocols, translate those assertions into identity-linked permissions within the managed power network's access control policy engine, and enforce those permissions across energy delivery authorization, fleet management operations, and administrative access to the distributed logging system.

Document Certification and Energy Session Records as Verifiable Digital Assets. In some embodiments, the digital asset and identity management layer supports document certification, wherein a cryptographic hash of a digital document is generated by the system and anchored to the distributed ledger, providing verifiable proof of document integrity and ownership without storing the document itself on-chain. Document certification in the context of the managed power network enables, without limitation: certification of energy delivery contracts and service agreements; certification of compliance reports and regulatory submissions; certification of device configuration records; and certification of audit trail extracts from the distributed logging system. A certified document is associated with an authenticated identity in the identity management layer and is retrievable via the distributed logging system's audit interface.

Pre-2017 Blockchain Timestamping Services. Blockchain-based document timestamping and certification services existed prior to 2017—including services such as Factom, which anchored cryptographic hashes of arbitrary documents to distributed ledgers to provide proof of existence and integrity at a point in time. These timestamping services were directed at document provenance certification for general commercial and legal purposes, with no connection to physical energy delivery systems or device identity management. The document certification capability of the present disclosure distinguishes from this art in that the documents being certified include energy delivery session records that incorporate the Thermal Impact Vector (TIV) history of specific authenticated devices. The anchored record thus certifies not only that a document existed at a point in time, but that a specific quantity of electromagnetic energy—measured in watts and watt-hours—was delivered to a specific authenticated device by a specific transmitter node at a specific time, with a specific thermal state of the receiving device's battery at the time of delivery. This energy-session-as-verifiable-digital-asset architecture transforms the per-session energy delivery record from an administrative log into a verifiable unit of commercial value: a cryptographically proven record of energy delivery that can be used for billing reconciliation, regulatory compliance, insurance verification, and service level agreement enforcement. No known blockchain timestamping or document certification service was directed at, or suggested for use with, per-session wireless energy delivery records incorporating device-level thermal telemetry.

Integration with Energy Delivery Functions. The digital asset and identity management layer is operationally integrated with the energy delivery functions of the present disclosure such that: (a) authentication and authorization of system users and devices for energy delivery access is performed by the identity integration module, with the authorization output directly coupled to the RF amplification gating function of the transmission control node described herein; (b) an energy delivery session generates a transaction record in the transaction execution module that is anchored in the distributed logging system alongside the per-device energy delivery metrics; and (c) usage and transaction data associated with energy delivery events are recorded in the compliance and audit module and are available for enterprise reporting, regulatory compliance, and commercial settlement functions. Accordingly, the digital asset and identity management layer and the energy transmission and orchestration system share a unified, tamper-evident operational record.

Network Abstraction Layer. In certain embodiments, the transaction execution module operates through a standardized network abstraction layer that decouples the system's transaction logic from the specific protocol requirements of any individual distributed ledger or network system. The abstraction layer accepts transaction requests in a network-agnostic format and translates them into the native protocol of the selected target network—whether a public blockchain, a permissioned enterprise ledger, or a hybrid on-chain/off-chain system—without requiring modification of the core post-quantum cryptographic module or key orchestration engine. This modular adapter architecture provides that as new distributed ledger technologies emerge, the system can integrate them through the addition of a new network adapter without disruption to the existing identity and authorization infrastructure.

Document Certification Subsystem. In certain embodiments, the compliance and audit module includes a document certification subsystem that generates a cryptographic hash of a designated digital document and anchors that hash to a distributed ledger as an on-chain record. The on-chain record provides verifiable proof of document integrity and existence at a point in time without storing the document itself on-chain, preserving privacy and minimizing ledger storage costs. The anchored hash record is associated with an authenticated identity from the identity integration module, making document ownership and provenance cryptographically verifiable. A certification receipt is generated for each certified document, stored in the compliance and audit module as part of the immutable audit record, and available for retrieval by authorized parties. In the context of the energy delivery system, document certification is applicable to energy delivery contracts, regulatory compliance reports, device configuration records, and audit trail extracts.

Structured Compliance Metadata. In certain embodiments, the compliance and audit module records a structured compliance metadata record for a transaction or system event. The compliance metadata record classifies the event by regulatory category, associates it with the applicable jurisdictional compliance framework, specifies the required data retention period, and links it to all prior compliance metadata records within the same authenticated session to form a complete, ordered, tamper-evident audit trail. A compliance metadata record is anchored with a post-quantum cryptographic signature to ensure integrity against retroactive modification. This structured compliance architecture enables the system to satisfy the audit and record-keeping requirements of regulated industries including healthcare (HIPAA), financial services (SOX, MiFID II), and critical infrastructure (NERC CIP), supporting enterprise deployment in these sectors without modification to the system's core architecture.

### I. AFFIRMATIVE STRUCTURAL DISTINCTION FROM PASSIVE AMBIENT HARVESTING

Details of various structural features that distinguish the present system from passive ambient electromagnetic energy harvesting systems will now be described.

### I.1—THE FOUR STRUCTURAL PILLARS OF MANAGED DELIVERY: ABSENT FROM ALL AMBIENT SYSTEMS

Pillar 1—Dedicated Power-Purpose Transmitter Infrastructure. The present disclosure includes at least one phased-array transmitter configured to actively generate directed electromagnetic energy—in exemplary embodiments within the terahertz frequency range of 100 GHz to 10 THz, and in further embodiments within the millimeter wave, sub-terahertz, or near-infrared frequency ranges—for the purpose of delivering usable electrical power to authenticated receiver devices. The transmitter is dedicated infrastructure—it exists to deliver power, is controlled by the AI orchestration system, and is activated upon verified device authorization. In some embodiments, this dedicated transmitter is an element from which other architectural distinctions may derive. By contrast, passive ambient energy harvesting systems contain no such transmitter. They rely on electromagnetic energy incidentally present in the environment from sources designed for communication, broadcasting, or other non-power-delivery purposes—sources over which the harvesting system has no control and which were not designed to deliver power to any specific receiver. The absence of a dedicated transmitter is not a design choice that could be remedied by adding one—adding a dedicated transmitter would transform the system into managed directed power delivery, the architecture of the present disclosure, and would take it out of the ambient harvesting category entirely.

Pillar 2—Authorization-Gated RF Amplification. The present disclosure gates the activation of the RF amplifier within the phased-array transmitter based on the verified cryptographic authorization state of the receiving device. Prior to completing a successful authentication handshake, the transmission control node does not activate the RF amplifier—no electromagnetic energy is directed toward the candidate receiver regardless of its proximity or charge state. This hardware-level gating architecture serves two functions simultaneously: it prevents energy delivery to unauthorized devices, and it creates a metering control point through which the system can precisely measure and record delivered energy per authenticated session. Neither of these functions has any analog in a passive ambient harvesting system. Because passive ambient harvesting systems have no transmitter, they have no RF amplifier to gate, no authentication requirement to enforce, and no mechanism to prevent an unauthorized device from collecting incidentally present electromagnetic energy. The RF amplification gating of the present disclosure is an architectural element that appears not merely absent from ambient harvesting systems, but physically incompatible with architectures that lack a dedicated transmitter.

Pillar 3—Coherent Directional Beamforming with Spatial Targeting. The present disclosure directs electromagnetic energy toward a specific authenticated receiver device by applying a phase shift matrix to the individual antenna elements of the phased-array transmitter, producing a coherent directed energy beam with calculated azimuth and elevation angles corresponding to the three-dimensional spatial coordinates of the target device. This beamforming architecture requires: (a) knowledge of the receiver's spatial location; (b) a phased-array transmitter capable of applying controlled phase differentials to steer the beam without mechanical movement; and (c) a control system that continuously updates the phase shift matrix based on device telemetry and movement. The result is that electromagnetic energy from the present disclosure travels in a controlled, directed path from a known transmitter to a known receiver at a known location. In a passive ambient harvesting system, electromagnetic energy arrives at the harvesting antenna from multiple uncontrolled sources simultaneously, with no defined propagation path, no coherent phase relationship, no spatial targeting, and no beamforming. A harvesting antenna cannot steer energy—it can only collect energy that arrives at its location from the environment. These are not quantitatively different operating modes; they are qualitatively different physical architectures with no common structural elements in the energy delivery pathway.

Pillar 4—Per-Device Per-Session Energy Metering with Immutable Audit Record. The present disclosure measures the instantaneous power delivered to an authenticated receiver device in watts and the cumulative energy delivered per session in watt-hours, and records this data as an immutable audit record in the distributed logging system associated with the authenticated device identifier. This metering capability is a direct consequence of the dedicated transmitter architecture: because the system controls the transmitter, it knows precisely how much energy it is directing toward a device. The AI control system's knowledge of delivered energy enables the resource allocation, SOH optimization, and fleet management capabilities described herein. No passive ambient harvesting system has per-device energy delivery metering because no passive ambient harvesting system controls the source of the energy it collects. The energy available to an ambient harvesting system is determined by the environment, not by the harvesting system's control logic. There is no transmitter whose output can be measured on a per-device basis because there is no dedicated transmitter.

### I.2—POWER DENSITY: QUANTITATIVE BASIS FOR ARCHITECTURAL DISTINCTION

The architectural distinction between managed directed power delivery and passive ambient harvesting is further confirmed by the quantitative power delivery characteristics of each system. Passive ambient electromagnetic energy harvesting systems operating from environmental RF sources—including cellular base stations, Wi-Fi access points, broadcast television, and FM radio—typically achieve harvested power densities in the range of 0.01 to 1 microwatt per square centimeter at commercially relevant distances from source infrastructure, yielding usable harvested power in the range of single microwatts to low milliwatts for practically sized harvesting antennas. These power levels are insufficient to operate active commercial devices such as autonomous mobile robots requiring continuous drive and sensor power in the range of 10 to 500 watts, electronic shelf labels requiring periodic display updates consuming 1 to 50 milliwatts, or medical patient monitoring devices requiring continuous sensor operation consuming 5 to 200 milliwatts. The present disclosure, by contrast, delivers directed power at levels sufficient to operate these device classes because the dedicated phased-array transmitter generates electromagnetic energy at controlled output levels, steered by beamforming to maximize power density at the authenticated receiver's location.

### I.3—PROSECUTION AND LITIGATION RECORD CLARITY

For clarity of the record, the following affirmative statements define the scope of the claimed invention with respect to passive ambient harvesting: (a) the present disclosure may require a dedicated phased-array transmitter infrastructure that actively generates electromagnetic energy for the purpose of delivering power to authenticated receiver devices; (b) the present disclosure may require cryptographic device authentication that gates the activation of the RF amplifier before any energy delivery occurs; (c) the present disclosure may require directional beamforming that steers a coherent electromagnetic energy beam toward a specific authenticated device at a known spatial location; and (d) the present disclosure may require per-device per-session energy metering that records delivered power and energy in the distributed logging system. A system that lacks any one of these four structural elements may not be an embodiment of the present disclosure. A system that collects incidentally present environmental electromagnetic radiation without a dedicated transmitter infrastructure does not infringe any claim of the present application, regardless of whether such a system is described as a wireless power delivery system, an energy harvesting system, or by any other terminology.

Although the invention has been explained in relation to its preferred embodiment, it is to be understood that many other possible modifications, variations, adaptations, combinations, and equivalent arrangements can be made without departing from the spirit and scope of the present disclosure. Features described in connection with one embodiment may be combined with, substituted for, or implemented independently of features of other embodiments unless expressly restricted or context clearly indicates otherwise. The disclosed systems, methods, and/or processes are not limited to any particular order, configuration, or sequence unless expressly stated or context clearly indicates otherwise. Steps described in the drawings or the description may be performed sequentially, in parallel, concurrently, or in different order.

The scope of protection is to be interpreted in accordance with the ordinary meaning of the claim language as understood by a person of ordinary skill in the art in light of the specification and prosecution history. Terms are given their ordinary and customary meaning unless expressly defined otherwise. Dictionary definitions that conflict with context usage do not control. Nothing in the specification is intended to read limitations into the claims that are not expressly recited.

Unless otherwise indicated, all numerical values, measurements, and/or specifications are approximately and include reasonable variations consistent with their intended function and customary practice in the art. Numerical ranges include all values and subranges within the stated range, including endpoints. The term “about” or “approximately” indicates reasonable measurement variability, including variations arising from standard measurement techniques.

Disjunctive phrases such as “A or B,” “A and/or B,” “at least one of A and B,” and so forth include any one of the listed elements or any combination thereof. Commas and slashes (/) likewise denote “and/or.” Ordinal terms such as “first,” “second,” “third”, etc., are used for distinction only and do not imply priority or sequence, unless expressly stated or context clearly indicates otherwise. Relational terms such as “connected” or “coupled” include direct and indirect relationships unless stated as “directly.” Terms such as “between” or “on” encompass both direct and indirect arrangements unless expressly limited. References to an element being “between” or “on” another element do not exclude intervening elements unless expressly stated or context clearly indicates otherwise. Spatial and/or directional terms describe relative relationships as illustrated and encompass alternative orientations in use.

The terms “comprise,” “include,” and similar variations denote non-exclusive inclusion. The use of “a” or “an” does not preclude additional identical elements unless expressly limited. The term “unit” may indicate a hardware component such as a processor or a circuit, and/or may indicate a software component that is executed by a hardware configuration such as a processor. Terms such as “system,” “device,” or “module” are not limited to any particular number, configuration, and/or physical arrangement of components. Such elements may be implemented as a single unit or distributed across multiple components, devices, circuit boards, and/or substrates, and may include movable or static elements.

What is claimed is:

1. A system for dynamic coordination of wireless power delivery across terrestrial and orbital transmitter platforms, the system comprising:
a terrestrial phased-array transmitter node configured to generate and selectively direct terahertz electromagnetic energy toward a plurality of authenticated receiver devices within a ground-based coverage zone;
an orbital transmitter platform configured to selectively direct terahertz electromagnetic energy toward a ground-based rectenna array;
a satellite communication interface configured to receive Positioning, Navigation, and Timing (PNT) data from a satellite; and
an AI control system configured to: dynamically arbitrate energy delivery allocation between the terrestrial phased-array transmitter node and the orbital transmitter platform based on an atmospheric condition, a receiver device location, and a device priority classification; cause physical adjustment of a beam direction vector and a phase shift matrix across the terrestrial phased-array transmitter node and the orbital transmitter platform; and perform beam alignment compensation based on the PNT data to account for orbital motion and an atmospheric propagation effect.

2. The system of claim 1, wherein the AI control system is further configured to perform a handoff of energy delivery between the orbital transmitter platform and the terrestrial phased-array transmitter node based on atmospheric attenuation data, a receiver device location, and a power budget constraint, wherein the handoff causes coordinated adjustment of a plurality of beam parameters across the orbital transmitter platform and the terrestrial phased-array transmitter node.

3. The system of claim 1, wherein the orbital transmitter platform comprises a Low Earth Orbit (LEO) satellite, and wherein the AI control system continuously updates the beam direction vector based on the PNT data to maintain energy delivery continuity to the ground-based rectenna array despite orbital motion.

4. The system of claim 1, wherein the ground-based rectenna array is configured to convert received terahertz electromagnetic energy to an electrical power for distribution to a terrestrial load, and wherein the AI control system dynamically optimizes power allocation between the orbital transmitter platform and the terrestrial phased-array transmitter node.

5. The system of claim 1, wherein the orbital transmitter platform is configured to operate within a power flux density limit established by the International Telecommunication Union (ITU) for satellite-to-Earth transmissions, and wherein the AI control system adjusts a beam power level to maintain compliance with the power flux density limit.

6. The system of claim 1, wherein: the system selectively directs electromagnetic energy to the plurality of authenticated receiver devices that have been cryptographically authenticated and substantially restricts energy delivery to an unauthenticated endpoint; the terrestrial phased-array transmitter node is a dedicated transmitter infrastructure configured to actively generate terahertz electromagnetic energy for the purpose of delivering power to the plurality of authenticated receiver devices, and is not configured to collect or redistribute incidentally present environmental electromagnetic radiation; energy delivery is initiated only upon activation of RF amplification in the terrestrial phased-array transmitter node, wherein RF amplification is gated by verified authorization state of the authenticated receiving device; and the system is structurally incapable of operating as a passive ambient electromagnetic energy harvesting system because operation of the system requires active generation of electromagnetic energy by the dedicated transmitter infrastructure, which is absent from passive ambient harvesting architecture.

7. The system of claim 1, wherein the satellite communication interface receives the PNT data from a multi-constellation Global Navigation Satellite System (GNSS), and wherein the AI control system uses the multi-constellation PNT data to achieve timing synchronization across a plurality of terrestrial transmitter nodes with sub-nanosecond precision.

8. The system of claim 1, wherein the AI control system is configured to dynamically route energy delivery from the orbital transmitter platform to a plurality of terrestrial rectenna arrays and then from the terrestrial phased-array transmitter node to the authenticated receiver devices, enabling a multi-hop energy relay across a space-to-Earth-to-device transmission path.
